(19) United States
(12) Patent Application Publication
(10) Pub. No.: US 2025/0000120 A1
(43) Pub. Date: Jan. 2, 2025

(54) METHOD OF PRODUCING A MODIFIED WHEY PROTEIN COMPOSITION BY GENTLE OXIDATION, THE MODIFIED WHEY PROTEIN COMPOSITION, AND NUTRITIONAL USES OF THE MODIFIED WHEY PROTEIN COMPOSITION

(71) Applicant: ARLA FOODS AMBA, Viby J (DK)

(72) Inventors: Søren Bang NIELSEN, Viby J (DK); Tanja Christine JÆGER, Viby J (DK); Xiaolu GENG, Viby J (DK); Lone Vendel NIELSEN, Viby J (DK); Peter Aasted PAULSEN, Viby J (DK); Søren KLITGAARD, Viby J (DK)

(21) Appl. No.: 18/700,946

(22) PCT Filed: Oct. 14, 2022
(86) PCT No.: PCT/EP2022/078739

§ 371 Date: Apr. 12, 2024

(30) Foreign Application Priority Data
Oct. 14, 2021 (EP) 21202780.9

(51) Int. Cl. A23J 3/08; A23L 2/66; A23L 3/015; A23L 3/16

(52) U.S. Cl. CPC A23J 3/08; A23L 2/66; A23L 3/015; A23L 3/16

(57) ABSTRACT

The present invention pertains to a method of preparing modified whey protein compositions by gentle oxidation under conditions that expose and selectively oxidize free thiol groups of beta-lactoglobulin. The resulting modified whey protein product has been found to have an excellent performance in e.g. protein-rich beverage products and has particularly been found to give rise to a reduced level of unpleasant odours during sterilizing heat-treatments at neutral pH and during consumption of such beverage products.

### FIELD OF THE INVENTION

The present invention pertains to a method of preparing modified whey protein compositions by gentle oxidation under conditions that expose and selectively oxidize free thiol groups of beta-lactoglobulin. The resulting modified whey protein product has been found to have an excellent performance in e.g. protein-rich beverage products and has particularly been found to give rise to a reduced level of unpleasant odours during sterilizing heat-treatments at neutral pH and during consumption of such beverage products.

### BACKGROUND

Sterile, pH-neutral, whey protein-rich beverages have a tendency to produce an unpleasant odour similar to the odour of rotten eggs during thermal processing. The beverages are typically bottled immediately after production and therefore also exposes the consumer to the unpleasant odour when the bottle is opened.

Oxidation of whey protein products by e.g. hydrogen peroxide has previously been used to bleach the whey protein products and to create whey protein powders of improved visual quality and acceptable microbiology. Oxidation, however, has also been associated with sensory problems such as the development of unpleasant odours and colour development during storage due to oxidative degradation of certain components of the whey protein compositions.

Jervis et al (“Effect of bleaching whey on sensory and functional properties of 80% whey protein concentrate”; J. Dairy Sci.; 95; page 2848-2862; 2012) disclose a study of the effects of bleaching high protein whey protein concentrates with hydrogen peroxide or benzoyl peroxide at elevated temperature. Non-heated, 10% aqueous solutions of reconstituted oxidized whey protein powder were subjected to sensory analysis where an increased “cardboard flavour” and “fatty flavour” but a decrease in “cooked/milky flavour” was observed.

US20160235082A1 discloses a method of producing heat stable whey protein ingredients that can be produced by subjecting whey protein to specific heat-treatments in the presence of a specific concentration of hydrogen peroxide. The whey protein ingredients including heat stable liquid retentate of WPI, WPC or any other form of whey protein ingredients, and heat stable powders of WPI or WPC or any other whey protein powders can be prepared by heat-treatment of a whey protein solution mixed with a hydrogen peroxide solution. The heat stable whey proteins have the starting whey protein cystine converted to cystine sulfonic acid, such that the free sulfhydryl groups of the major whey protein, beta-lactoglobulin, are converted into compounds, such as cysteine sulphonic acid and/or cysteic acid, which is suggested not only to minimize or eliminate undesirable gelling but also is a precursor for taurine group of compounds.

### SUMMARY OF THE INVENTION

The present inventors have found that gentle oxidation of whey protein products can be used to reduce or even remove the unpleasant odour similar to the odour of rotten eggs produced during the production of whey protein-containing beverages.

An aspect of the invention pertains to a method of producing an oxidized whey protein composition, the method comprising
a) processing a whey protein source to provide an oxidizing whey protein solution comprising:
   oxidizing agent capable of oxidizing the thiol group of cysteine, and
having:
   a pH in the range of 6.5-9.5,
   a total protein content of at least 1% w/w relative to the weight of the oxidizing whey protein solution,
   a beta-lactoglobulin (BLG) content of at least 10% w/w relative to total protein
   preferably, a protein content of at least 30% w/w relative to total solids,
   preferably, a total fat content of at most 3% w/w relative to total solids,
and wherein the oxidizing whey protein solution furthermore:
   i) has a temperature in the range of 0-160 degrees C., and/or
   ii) is pressurized to a pressure in the range of 20-4000 bar,
b) incubating the oxidizing whey protein solution under one or more conditions that allow for oxidation of the free thiol of at least some of the BLG molecules of the oxidizing whey protein solution, preferably to reduce the amount of free thiol groups of the oxidizing whey protein solution to at most 15 micromol/g protein, which one or more conditions involve:
   I) the oxidizing whey protein solution having temperature in the range of 0-160 degrees C., and/or
   II) the oxidizing whey protein solution is pressurized to a pressure in the range of 20-4000 bar,
c) optionally, yet preferably, subjecting the oxidized whey protein solution obtained from step b) or a protein concentrate thereof to a heat-treatment step which involves heating to a temperature of at least 60 degrees C.,
d) optionally, yet preferably, drying a liquid feed comprising at least the protein derived from the oxidized whey protein solution obtained from step b).

Another aspect of the invention pertains to an oxidized whey protein composition having:
a protein content of at least 30% w/w relative to total solids,
preferably, a fat content of at most 3% w/w relative to total solids,
at most 15 micromol free thiol groups/g protein,
preferably, a tryptophan content of at least 0.7% w/w relative to total protein,
preferably, a methionine content of at least 0.3% w/w relative to total protein,
preferably, a kynurenine content of at most 0.2 micrograms/mg protein,
preferably, a content of protein-bound sulfur in the range of 100-600 micromol/g protein,
preferably, a content of protein-bound cysteine residues that form disulfide bonds in the range of 150-400 micromol/g protein
preferably, an weight average molecular weight of the protein in the range of 18 kDa and 10000 kDa, more preferably between 50-8000 kDa, and most preferably 80-5000 kDa, and
preferably, at least 60% w/w of the protein has a molecular weight between 18 kDa and 10000 kDa, more preferably at least 80% w/w, even more preferably at least 90% w/w, and most preferably at least 99% w/w.

A further aspect of the invention pertains to a process of producing a food product comprising:
processing the oxidized whey protein composition described herein, and/or
combining the oxidized whey protein composition described and/or the processed oxidized whey protein composition with one or more further ingredients, and optionally processing the combination.

A preferred example of a food product is a heat-treated, and preferably heat-sterilized, beverage having a pH of 5.5-8.5.

Thus, a more specific aspect of the invention pertains to a process of producing a heat-treated, and preferably heat-sterilized, beverage having a pH of 5.5-8.5, more preferably 6.5-7.5, the process comprises:
1) combining oxidized whey protein composition as described herein with one or more further ingredients to obtain a liquid mixture having a pH of 5.5-8.5, more preferably 6.5-7.5, and comprising:
   the oxidized whey protein composition in an amount sufficient to contribute with at least 0.5% w/w protein, and
   water,
2) packaging the liquid mixture in a container, preferably a sterile container, and wherein the liquid mixture is heat-treated, and preferably heat-sterilised, prior to and/or after packaging.

A further aspect of the invention pertains to the use of an oxidized whey protein composition, preferably the oxidized whey protein composition of the invention, as a food ingredient, preferably for improving the odour and/or reducing the level of unpleasant odour similar to the odour of rotten eggs of heat-sterilized, beverages having a pH in the range of 5.5-8.5, preferably having a whey protein content of at least 3% w/w, and preferably heat-sterilized using indirect heat-treatment.

Yet an aspect of the invention pertains to a food ingredient comprising:
the solids of the oxidized whey protein composition described herein, and
one or more further ingredient(s), preferably selected from:
   a dairy ingredient, preferably a non-oxized dairy ingredient,
   a plant-based ingredient,
   a non-dairy carbohydrate source,
   a flavouring agent, and/or
   a sweetener (sweet carb/polyol/HIS).

Yet an aspect of the invention pertains to the use of an oxidized whey protein composition, preferably the oxidized whey protein composition of the invention, as a food ingredient, preferably for improving the odour and/or reducing the level of unpleasant odour similar to the odour of rotten eggs of heat-sterilized, beverages having a pH in the range of 5.5-8.5, preferably having a whey protein content of at least 3% w/w, and preferably heat-sterilized using indirect heat-treatment.

### SUMMARY OF THE FIGURES

FIG. 1 shows a photo of beverage samples that were subjected to simulated UHT treatment in Example 2b: Sample 1: WPI-B22 (non-heated reference), Sample 2: WPI-B30; Sample 3: WPI-B29; Sample 4: WPI-B28; Sample 5: WPI-B27; Sample 6: WPI-B26; Sample 7: WPI-B25; Sample 8: WPI-B24; Sample 9: WPI-B23.

FIG. 2 shows a plot of the amino acid profile of a non-oxidized WPI reference (WPI-C24), a liquid oxidized WPI according to the invention (WPI-C25) and a oxidized WPI powder according to the invention (WPI-C26). FIG. 2 documents that the present invention allows for selective oxidation of the free thiol of beta-lactoglobulin without damaging the amino acid composition of the whey protein source.

### DESCRIPTION OF THE INVENTION

An aspect of the invention pertains to a method of producing an oxidized whey protein composition, the method comprising:
a) processing a whey protein source to provide an oxidizing whey protein solution comprising:
   oxidizing agent capable of oxidizing the thiol group of cysteine, and
having:
   a pH in the range of 6.5-9.5,
   a total protein content of at least 1% w/w relative to the weight of the oxidizing whey protein solution,
   a beta-lactoglobulin (BLG) content of at least 10% w/w relative to total protein,
   preferably, a protein content of at least 30% w/w relative to total solids,
   preferably, a total fat content of at most 3% w/w relative to total solids,
and wherein the oxidizing whey protein solution furthermore:
   i) has a temperature in the range of 0-160 degrees C., and/or
   ii) is pressurized to a pressure in the range of 20-4000 bar,
b) incubating the oxidizing whey protein solution under one or more conditions that allow for oxidation of the free thiol of at least some of the BLG molecules of the oxidizing whey protein solution, preferably, to reduce the amount of free thiol groups of the oxidizing whey protein solution to at most 15 micromol/g protein, which one or more conditions involve:
   I) the oxidizing whey protein solution having temperature in the range of 0-160 degrees C., and/or
   II) the oxidizing whey protein solution is pressurized to a pressure in the range of 20-4000 bar,
c) optionally, yet preferably, subjecting the oxidized whey protein solution obtained from step b) or a protein concentrate thereof to a heat-treatment step which involves heating to a temperature of at least 60 degrees C.,
d) optionally, yet preferably, drying a liquid feed comprising at least the protein derived from the oxidized whey protein solution obtained from step b).

For example, a preferred embodiment of the invention pertains to a method of producing an oxidized whey protein composition, the method comprising:
a) processing a whey protein source to provide an oxidizing whey protein solution comprising:
   oxidizing agent capable of oxidizing the thiol group of cysteine, and
having:
   a pH in the range of 6.5-9.5,
   a total protein content of at least 1% w/w relative to the weight of the oxidizing whey protein solution,
   a beta-lactoglobulin (BLG) content of at least 10% w/w relative to total protein,
   preferably, a protein content of at least 30% w/w relative to total solids,
   preferably, a total fat content of at most 3% w/w relative to total solids,
and wherein the oxidizing whey protein solution furthermore:
   i) has a temperature in the range of 0-65 degrees C., and/or
   ii) is pressurized to a pressure in the range of 100-4000 bar,
b) incubating the oxidizing whey protein solution under one or more conditions that allow for oxidation of the free thiol of at least some of the BLG molecules of the oxidizing whey protein solution, preferably, to reduce the amount of free thiol groups of the oxidizing whey protein solution to at most 15 micromol/g protein, which one or more conditions involve:
   I) the oxidizing whey protein solution having temperature in the range of 0-65 degrees C., and/or
   II) the oxidizing whey protein solution is pressurized to a pressure in the range of 100-4000 bar,
c) optionally, yet preferably, subjecting the oxidized whey protein solution obtained from step b) or a protein concentrate thereof to a heat-treatment step which involves heating to a temperature of at least 60 degrees C.,
d) optionally, yet preferably, drying a liquid feed comprising at least the protein derived from the oxidized whey protein solution obtained from step b).

In the context of the present invention, the term “oxidized whey protein composition” pertains to the product has a content of free thiol groups of at most 15 micromol/g protein and most preferably at most 10 micromol/g protein, and which may by obtainable from the present method.

In the context of the present invention, the term “free thiol group” pertains to an —SH group which e.g. is present in the amino acid cysteine. In whey protein products, free thiol groups typically form part of the protein and are typically provided by the cysteine residues of the protein. In the present context, the term “free” means that the —SH groups have not reacted with other —SH groups to form disulfide bonds (—S—S—). The content of free thiol groups is measured according to Analysis E.

In the context of the present invention, the term “total amount of thiol groups” pertains to the sum of thiol groups which is either present in the form of —SH (i.e. as free thiols) or which is present in the form of disulphide bonds (—S—S—). The total amount of thiol groups is measured according to Analysis E.

In the context of the present invention, the term “oxidizing whey protein solution” pertains to an aqueous whey protein solution that contains an oxidizing agent, such as e.g. a peroxide, which can oxidize the free thiol group of cysteine.

In the context of the present invention, the term “beta-lactoglobulin” or BLG, pertains to BLG from mammal species, e.g. in native and/or glycosylated forms and includes the naturally occurring genetic variants. The term BLG also encompasses mammal BLG produced by recombinant microorganisms. The term “BLG” or “beta-lactoglobulin” as used herein excludes unfolded and aggregated BLG. The content of BLG is measured according to Analysis L.

In the context of the present invention, the term “oxidizing agent capable of oxidizing the thiol group of cysteine” refers to one or more oxidizing agents characterized by their ability to oxidize the thiol group of cysteine, and therefore, also oxidize the free thiol group of BLG when the free thiol group is made accessible. Useful examples are e.g. peroxides approved for food production, and most preferably, hydrogen peroxide.

The term “whey” pertains to the liquid phase that is left after the casein of milk has been precipitated and removed. Casein precipitation may e.g. be accomplished by acidification of milk and/or by use of rennet enzyme. Several types of whey exist, such as “sweet whey”, which is the whey product produced by rennet-based precipitation of casein, and “acid whey” or “sour whey”, which is the whey product produced by acid-based precipitation of casein. Acid-based precipitation of casein may e.g. be accomplished by the addition of food acids or by means of bacterial cultures.

The term “milk serum” pertains to the liquid which remains when casein and milk fat globules have been removed from milk, e.g. by microfiltration or large pore ultrafiltration. Milk serum may also be referred to as “ideal whey”.

In the context of the present invention, the term “whey protein” pertains to the protein that is found in whey or milk serum. Whey protein may be a subset of the protein species found in whey or milk serum, and even a single whey protein species or it may be the complete set of protein species found in whey or/and in milk serum.

Unfractionated whey protein typically contains alpha-lactalbumin (ALA), beta-lactoglobulin (BLG), bovine serum albumin, immunoglobulins, osteopontin, lactoferrin, and lactoperoxidase. Whey protein derived from rennet treated milk furthermore comprise caseinomacropeptide (CMP) in addition to the other protein species.

The methods of analysis described herein are used determine the corresponding parameters in relation to the invention.

In some preferred embodiments of the invention, the oxidizing agent capable of oxidizing the thiol group of cysteine comprises or even consists of a peroxide, ozone, dioxygen, or a combination thereof.

It is particularly preferred that the oxidizing agent capable of oxidizing the thiol group of cysteine comprises, or even consists of one or more peroxides, and the oxygen that is dissolved in oxidizing whey protein solution.

Even more preferably, the oxidizing agent capable of oxidizing the thiol group of cysteine comprises, or even consists of hydrogen peroxide, and the oxygen that is dissolved in oxidizing whey protein solution.

In some preferred embodiments of the invention, the oxidizing agent capable of oxidizing the thiol group of cysteine of step a) comprises peroxide in an amount of at least 50% mol/mol relative to the total amount of oxidizing agent capable of oxidizing the thiol group of cysteine, more preferably at least 70% mol/mol, even more preferably at least 80% mol/mol, and most preferably at least 90% mol/mol.

Even higher contents of peroxide are often preferred, and in some preferred embodiments of the invention, the oxidizing agent capable of oxidizing the thiol group of cysteine of step a) comprises peroxide in an amount of at least 92% mol/mol relative to the total amount of oxidizing agent capable of oxidizing the thiol group of cysteine comprises peroxide, more preferably at least 94% mol/mol, even more preferably at least 96% mol/mol, and most preferably at least 98% mol/mol.

It is often preferred that the oxidizing agent capable of oxidizing the thiol group of cysteine comprises or even consists of a peroxide selected from the group consisting of hydrogen peroxide, benzoyl peroxide, peracetic acid, or a mixture thereof.

It is particularly preferred that the oxidizing agent capable of oxidizing the thiol group of cysteine comprises or even consists of hydrogen peroxide.

In some preferred embodiments of the invention, the oxidizing agent capable of oxidizing the thiol group of cysteine of step a) comprises hydrogen peroxide in an amount of at least 50% mol/mol relative to the total amount of oxidizing agent capable of oxidizing the thiol group of cysteine, more preferably at least 70% mol/mol, even more preferably at least 80% mol/mol, and most preferably at least 90% mol/mol.

Even higher contents of hydrogen peroxide are often preferred, and in some preferred embodiments of the invention, the oxidizing agent capable of oxidizing the thiol group of cysteine of step a) comprises hydrogen peroxide in an amount of at least 92% mol/mol relative to the total amount of oxidizing agent capable of oxidizing the thiol group of cysteine, more preferably at least 94% mol/mol, even more preferably at least 96% mol/mol, and most preferably at least 98% mol/mol.

In some preferred embodiments of the invention, the oxidizing agent capable of oxidizing the thiol group of cysteine is generated enzymatically. E.g. by use of a lactose oxidase or a hexose oxidase, such as e.g. glucose oxidase.

In other preferred embodiments, the oxidizing agent capable of oxidizing the thiol group of cysteine is generated electrochemically.

There are two main approaches for dosing oxidizing agents capable of oxidizing the thiol group of cysteine to the oxidizing whey protein solution of step a).

In the first approach all required oxidizing agent capable of oxidizing the thiol group of cysteine is added during step a), and then, at least partially used during step b). This approach is easy to implement but is often slightly more prone to generate undesired oxidation than the second approach.

The second approach uses a relatively low initial content of oxidizing agent capable of oxidizing the thiol group of cysteine in step a) but involves additional dosing of oxidizing agent capable of oxidizing the thiol group of cysteine during step b), either continuously or by discrete addition(s). The inventors have found this approach to provide a very gentle oxidation of the free thiol groups but it is slightly more complex to implement than the first approach.

It is furthermore feasible to implement the method by adding most of the oxidixing agent during step a) but supplementing with some oxidizing agent during step b).

In some preferred embodiments of the invention, particularly useful for the first approach, the molar ratio between:
the oxidizing agent capable of oxidizing the thiol group of cysteine, and
the total amount of free thiol groups
   of the oxidizing whey protein solution of step a) is at least 1:2, more preferably at least 1:1, and most preferably at least 2:1.

It is often preferred that the molar ratio between:
the oxidizing agent capable of oxidizing the thiol group of cysteine, and
the total amount of free thiol groups
   of the oxidizing whey protein solution of step a) is at least 3:1, more preferably at least 5:1, and most preferably at least 10:1.

In the context of the present invention, a ratio between the amount of a first component (A) and the amount of a second component (B) means A divided by B which is also represented by A:B.

In the first approach, preferably, the molar ratio between:
the oxidizing agent capable of oxidizing the thiol group of cysteine, and
the total amount of free thiol groups
   of the oxidizing whey protein solution of step a) is 1:2-200:1, more preferably 1:1-100:1, even more preferably 2:1-30:1, and most preferably 4:1-15:1.

Alternatively, but also preferred in relation to the first approach, the molar ratio between:
the oxidizing agent capable of oxidizing the thiol group of cysteine, and
the total amount of free thiol groups
   of the oxidizing whey protein solution of step a) is 1:2-15:1, more preferably 1:1.5-10:1, even more preferably 1:1-8:1, and most preferably 1:1-3:1.

It is often preferred that the molar ratio between:
the oxidizing agent capable of oxidizing the thiol group of cysteine, and
the total amount of free thiol groups
   of the oxidizing whey protein solution of step a) is 1:2-200:1, more preferably 1:1-100:1, even more preferably 2:1-30:1, and most preferably 4:1-15:1.

Alternatively, but also preferred, the molar ratio between:
the oxidizing agent capable of oxidizing the thiol group of cysteine, and
the total amount of free thiol groups
   of the oxidizing whey protein solution of step a) may be 1:2-15:1, more preferably 1:1.5-10:1, even more preferably 1:1-8:1, and most preferably 1:1-3:1.

In some preferred embodiments of the invention the molar ratio between:
the oxidizing agent capable of oxidizing the thiol group of cysteine, and
the total amount of free thiol groups
   of the oxidizing whey protein solution of step a) is 1:1.5-15:1, more preferably 1:1.5-10:1, even more preferably 1:1.5-8:1, and most preferably 1:1.5-3:1.

It is furthermore preferred in relation to the first approach, that the molar ratio between:
the oxidizing agent capable of oxidizing the thiol group of cysteine, and
the total amount of free thiol groups
   of the oxidizing whey protein solution of step a) is 2:1-30:1, more preferably 3:1-25:1, even more preferably 4:1-20:1, and most preferably 5:1-15:1.

In other preferred embodiments of the invention, particularly useful for the second approach, the molar ratio between:
the oxidizing agent capable of oxidizing the thiol group of cysteine, and
the total amount of free thiol groups
   of the oxidizing whey protein solution of step a) is at most 5:1, more preferably at most 2:1, even more preferably at most 1:1, and most preferably at most 1:2.

Preferably, and particularly useful for the second approach, the molar ratio between:
the oxidizing agent capable of oxidizing the thiol group of cysteine, and
the total amount of free thiol groups
   of the oxidizing whey protein solution of step a) is at most 1:4, more preferably at most 1:10, even more preferably at most 1:20, and most preferably at most 1:40.

In the second approach, preferably, the molar ratio between:
the oxidizing agent capable of oxidizing the thiol group of cysteine, and
the total amount of free thiol groups
   of the oxidizing whey protein solution of step a) is 1:100-5:1, more preferably 1:60-2:1, even more preferably 1:40-1:1, and most preferably 1:20-1:2.

The oxidizing whey protein solution of step a) has a pH in the range of 6.5-9.5.

In some preferred embodiments of the invention, the oxidizing whey protein solution of step a) has a pH in the range of 7.0-9.5, more preferably 7.1-8.5, even more preferably 7.2-8.5, and most preferably 7.4-8.2. The inventors have found these pH ranges to be particularly beneficial for rapid and selective oxidation of the free thiol groups of BLG.

In other preferred embodiments of the invention, the oxidizing whey protein solution of step a) has a pH in the range of 7.5-9.5, more preferably 7.6-8.5, even more preferably 7.7-8.4, and most preferably 7.7-8.3. The inventors have found these pH ranges to be particularly beneficial for rapid and selective oxidation of the free thiol groups of BLG.

Alternatively, but also preferred the oxidizing whey protein solution of step a) may have a pH in the range of 6.5-8.5, more preferably 6.6-8.0, even more preferably 6.7-7.5, and most preferably 6.8-7.3.

The inventors have found that it is advantageous to operate the method with a protein content of at least 1% w/w preferably even higher to improve the production capacity and reduce the water and energy consumption of the process, particularly when drying is required.

In some preferred embodiments of the invention, the oxidizing whey protein solution of step a) has a total protein content of at least 2% w/w relative to the weight of the oxidizing whey protein solution, more preferably at least 3% w/w, even more preferably at least 5% w/w and most preferably at least 6% w/w.

Preferably the oxidizing whey protein solution of step a) has a total protein content in the range of 1-30% w/w relative to the weight of the oxidizing whey protein solution, more preferably 3-20% w/w, even more preferably 4-15% w/w, and most preferably at least 6-10% w/w.

The inventors have observed that it often is advantageous to keep the protein content at or below 12% w/w as this seems to limit the level of protein aggregation caused during step b). It is often preferred that the oxidizing whey protein solution of step a) has a total protein content in the range of 1-12% w/w relative to the weight of the oxidizing whey protein solution, more preferably 3-11% w/w, even more preferably 4-10% w/w, and most preferably at least 5-9% w/w.

In some preferred embodiments of the invention, the oxidizing whey protein solution of step a) has a total protein content of at least 30% w/w relative to the total solids of the oxidizing whey protein solution, more preferably at least 50% w/w, even more preferably at least 75% w/w and most preferably at least 85% w/w relative to the total solids of the oxidizing whey protein solution.

Preferably, the oxidizing whey protein solution of step a) has a total protein content in the range of 30-99% w/w relative to the total solids of the oxidizing whey protein solution, more preferably 50-97% w/w, even more preferably 75-96% w/w, and most preferably at least 85-95% w/w relative to the total solids of the oxidizing whey protein solution.

The oxidizing whey protein solution of step a) has a BLG content of at least 10% w/w relative to the total protein.

The inventors have found the whey protein BLG to be at least partially responsible for the formation of unpleasant odours during heat-treatment of pH-neutral food products, and the free thiol group of BLG is believed to be involved in the odour formation. The present invention is therefore particularly suitable for processing of whey protein sources that contain some BLG and preferably at least 10% w/w BLG relative to total protein.

In some preferred embodiments of the invention, the oxidizing whey protein solution of step a) has a BLG content of at least 20% w/w relative to the total protein of the oxidizing whey protein solution, more preferably at least 40% w/w, even more preferably at least 45% w/w and most preferably at least 50% w/w relative to the total protein of the oxidizing whey protein solution.

Even more preferred, the oxidizing whey protein solution of step a) may have a BLG content of at least 55% w/w relative to the total protein of the oxidizing whey protein solution, more preferably at least 60% w/w, even more preferably at least 80% w/w and most preferably at least 90% w/w relative to the total protein of the oxidizing whey protein solution.

Preferably, the oxidizing whey protein solution of step a) has a BLG content in the range of 10-99% w/w relative to the total protein of the oxidizing whey protein solution, more preferably 45-98% w/w, even more preferably 80-96% w/w, and most preferably 90-95% w/w relative to the total protein of the oxidizing whey protein solution.

Alternatively, but also preferred, the oxidizing whey protein solution of step a) may have a BLG content in the range of 10-90% w/w relative to the total protein of the oxidizing whey protein solution, more preferably 20-80% w/w, even more preferably 30-75% w/w, and most preferably 45-70% w/w relative to the total protein of the oxidizing whey protein solution.

Features and preferences described in relation to the protein composition of the whey protein source equally apply to the protein composition of oxidizing whey protein solution of step a).

The oxidizing whey protein solution of step a) and the whey protein source from which it has been prepared typically, also comprise other whey proteins, at least in trace amounts. For example, the oxidizing whey protein solution of step a) and the whey protein source from which it has been prepared typically, also contain one or more of alpha-lactalbumin (ALA), caseinomacropeptide (CMP), bovine serum albumin, immunoglobulins, osteopontin, lactoferrin, and lactoperoxidase.

The oxidizing whey protein solution of step a) and the whey protein source from which it has been prepared preferably contains casein in an amount of at most 20% w/w relative to total protein, more preferably at most 10% w/w, even more preferably at most 6% w/w, and most preferably at most 2% w/w relative to total protein.

The inventors have found that the fat level of the oxidizing whey protein solution of step a), preferably, is kept low and preferably lower than what is typically found in whey protein concentrates and high fat WPIS.

Preferably, the oxidizing whey protein solution of step a) has a total fat content of at most 3% w/w relative to total solids.

Even lower levels of fat are typically preferred and it is often preferred that the oxidizing whey protein solution of step a) has a total fat content of at most 1% w/w relative to total solids, more preferably at most 0.5% w/w, even more preferably at most 0.2% w/w, and most preferably at most 0.1% w/w relative to total solids.

The oxidizing whey protein solution of step a) may contain carbohydrates in various amounts.

However, often it is preferred that the oxidizing whey protein solution of step a) has a carbohydrate content of at most 65% w/w relative to total solids.

Even lower levels of carbohydrate are typically preferred and it is often preferred that the oxidizing whey protein solution of step a) has a carbohydrate content of at most 20% w/w relative to total solids, more preferably at most 8% w/w, even more preferably at most 2% w/w, and most preferably at most 0.2% w/w relative to total solids.

The oxidizing whey protein solution of step a) preferably has a degree of protein denaturation of at most 30%, more preferably at most 25%, even more preferably at most 20% and most preferably at most 15%.

The degree of protein denaturation is determined according to Example 1.3 of WO 2020/002426.

Even lower degrees of protein denaturation are often preferred, and in some preferred embodiments of the present invention, the oxidizing whey protein solution of step a), preferably, has a degree of protein denaturation of at most 12%, more preferably at most 10%, even more preferably at most 8% and most preferably at most 5%.

The oxidizing whey protein solution of step a) preferably has an ash content of at most 8% w/w relative to total solids, more preferably at most 6% w/w, even more preferably at most 5% and most preferably at most 4.0%.

In some preferred embodiments of the present invention, the oxidizing whey protein solution of step a) preferably has an ash content of 0.4-8% w/w relative to total solids, more preferably at most 0.5-6% w/w, even more preferably 0.5-5% w/w and most preferably 0.6-4.0% w/w relative to total solids.

The ash content of a composition is determined according to Example 1.13 of WO 2020/002426.

The oxidizing whey protein solution of step a) preferably has a combined content of magnesium and calcium of at most 1% w/w relative to total solids, more preferably at most 0.7% w/w, even more preferably at most 0.5% w/w, and most preferably at most 0.2% w/w relative to total solids.

In some preferred embodiments of the present invention, the oxidizing whey protein solution of step a) preferably has combined contents of magnesium and calcium of 0.01-1% w/w relative to total solids, more preferably at most 0.001-0.7% w/w, even more preferably 0.01-0.5% w/w and most preferably 0.01-0.2% w/w relative to total solids.

The oxidizing whey protein solution of step a) has a solids content of 0.5-50% w/w, more preferably 1-35% w/w, even more preferably 2-20% w/w, and most preferably 3-10% w/w.

The part of the oxidizing whey protein solution of step a), that is not made up of solids, preferably comprises water. The part of the oxidizing whey protein solution of step a), that is not made up of solids, preferably comprises water in an amount of at least 80% w/w, more preferably at least 90% w/w, even more preferably 95% w/w, and more preferably at least 99% w/w.

The oxidizing whey protein solution of step a) furthermore:
i) has a temperature in the range of 0-160 degrees C., and/or
ii) is pressurized to a pressure in the range of 20-4000 bar.

This means that the oxidizing whey protein solution of step a) must:
i) have a temperature in the range of 0-160 degrees C., or
ii) be pressurized to a pressure in the range of 20-4000 bar, or
i+ii) have a temperature in the range of 0-160 degrees C. and be pressurized to a pressure in the range of 20-4000 bar

In some preferred embodiments of the invention, step a) comprises condition i).

In other preferred embodiments of the invention, step a) comprises condition ii).

In further preferred embodiments of the invention, step a) comprises both features i) and ii).

It is feasible to implement the invention using both the temperature range of i) and the pressure range of ii) at the same time and both the elevated temperature and the increased pressure has been found by the inventors to favour selective oxidation of the free thiol of BLG under the conditions described herein.

Preferably, condition i) of step a) involves the oxidizing whey protein solution having a temperature in the range of 5-65 degrees C., more preferably 10-65 degrees C., even more preferably 30-60 degrees C., and most preferably 40-55 degrees C.

The inventors have found that the lowest pH ranges, close to pH 6.5, require higher temperatures for efficient oxidation than the higher pH ranges.

In some embodiments of the invention, the pH of the oxidizing whey protein solution of step a) is in the range 6.5-7.0 and its temperature is in the range of 40-65 degrees C., more preferably 45-65 degrees C., even more preferably 50-65 degrees C., and most preferably 55-65 degrees C.

In some preferred embodiments of the present invention, the pH of the oxidizing whey protein solution of step a) is in the range 7.1-9.5 and its temperature is in the range of 5-65 degrees C., more preferably 10-65 degrees C., even more preferably 30-60 degrees C., and most preferably 40-55 degrees C.

In other preferred embodiments of the present invention, the pH of the oxidizing whey protein solution of step a) is in the range 8.5-9.5 and its temperature is in the range of 0-65 degrees C., more preferably 0-50 degrees C., even more preferably 0-30 degrees C., and most preferably 5-25 degrees C.

The inventors have found that it is particularly preferred that the pH of the oxidizing whey protein solution of step a) is in the range 7.5-8.5 and that its temperature is in the range of 5-60 degrees C., more preferably 10-60 degrees C., even more preferably 15-60 degrees C., and most preferably 20-60 degrees C. These ranges seem to favour both selective oxidation of the free thiol of BLG and relatively fast kinetics of the reaction.

Additionally, the inventors have found that it is particularly preferred that the pH of the oxidizing whey protein solution of step a) is in the range 7.7-8.5 and that its temperature is in the range of 25-55 degrees C., more preferably 30-55 degrees C., even more preferably 35-50 degrees C., and most preferably 35-45 degrees C. These ranges also seem to favour both selective oxidation of the free thiol of BLG and relatively fast kinetics of the reaction.

The inventors have found that it is sometimes advantageous from a production perspective that the oxidizing whey protein solution of step a) has a pH in the range of 6.8-7.5 as this reduces the need for pH adjustments after the oxidation.

The inventors have observed that even higher temperatures can be be used in step a) and in some preferred embodiments of the invention condition i) involves the oxidizing whey protein solution of step a) having a temperature in the range of 66-160 degrees C., more preferably 70-145 degrees C., even more preferably 75-120 degrees C., and most preferably 80-100 degrees C.

Additionally, the inventors have found that it is particularly preferred that the pH of the oxidizing whey protein solution of step a) is in the range 7.5-8.5, more preferably 7.7-8.5 and that its temperature is in the range of 66-160 degrees C., more preferably 70-145 degrees C., even more preferably 75-120 degrees C., and most preferably 80-100 degrees C. These ranges also seem to favour both selective oxidation of the free thiol of BLG and relatively fast kinetics of the reaction. As seen in Example 16, these combinations allow for a very fast step b), and an oxidation process that is completed in the order of minutes or less.

When step a) uses condition i) the pressure of the oxidizing whey protein solution is typically less than 100 bar, and typically in the range 0.1-100 bar, and more preferably in the range of 1-80 bar.

Pressures of 100 bar or higher may be used by combining condition i) and condition ii) of step a).

Preferably, condition ii) of step a) involves that the oxidizing whey protein solution of step a) is subjected to a pressure in the range of 20-4000 bar, more preferably 200-3500 bar, even more preferably 300-3000 bar, and most preferably 500-2500 bar.

In some preferred embodiments of the present invention, condition ii) of step a) involves that the oxidizing whey protein solution of step a) is subjected to a pressure in the range of 100-1000 bar, more preferably 150-800 bar, even more preferably 200-600 bar, and most preferably 200-500 bar.

In other preferred embodiments of the invention condition ii) involves that the oxidizing whey protein solution of step a) is subjected to a pressure in the range of 25-1000 bar, more preferably 30-500 bar, even more preferably 35-300 bar, and most preferably 40-200 bar.

When condition ii) is used in step a) the temperature is typically in the range of 0-65 degrees C., more preferably 5-65 degrees C., even more preferably 20-60 degrees C., and most preferably 40-60 degrees C. and condition. Therefore condition ii) is preferably used together with condition i, whereas condition i) may be used without condition ii).

The inventors have found that lower temperatures often are sufficient when step a) also involves condition ii). In some preferred embodiments of the invention, step a) involves the use of condition ii) and the oxidizing whey protein solution of step a) has a temperature in the range of 0-50 degrees C., more preferably 0-40 degrees C., even more preferably 0-30 degrees C., and most preferably 2-20 degrees C.

However, when condition ii) is used in step a) the temperature may also be in the range of 66-160 degrees C., more preferably 70-145 degrees C., even more preferably 75-120 degrees C., and most preferably 80-100 degrees C.

The processing of a whey protein source in step a) typically involves one or more process steps that bring the whey protein source in contact with the oxidizing agent capable of oxidizing the thiol of cysteine and adjust protein content, pH, and the temperature and/or pressure to the desired level.

Preferably, the processing of the whey protein source in step a) involves at least I and II and optionally also III and/or IV of the following:
I) contacting, preferably by combining or mixing, the whey protein source with at least one oxidizing agent capable of oxidizing the thiol of cysteine, and optionally further ingredients; e.g. water,
II) if required, pH adjustment to obtain the desired pH range, e.g. a pH in the range of 6.5-9.5
III) optionally, pressurisation to obtain the desired pressure range, e.g. pressure in the range of 20-4000 bar, such as e.g. 100-4000 bar or 20-200 bar
IV) optionally, adjustment of the temperature to the desired temperature range, e.g a temperature in the range of 0-160 degrees C., such as e.g. 0-65 degrees C. or 66-160 degrees C.

It is often preferred that to keep the oxidizing whey protein solution in liquid form and if the temperature of the oxidizing whey protein solution is to exceed e.g. 100 degrees C. the solution can be pressurized to avoid boiling and evaporation.

In step a), the order for the processing steps I, II, III, and IV is less important as long as an oxidizing whey protein solution with the desired characteristics is obtained.

The pH adjustment of processing step II) preferably takes place prior to processing step I) or during process step I). Alternatively, the pH adjustment of processing step II) may take place after processing step I). However, it is often preferred in step a) to minimize the duration in which the whey protein source and the oxidizing agent is in contact but where the pH and the temperature and/or pressure are outside the desired ranges.

Processing step III) preferably takes place after processing step I).

Processing step IV) preferably takes place prior to processing step I), during processing step I) or after processing step I).

Preferably, the whey protein source and any intermediate mixture containing the whey protein source during step a) do not have temperatures higher than 65 degrees C. and most preferably not higher than 55 degrees C.

In the context of the present invention, the term “whey protein source” pertains to the whey protein composition(s) that is (are) used to prepare the oxidizing whey protein solution of step a). The whey protein source may be a single whey protein composition, e.g. a whey protein powder or an aqueous whey protein liquid, or it may be the combination of several sub-sources e.g. several whey protein powders and/or several aqueous whey protein liquids. If several sub-sources are used, they may be combined to form a single composition prior to the preparation of the oxidizing whey protein solution of step a) or they may be added individually during the preparation of the oxidizing whey protein solution of step a). If several sub-sources are used, the term “whey protein source” describes the characteristics of the combination of the used sub-sources.

The whey protein source may be a powder or a liquid. If provided in powder form, it is preferred that the whey protein source powder is reconstituted in water and allowed to hydrate for at least 0.5 hours before additional processing is performed.

The whey protein source is preferably a whey protein concentrate (WPC), a whey protein isolate (WPI), or a combination thereof.

In the context of the present invention, the term “whey protein concentrate” (WPC) pertains to dry or aqueous compositions which contain a total amount of protein of 20-89% w/w relative to total solids.

A WPC preferably contains:
30-85% w/w protein relative to total solids,
15-90% w/w BLG relative to total protein,
4-50% w/w ALA relative to total protein, and
0-40% w/w CMP relative to protein.

Most preferably a WPC contains:
70-85% w/w protein relative to total solids,
30-90% w/w BLG relative to total protein,
4-35% w/w ALA relative to total protein, and
0-25% w/w CMP relative to protein.

WPC based on milk serum protein typically contains no CMP or only traces of CMP.

The term “whey protein isolate” (WPI) pertains to dry or aqueous compositions which contain a total amount of protein of 86-100% w/w relative to total solids.

A WPI preferably contains:
86-99% w/w protein relative to total solids,
30-100% w/w BLG relative to total protein,
0-35% w/w ALA relative to total protein, and
0-25% w/w CMP relative to total protein.

Most preferably a WPI contains:
90-99% w/w protein relative to total solids,
50-99% w/w BLG relative to total protein,
0-35% w/w ALA relative to total protein, and
0-25% w/w CMP relative to total protein.

WPI based on milk serum protein typically contains no CMP or only traces of CMP.

It is particularly preferred that the whey protein source is a WPI.

Features and preferences described in relation to the protein composition, fat composition, carbohydrate composition and mineral composition of the oxidizing whey protein solution of step a) equally apply to the whey protein source.

The whey protein source preferably has a degree of protein denaturation of at most 30%, more preferably at most 25%, even more preferably at most 20% and most preferably as most 15%.

An even lower degree of protein denaturation is often preferred, and in some preferred embodiments of the present invention, the whey protein source has a degree of protein denaturation of at most 12%, more preferably at most 10%, even more preferably at most 8%, and most preferably at most 5%.

In step b), the oxidizing whey protein solution is incubated under one or more conditions that allow for oxidation of the free thiol of at least some of the BLG molecules of the oxidizing whey protein solution.

By “one or more conditions” is meant under certain temperature conditions and/or under certain pressure conditions.

The inventors have found that even oxidation of only some of the free thiol groups, referred to as “partial oxidation” in the present context, may be sufficient if the method includes the heat-treatment of step c) and have seen evidence that the oxidised thiol groups react with non-oxidized free thiol groups during step c) and form stable, intermolecular disulfide bonds.

In some preferred embodiments of the invention, step b) reduces, or is performed to reduce, the initial amount of free thiol groups of the oxidizing whey protein solution of step a) to at most 80% of the initial amount, more preferably to at most 76%, even more preferably to at most 73%, and most preferably to at most 70% of the initial amount.

In some preferred embodiments of the invention, step b) reduces, or is performed to reduce, the initial amount of free thiol groups of the oxidizing whey protein solution of step a) to 20-80% of the initial amount, more preferably to 30-80%, even more preferably to 50-75%, and most preferably to 60-75% of the initial amount. These ranges are often preferred when the method includes step c).

In some preferred embodiments of the invention, relevant both with or without step c), step b) reduces, or is performed to reduce, the initial amount of free thiol groups of the oxidizing whey protein solution of step a) to at most 30% of the initial amount, more preferably to at most 25%, even more preferably to at most 20%, and most preferably to at most 15% of the initial amount.

Preferably, and relevant both with or without step c), step b) reduces, or is performed to reduce, the initial amount of free thiol groups of the oxidizing whey protein solution of step a) to at most 10% of the initial amount, more preferably to at most 5%, even more preferably to at most 3%, and most preferably to at most 1% of the initial amount.

Small residual amounts of free thiol can often be tolerated, and may even be desirable to avoid subjecting the other components of the whey protein solution to unnecessary oxidative damage. Preferably, step b) reduces, or is performed to reduce, the initial amount of free thiol groups of the oxidizing whey protein solution of step a) to 0.01-30% of the initial amount, more preferably 0.02-25%, even more preferably 0.05-20%, and most preferably to 0.1-10% of the initial amount.

In some preferred embodiments of the present invention, step b) reduces, or is performed for a duration sufficient to reduce, the amount of free thiol of the oxidizing whey protein solution to at most 15 micromol/g protein, more preferably at most 14 micromol/g protein, even more preferably at most 13 micromol/g protein, and most preferably at most 12 micromol/g protein.

Preferably, step b) reduces, or is performed for a duration sufficient to reduce, the amount of free thiol of the oxidizing whey protein solution to 0.001-15 micromol/g protein, more preferably to 0.01-14 micromol/g protein, even more preferably to 0.01-13 micromol/g protein, and most preferably to 0.01-12 micromol/g protein.

Lower levels are often preferred, and in some preferred embodiments of the present invention, step b) reduces, or is performed for a duration sufficient to reduce, the amount of free thiol of the oxidizing whey protein solution to at most 10 micromol/g protein, more preferably at most 8 micromol/g protein, more preferably at most 5 micromol/g protein, even more preferably at most 3 micromol/g protein, and most preferably at most 2 micromol/g protein.

Preferably, step b) reduces, or is performed for a duration sufficient to reduce, the amount of free thiol of the oxidizing whey protein solution to 0.001-10 micromol/g protein, more preferably to 0.01-8 micromol/g protein, more preferably to 0.01-5 micromol/g protein, even more preferably to 0.01-3 micromol/g protein, and most preferably to 0.01-2 micromol/g protein.

Even lower levels of free thiol groups may be desired, and in some preferred embodiments of the invention, step b) reduces, or is performed for a duration sufficient to reduce, the amount of free thiol of the oxidizing whey protein solution to at most 1 micromol/g protein, more preferably at most 0.7 micromol/g protein, even more preferably at most 0.5 micromol/g protein, and most preferably at most 0.2 micromol/g protein.

The inventors have observed that the oxidation of step b) causes a slight reduction in the pH of the whey protein solution, and have found that it often is advantageous to adjust the pH during step b) to keep it in the desired pH interval. Particularly, when higher ratios between oxidant and thiol groups are used.

In some preferred embodiments of the invention, step b) involves adjusting the pH during the oxidation to a pH in the range of 6.5-9.5, more preferably 7.0-8.5, even more preferably 7.2-8.5, and most preferably 7.5-8.5.

The inventors have found that performing the oxidation in the range the pH 7.0-8.5, even more preferably 7.2-8.5, and most preferably 7.5-8.5, gives rise to selective oxidation of free thiol groups relative to other oxidation targets within the whey protein solution, such as e.g. methionine and tryptophan.

Preferably, step b) involves adjusting the pH during the oxidation to a pH in the range of 7.5-9.5, more preferably 7.6-8.5, even more preferably 7.7-8.4, and most preferably 7.7-8.3.

The pH adjustment of step b) may e.g. involve one or more discrete pH adjustments, or more preferably continuous pH control, e.g. using a pH stat. The pH adjustment preferably employs one or more food acceptable acids and or bases.

The inventors have found that it is beneficial to limit the amount of consumed oxidizing agent during step b) particularly to avoid undesirable oxidation reactions.

In some preferred embodiments of the invention, the molar ratio between:
the amount of oxidizing agent capable of oxidizing the thiol group of cysteine consumed during step b) but excluding any removal of excess oxidizing agent at the end of step b), and
the initial amount of free thiol groups in step a) is 1:2-30:1, more preferably 1:2-25:1, even more preferably 1:2-20:1, and most preferably 1:1-15:1.

Often it is preferred that the molar ratio between:
the amount of oxidizing agent capable of oxidizing the thiol group of cysteine consumed during step b) but excluding any removal of excess oxidizing agent at the end of step b), and
the initial amount of free thiol groups in step a) is 2:1-30:1, more preferably 3:1-25:1, even more preferably 4:1-20:1, and most preferably 5:1-15:1.

The inventors have found that, surprisingly, even partial oxidation of free thiol groups combined with the heat-treatment of step c) gives rise to oxidized whey protein composition with a very low content free thiol groups. Thus, in some preferred embodiments of the invention, the molar ratio between:
the amount of oxidizing agent capable of oxidizing the thiol group of cysteine consumed during step b) but excluding any removal of excess oxidizing agent at the end of step b), and
the initial amount of free thiol groups in step a) is 1:4-15:1, more preferably 1:3-10:1, even more preferably 1:2-5:1, and most preferably 1:2-2:1.

Preferably, step b), and the method of the invention as such, does not involve the addition of sulphites and does not involve sulphitolysis.

In some preferred embodiments of the invention, the one or more conditions of step b) involve I) the oxidizing whey protein solution having a temperature in the range of 5-65 degrees C., more preferably 10-65 degrees C., even more preferably 30-60 degrees C., and most preferably 40-60 degrees C.

The temperature range of the temperature of the oxidizing whey protein solution of step b) is preferably the same as the temperature range of the temperature of the oxidizing whey protein solution of step a). However, the inventors have also found that it may be beneficial to increase the temperature of during step b) e.g. if step a) provides a relatively low temperature and they have found that that step b) may contain several different temperature stages.

The inventors have found that the lowest pH ranges, close to pH 6.5, require higher temperatures for efficient oxidation than the higher pH ranges.

In some embodiments of the invention, the pH of the oxidizing whey protein solution of step b) is in the range 6.5-7.0 and its temperature is in the range of 40-65 degrees C., more preferably 45-65 degrees C., even more preferably 50-65 degrees C., and most preferably 55-65 degrees C.

In some preferred embodiments of the present invention, the pH of the oxidizing whey protein solution of step b) is in the range 7.1-9.5 and its temperature is in the range of 5-65 degrees C., more preferably 10-65 degrees C., even more preferably 30-60 degrees C., and most preferably 40-55 degrees C.

In other preferred embodiments of the present invention, the pH of the oxidizing whey protein solution of step b) is in the range 8.5-9.5 and its temperature is in the range of 0-65 degrees C., more preferably 0-50 degrees C., even more preferably 0-30 degrees C., and most preferably 5-25 degrees C.

The inventors have found that it is particularly preferred that the pH of the oxidizing whey protein solution of step b) is in the range 7.5-8.5 and that its temperature is in the range of 5-60 degrees C., more preferably 10-60 degrees C., even more preferably 15-60 degrees C., and most preferably 20-60 degrees C. These ranges seems to favour both selective oxidation of the free thiol of BLG and relatively fast kinetics of the reaction.

Additionally, the inventors have found that it is particularly preferred that the pH of the oxidizing whey protein solution of step b) is in the range 7.7-8.5 and that its temperature is in the range of 25-55 degrees C., more preferably 30-55 degrees C., even more preferably 35-50 degrees C., and most preferably 35-45 degrees C. These ranges also seem to favour both selective oxidation of the free thiol of BLG and relatively fast kinetics of the reaction.

The inventors have found that even higher temperatures can be be used in step b) and in some pepi condition I) involves the oxidizing whey protein solution of step b) having a temperature in the range of 66-160 degrees C., more preferably 70-145 degrees C., even more preferably 75-120 degrees C., and most preferably 80-100 degrees C.

Additionally, the inventors have found that it is particularly preferred that the pH of the oxidizing whey protein solution of step b) is in the range 7.5-8.5, more preferably 7.7-8.5 and that its temperature is in the range of 66-160 degrees C., more preferably 70-145 degrees C., even more preferably 75-120 degrees C., and most preferably 80-100 degrees C. These ranges also seem to favour both selective oxidation of the free thiol of BLG and relatively fast kinetics of the reaction. As seen in Example 16, these combinations allow for a very fast step b), and an oxidation process that is completed in the order of minutes or less.

The inventors have found that it is sometimes advantageous from a production perspective that the oxidizing whey protein solution of step b) has a pH in the range of 6.8-7.5 as this reduces the need for pH adjustments after the oxidation.

In some preferred embodiments of the invention, the temperature of the oxidizing whey protein solution of step b) is held within the desired temperature range for a duration sufficient to reduce the initial amount of free thiol groups of the oxidizing whey protein solution of step a) to at most 80% of the initial amount, more preferably to at most 76%, even more preferably to at most 73%, and most preferably to at most 70% of the initial amount.

As mentioned above, partial oxidation of free thiol groups may be advantageous with the heat-treatment of step c) and in some preferred embodiments of the invention, the temperature of the oxidizing whey protein solution of step b) is held within the desired temperature range for a duration sufficient to reduce the initial amount of free thiol groups of the oxidizing whey protein solution of step a) to 20-80% of the initial amount, more preferably to 30-80%, even more preferably to 50-75%, and most preferably to 60-75% of the initial amount.

Preferably, the temperature of the oxidizing whey protein solution of step b) is held within the desired temperature range for a duration sufficient to reduce the initial amount of free thiol groups of the oxidizing whey protein solution of step a) to at most 30% of the initial amount, more preferably to at most 25%, even more preferably to at most 20%, and most preferably to at most 15% of the initial amount.

Preferably, during step b), the temperature is held within the desired temperature range for a duration sufficient to reduce the initial amount of free thiol groups of the oxidizing whey protein solution of step a) to at most 10% of the initial amount, more preferably to at most 5%, even more preferably to at most 3%, and most preferably to at most 1% of the initial amount.

Preferably, during step b), the temperature is held within the desired temperature range for a duration sufficient to reduce the initial amount of free thiol groups of the oxidizing whey protein solution of step a) to 0.01-30% of the initial amount, more preferably 0.02-25%, even more preferably 0.05-20%, and most preferably to 0.1-10% of the initial amount.

Preferably, the temperature of the oxidizing whey protein solution of step b) is held within the desired temperature range for a duration sufficient to reduce the amount of free thiol of the oxidizing whey protein solution to at most 15 micromol/g protein, more preferably at most 14 micromol/g protein, even more preferably at most 13 micromol/g protein, and most preferably at most 12 micromol/g protein.

Often, the temperature of the oxidizing whey protein solution of step b) is held within the desired temperature range for a duration sufficient to reduce the amount of free thiol of the oxidizing whey protein solution to 0.001-15 micromol/g protein, more preferably 0.01-14 micromol/g protein, even more preferably 0.01-13 micromol/g protein, and most preferably 0.01-12 micromol/g protein.

Preferably, the temperature of the oxidizing whey protein solution of step b) is held within the desired temperature range for a duration sufficient to reduce the amount of free thiol of the oxidizing whey protein solution to at most 10 micromol/g protein, more preferably at most 8 micromol/g protein, more preferably at most 5 micromol/g protein, even more preferably at most 3 micromol/g protein, and most preferably at most 2 micromol/g protein.

Preferably, step b) is held within the desired temperature range for a duration sufficient to reduce the amount of free thiol of the oxidizing whey protein solution to 0.001-10 micromol/g protein, more preferably 0.01-8 micromol/g protein, more preferably 0.01-5 micromol/g protein, even more preferably 0.01-3 micromol/g protein, and most preferably 0.01-2 micromol/g protein.

Even lower levels of free thiol groups may be desired, and in some preferred embodiments of the invention, the temperature of the oxidizing whey protein solution of step b) is held within the desired temperature range for a duration sufficient to reduce the amount of free thiol of the oxidizing whey protein solution to at most 1 micromol/g protein, more preferably at most 0.7 micromol/g protein, even more preferably at most 0.5 micromol/g protein, and most preferably at most 0.2 micromol/g protein.

When step b) uses condition I) the pressure of the oxidizing whey protein solution is typically less than 100 bar, and typically in the range 0.1-100 bar, and more preferably in the range of 1-80 bar.

Pressures of 100 bar or higher may be used by combining condition I and condition II of step b).

In other preferred embodiments of the invention, step b) involves condition II) wherein the oxidizing whey protein solution is subjected to a pressure in the range of 20-4000 bar, more preferably 200-3500 bar, even more preferably 300-3000 bar, and most preferably 500-2500 bar.

However, in further preferred embodiments of the invention condition II) involves that the oxidizing whey protein solution is subjected to a pressure in the range of 20-500 bar; more preferably 30-300 bar, and most preferably 40-200 bar.

The pressure range of the pressure of the oxidizing whey protein solution of step b) is preferably the same as the pressure range of the pressure of the oxidizing whey protein solution of step a).

In some preferred embodiments of the invention, the pressure of the oxidizing whey protein solution of step b) is held within the desired pressure range for a duration sufficient to reduce the initial amount of free thiol groups of the oxidizing whey protein solution of step a) to at most 80% of the initial amount, more preferably to at most 76%, even more preferably to at most 73%, and most preferably to at most 70% of the initial amount.

As mentioned above, partial oxidation of free thiol groups may be advantageous with the heat-treatment of step c), and in some preferred embodiments of the invention, the pressure of the oxidizing whey protein solution of step b) is held within the desired pressure range for a duration sufficient to reduce the initial amount of free thiol groups of the oxidizing whey protein solution of step a) to 20-80% of the initial amount, more preferably to 30-80%, even more preferably to 50-75%, and most preferably to 60-75% of the initial amount.

Preferably, the oxidizing whey protein solution of step b) is subjected to the pressure for a duration sufficient to reduce the initial amount of free thiol groups of the oxidizing whey protein solution of step a) to at most 30% of the initial amount, more preferably to at most 25%, even more preferably to at most 20%, and most preferably to at most 15% of the initial amount.

Preferably, during step b), the pressure is held within the desired pressure range for a duration sufficient to reduce the initial amount of free thiol groups of the oxidizing whey protein solution of step a) to at most 10% of the initial amount, more preferably to at most 5%, even more preferably to at most 3%, and most preferably to at most 1% of the initial amount.

Preferably, during step b), the pressure is held within the desired pressure range for a duration sufficient to reduce the initial amount of free thiol groups of the oxidizing whey protein solution of step a) to 0.01-30% of the initial amount, more preferably 0.02-25%, even more preferably 0.05-20%, and most preferably to 0.1-10% of the initial amount.

Preferably, and both relevant to embodiments with or without step c), the pressure of the oxidizing whey protein solution of step b) is held within the desired pressure range for a duration sufficient to reduce the amount of free thiol of the oxidizing whey protein solution to at most 15 micromol/g protein, more preferably at most 14 micromol/g protein, even more preferably at most 13 micromol/g protein, and most preferably at most 12 micromol/g protein.

In some preferred embodiments of the present invention, the pressure of the oxidizing whey protein solution of step b) is held within the desired pressure range for a duration sufficient to reduce the amount of free thiol of the oxidizing whey protein solution to 0.001-15 micromol/g protein, more preferably 0.001-14 micromol/g protein, even more preferably 0.001-13 micromol/g protein, and most preferably 0.001-12 micromol/g protein.

Preferably, and both relevant to embodiments with or without step c), the pressure of the oxidizing whey protein solution of step b) is held within the desired pressure range for a duration sufficient to reduce the amount of free thiol of the oxidizing whey protein solution to at most 10 micromol/g protein, more preferably at most 8 micromol/g protein, more preferably at most 5 micromol/g protein, even more preferably at most 3 micromol/g protein, and most preferably at most 2 micromol/g protein.

In some preferred embodiments of the present invention, the pressure of the oxidizing whey protein solution of step b) is held within the desired pressure range for a duration sufficient to reduce the amount of free thiol of the oxidizing whey protein solution to 0.001-10 micromol/g protein, more preferably 0.01-8 micromol/g protein, more preferably 0.01-5 micromol/g protein, even more preferably 0.01-3 micromol/g protein, and most preferably 0.01-2 micromol/g protein.

Even lower levels of free thiol groups may be desired, and in some preferred embodiments of the invention, the pressure of the oxidizing whey protein solution of step b) is held within the desired pressure range for a duration sufficient to reduce the amount of free thiol of the oxidizing whey protein solution to at most 1 micromol/g protein, more preferably at most 0.7 micromol/g protein, even more preferably at most 0.5 micromol/g protein, and most preferably at most 0.2 micromol/g protein.

When condition II is used in step b) the temperature is typically in the range of 0-65 degrees C., more preferably 5-65 degrees C., even more preferably 20-60 degrees C., and most preferably 40-60 degrees C. and condition. Therefore condition II is typically used together with condition I, whereas condition I may be used without condition II.

The inventors have found that lower temperatures often are sufficient when step b) also involves condition II. In some preferred embodiments of the invention, step b) involves the use of condition II, the oxidizing whey protein solution has a temperature in the range of 0-50 degrees C., more preferably 0-40 degrees C., even more preferably 0-30 degrees C., and most preferably 2-20 degrees C.

However, in some embodiments of the invention, step b) involves the use of condition II, the oxidizing whey protein solution has a temperature in the range of 66-160 degrees C., more preferably 70-145 degrees C., even more preferably 75-120 degrees C., and most preferably 80-100 degrees C.

The inventors have seen indications that slowly increasing the temperature during step b) allows for an efficient oxidation of free thiol groups of the whey protein.

In some preferred embodiments of the invention, step b) involves increasing the temperature of the oxidizing whey protein solution during step b) to the maximum oxidation temperature with a heating rate of at most 2 degrees C. per minute, more preferably at most 1 degrees C. per minute, even more preferably at most 0.3 degrees C. per minute, and most preferably at most 0.1 degrees C. per minute.

Operating step b) with increasing temperatures is particularly useful when the oxidizing whey protein of step b) has a pH in the range of 6.5-7.5.

The temperature may be increased continuously or in steps.

The pH is measured according to Analysis B.

The inventors have furthermore found that even rapidly increasing temperatures during step b) can be advantageous, particularly if the pH is in the range of 7.5-9.5, and more preferably 7.7-8.5.

In these preferred embodiments of the invention the temperature of the oxidizing whey protein solution is in the range of 0-65 degrees C. when step b) starts and during step b) the temperature of the oxidizing whey protein solution is increased to a temperature in the range of 66-160 degrees C., more preferably 70-145 degrees C., even more preferably 75-120 degrees C., and most preferably 80-100 degrees C. The benefit of this approach is illustrated in Example 16.

In some preferred embodiments of the invention, particularly useful for the first approach mentioned above, step b) does not involve adding or generating additional oxidizing agent capable of oxidizing the thiol group of cysteine during step b).

This means that all required oxidizing agent is added in step a).

In other preferred embodiments of the invention, particularly useful for the second approach mentioned above, step b) involves adding and/or generating additional oxidizing agent capable of oxidizing the thiol group of cysteine during step b).

In such preferred embodiments of the invention, the molar ratio between:
the maximum amount of oxidizing agent capable of oxidizing the thiol group of cysteine present in the oxidizing with protein solution during step b), and
the initial amount of free thiol groups of the oxidixing whey protein solution of step a) is preferably at most 5:1, more preferably at most 2:1, even more preferably at most 1:1, and most preferably at most 1:2.

Preferably, and particularly in relation to the second approach, the molar ratio between:
the maximum amount of oxidizing agent capable of oxidizing the thiol group of cysteine present in the oxidizing with protein solution during step b), and
the initial amount of free thiol groups of the oxidixing whey protein solution of step a) is at most 1:5, more preferably at most 1:10, even more preferably at most 1:20, and most preferably at most 1:50.

Preferably, and particularly in relation to the second approach, the molar ratio between:
the maximum amount of oxidizing agent capable of oxidizing the thiol group of cysteine present in the oxidizing with protein solution during step b), and
the initial amount of free thiol groups of oxidixing whey protein solution of step a) is at 1:1000-1:1, more preferably 1:100-1:2, even more preferably 1:70-1:5, and most preferably 1:60-1:15.

In some preferred embodiments of the invention, the duration of step b) is at most 48 hours, more preferably at most 36 hours, even more preferably at most 30 hours, and most preferably at most 25 hours.

Preferably, the duration of step b) is 0.1-48 hours, more preferably 3-36 hours, even more preferably 5-30 hours, and most preferably 10-25 hours.

Even faster oxidation steps are feasible, and in some preferred embodiments of the invention, the duration of step b) is at most 12 hours, more preferably at most 6 hours, even more preferably at most 3 hours, and most preferably at most 1 hour.

Preferably, the duration of step b) is 0.1-12 hours, more preferably 0.1-6 hours, even more preferably 0.1-3 hours, and most preferably 0.1-1 hour.

Fast reduction of the free thiol may e.g. be accomplished by implementing the method a continuous process and/or by selecting the parameters of steps a) and b) to be close to the optimum conditions.

The inventors have found that it is even feasible to perform step b) in the order of half an hour or less.

In some preferred embodiments of the invention, the duration of step b) is at most 40 minutes, more preferably at most 30 minutes, even more preferably at most 20 minutes, and most preferably at most 10 minutes.

Even faster oxidation steps are feasible, and in some preferred embodiments of the invention, the duration of step b) is at most 10 minutes, more preferably at most 8 minutes, even more preferably at most 4 minutes, and most preferably at most 2 minutes.

In some preferred embodiments of the invention, the oxidizing whey protein solution does not have a temperature higher than 65 degrees C. during step b), more preferably not higher than 60 degrees C.

However, as mentioned above and as shown in Example 16 the inventors have found that higher temperature also may be used, particularly if the conditions of the oxidation and the dosage of the oxidant is controlled.

In some preferred embodiments of the invention, step b) involves allowing the oxidation to proceed until substantially all oxidizing agent capable of oxidizing the thiol group of cysteine has been consumed.

In other preferred embodiments of the invention, step b) involves stopping the oxidation by contacting the oxidizing whey protein solution of step b) with a component, e.g. an enzyme, a catalysator, or a reactant, that eliminates the residual oxidizing agent capable of oxidizing the thiol group of cysteine.

Suitable enzymes include catalase which is capable of dismutating peroxide.

Suitable reactants include antioxidants.

In further embodiments of the invention, the oxidixing whey protein solution of step b) still contains some oxidizing agent capable of oxidizing the thiol group of cysteine at the end of step b). However, it is often preferred to keep the contents of oxidizing agent capable of oxidizing the thiol group of cysteine of the oxidized whey protein solution obtained from step b) very low.

Preferably, the molar ratio between:
the amount of oxidizing agent capable of oxidizing the thiol group of cysteine of the oxidized whey protein solution obtained from step b), and
the initial amount of free thiol groups of the oxidizing whey protein solution of step a) is at most 1:50, more preferably at most 1:100, and most preferably at most 1:200.

Even more preferably, the molar ratio between:
the amount of oxidizing agent capable of oxidizing the thiol group of cysteine of the oxidized whey protein solution obtained from step b), and
the initial amount of free thiol groups of the oxidizing whey protein solution of step a) is at most 1:500, more preferably at most 1:1000, and most preferably at most 1:2000.

Most preferably, the oxidized whey protein solution obtained from step b) does not contain detectable levels the oxidizing agent capable of oxidizing the thiol group of cysteine.

If the oxidizing agent capable of oxidizing the thiol group of cysteine mainly comprises peroxide, it is preferred that the content of peroxide is low in the oxidized whey protein solution obtained from step b).

Preferably, the molar ratio between:
the amount of peroxide of the oxidized whey protein solution obtained from step b), and
the initial amount of free thiol groups of the oxidizing whey protein solution of step a) is at most 1:50, more preferably at most 1:100, and most preferably at most 1:200.

Even more preferably, the molar ratio between:
the amount of peroxide of the oxidized whey protein solution obtained from step b), and
the initial amount of free thiol groups of the oxidizing whey protein solution of step a) is at most 1:500, more preferably at most 1:1000, and most preferably at most 1:2000.

Most preferably, the oxidized whey protein solution obtained from step b) does not contain detectable levels of peroxide.

If the oxidizing agent capable of oxidizing the thiol group of cysteine mainly comprises hydrogen peroxide, it is preferred that the content of hydrogen peroxide is low in the oxidized whey protein solution obtained from step b).

Preferably, the molar ratio between:
the amount of hydrogen peroxide of the oxidized whey protein solution obtained from step b), and
the initial amount of free thiol groups of the oxidizing whey protein solution of step a) is at most 1:50, more preferably at most 1:100, and most preferably at most 1:200.

Even more preferably, the molar ratio between:
the amount of hydrogen peroxide of the oxidized whey protein solution obtained from step b), and
the initial amount of free thiol groups of the oxidizing whey protein solution of step a) is at most 1:500, more preferably at most 1:1000, and most preferably at most 1:2000.

Most preferably, the oxidized whey protein solution obtained from step b) does not contain detectable levels of hydrogen peroxide.

Step b) is preferably implemented as a single incubation step under the one or more conditions that promote efficient oxidation but may also be implemented as a sequence of incubation steps under the one or more conditions, which incubation steps e.g. are interrupted e.g. when the added oxidizing agent has been consumed and starts again when additional oxidizing agent is added.

Step c) is optional in the sense that some embodiments of the invention do not comprise the heat-treatment of step c). However, step c) is also preferred and preferred methods of the invention often contain step c).

Thus, it is often preferred that the method also comprising step c), which involves subjecting the oxidized whey protein solution obtained from step b) to a heat-treatment step, preferably followed by cooling. The heat-treatment of step c) is e.g. preferred if enzyme has been added previously e.g. to generate oxidizing agent and/or to eliminate residual oxidizing agent.

The heat-treatment may then serve the purpose of inactivating the enzyme(s).

Alternatively or additionally, the heat-treatment may cause residual oxidizing agent to be consumed.

The heat-treatment of step c) is furthermore preferred when step b) has been performed to obtain only partial oxidation of the free thiol groups meaning that step b) only has reduced the content of free thiol groups of the oxidizing whey protein solution to 20-80% of the initial amount of free thiol groups of the oxidizing whey protein solution of step a).

The inventors have found that subsequent heat-treatment of the partially oxidized whey protein solution leads to further reduction of the content of free thiol groups. The partial oxidation approach therefore requires less added oxidizing agent relative to the initial content of free thiol groups and therefore reduces the risk for oxidative damage of the whey protein.

The heat-treatment of step c) preferably involves heating the oxidized whey protein solution obtained from step b) to a temperature of 60-160 degrees C., more preferably 65-95 degrees C., even more preferably 70-95 degrees C., and most preferably 80-90 degrees C. for 5 seconds-20 minutes.

If the oxidation of step b) is terminated by addition of enzyme, such as e.g. catalase, the heat-treatment is preferably performed for a duration sufficient to inactive the enzyme, preferably using a temperature in the range of 70-160 degrees C., and most preferably 80-150 degrees C.

The inventors have found that a heat-sterilisation can be useful as step c), and in some preferred embodiments of the invention, the step c) involves heating the oxidized whey protein solution of step b) to a temperature of at least 100 degrees C. for duration sufficient to obtain sterility. Preferably, this heat-treatment involves heating the oxidized whey protein solution of step b) to a temperature in the range 140-160 degrees for a duration of 0.1-10 seconds.

It is particularly preferred that step c) involves a heat-sterilisation when the oxidized whey protein solution subsequently is to be used as a beverage as such. In such embodiments the sterile oxidized whey protein solution is filled into suitable containers, preferably by aseptic filing, to provide packaged, sterile beverages consisting of the sterile, oxidized whey protein solution.

In other embodiments of the invention, the heat-treatment of step c) involves heating the oxidized whey protein solution obtained from step b) to a temperature of 60-100 degrees C. for 1 second-1 hours, and more preferably 65-95 degrees C. for 2 seconds-50 minutes, even more preferably 70-95 degrees C. for 2 seconds-40 minutes, and most preferably 80-90 degrees C. for 5 seconds-20 minutes.

Step d) is optional in the sense that some embodiments of the invention do not comprise the drying step. However, preferred embodiments often do.

Thus, in some preferred embodiments of the invention, the method furthermore comprises step d) of drying a liquid feed comprising at least the protein derived from the oxidized whey protein solution obtained from step b).

In the context of the present invention, the term “protein derived from of the oxidized whey protein solution obtained from step b)” means that the protein of the liquid feed is the protein of the oxidized whey protein solution obtained from step b) or alternatively the protein resulting from the heat-treatment of step c) if the method includes step c).

Preferably, the liquid feed for drying comprises or even consists of:
the oxidized whey protein solution obtained from step b) or a protein concentrate thereof, or
the heat-treated oxidized whey protein solution obtained from step c) or a protein concentrate thereof.

In the context of the present invention, a “protein concentrate” of a first liquid is a second liquid in which at least the protein originate from the first liquid but which has a higher protein content relative to total solids than the first liquid. Preferably, substantially all solids of the protein concentrate originate from the first liquid. A “protein concentrate” of a first liquid is preferably prepared by ultrafiltration, nanofiltration, reverse osmosis, and/or evaporation. Protein concentration ultrafiltration and/or nanofiltration may e.g. be implemented with diafiltration to wash out some of the small non-protein solids. A “protein concentrate” contains the same protein species and preferably has the same weight percentage of the whey protein species relative to total protein as the first liquid. The provision of a protein concentrate may also involve one or more pH adjustments.

The preparation of the liquid feed of step d) may furthermore involve a pH adjustment, preferably to give the liquid feed a pH in the range of 6.0-8.0, more preferably 6.5-7.7, even more preferably 6.7-7.5, and most preferably 6.8-7.3.

Therefore, the liquid feed preferably has a pH in the range of 6.0-8.0, more preferably 6.5-7.7, even more preferably 6.7-7.5, and most preferably 6.8-7.3.

The protein derived from of the oxidized whey protein solution obtained from step b) preferably contributes with at least 50% w/w of the total protein of the liquid feed, more preferably at least 70% w/w, even more preferably 90% w/w, and most preferably at least 99% w/w.

The liquid feed is preferably a protein concentrate of the oxidized whey protein solution of step b) or of the heat-treated oxidized whey protein solution obtained from step c). The liquid feed may be subjected to drying directly after it has been produced. Alternatively it held in a storage tank until drying.

It is particularly preferred that the protein derived from of the oxidized whey protein solution obtained from step b) is the only protein of the liquid feed.

Solids derived from the oxidized whey protein solution obtained from step b) preferably contributes with at least 50% w/w of the solids of the liquid feed, more preferably at least 70% w/w, even more preferably 90% w/w, and most preferably at least 99% w/w.

It is particularly preferred that the solids derived from of the oxidized whey protein solution obtained from step b) are the only protein of the liquid feed, possibly with the exception of mineral added during the pH adjustment.

The liquid feed for drying preferably has a protein content in the range of 8-22% w/w, more preferably 10-18% w/w.

The liquid feed for drying preferably has a solids content in the range of 8-50% w/w, more preferably 10-25% w/w.

The drying of step d) preferably converts the liquid feed to a powder.

The drying of step d) preferably involves spray-drying.

Furthermore, the method typically contains a step of packaging the dried product, typically a powder, obtained from step d).

The oxidized whey protein composition obtained by the method is the end-product of the method, and is preferably the oxidized whey protein solution obtained from step b), the heat-treated oxidized whey protein solution obtained from step c), or the oxidized whey protein powder obtained from step d).

The method of the invention can be implemented as a batch method, as a semi-batch method, and as a continuous method.

In some preferred embodiments of the invention the method is implemented as a continuous method. It is particularly preferred that at least steps a) and b), or steps a), b) and c) are performed as a continuous method.

Continuous implementations are often preferred for embodiments of the invention wherein the duration of step b) is relatively short, for example at most 2 hour, more preferably at most 1 hour, even more preferably at most 30 minutes, even more preferably at most 20 minutes, and most preferably at most 10 minutes.

In other preferred embodiments of the invention the method is implemented as a semi-batch method.

A particularly preferred embodiment of the method comprises:
a) processing a whey protein source, which is a WPI, to provide an oxidizing whey protein solution comprising:
   oxidizing agent capable of oxidizing the thiol group of cysteine which comprises peroxide, most preferably hydrogen peroxide, in an amount of at least 90% mol/mol relative to the total amount of oxidizing agent capable of oxidizing the thiol group of cysteine, and
having:
   a pH in the range of 7.5-9.5, most preferably 7.7-8.5,
   a total protein content of 2-9% w/w relative to the weight of the oxidizing whey protein solution, most preferably 3-8% w/w,
   a beta-lactoglobulin (BLG) content of at least 50% w/w relative to total protein,
   a protein content of at least 86% w/w relative to total solids, most preferably at least 90% w/w
   a total fat content of at most 1% w/w relative to total solids, most prefearbly at most 0.2% w/w,
and wherein the oxidizing whey protein solution furthermore:
   i) has a temperature in the range of 20-65 degrees C., and most preferably 30-65 degrees C.,
b) incubating the oxidizing whey protein solution under one or more conditions that allow for oxidation of the free thiol of at least some of the BLG molecules of the oxidizing whey protein solution, which one or more conditions involve:
   I) the oxidizing whey protein solution having temperature in the range of 20-65 degrees C., and most preferably 30-60 degrees C.,
wherein step b) furthermore involves:
   adjusting the pH of the oxidizing whey protein solution to be in the range of 7.5-9.5, most preferably 7.7-8.5,
   operating step b) to reduce the initial amount of free thiol groups of the oxidizing whey protein solution of step a) to 30-80% of the initial amount, and most preferably to 50-75% of the initial amount,
   no additional oxidizing agent is added during step b),
   terminating the oxidation of step b) by addition of catalase,
c) subjecting the oxidized whey protein solution obtained from step b) to a heat-treatment step which involves heating to a temperature of at least 75 degrees C. for a duration sufficient to inactivate the catalase, most preferably 80-95 degrees C. for a duration sufficient to inactivate the catalase,
d) drying a liquid feed comprising at least the protein derived from the oxidized whey protein solution of step b), and wherein:
   the protein derived from of the oxidized whey protein solution obtained from step b) preferably contributes with at least 90% w/w of the protein of the liquid feed, and most preferably at least 99% w/w,
   the liquid feed has a protein content in the range of 8-22% w/w, most preferably 10-18%/w
   the liquid feed having a pH in the range of 6.7-7.5, and most preferably 6.8-7.3,
and wherein the drying involves spray-drying.

The pressure of the oxidizing whey protein solutions in the above-mentioned particularly preferred embodiment is typically 0.5-99 bar, and most preferably 1-30 bar.

The oxidized whey protein composition of the invention is preferably obtainable by the above-mentioned particularly preferred embodiment.

Instead of drying, the oxidized whey protein solution obtained from step c), or a protein concentrate thereof, may be filled directly into a container, preferably an sterile container by aseptic filling and sealing. Alternatively, if the oxidized whey protein solution obtained from step c), or the protein concentrate thereof, is not already sterile, it may be subjected to heat-sterilisation as described herein.

Another particularly preferred embodiment of the method comprises:
a) processing a whey protein source, which is a WPI, to provide an oxidizing whey protein solution comprising:
   oxidizing agent capable of oxidizing the thiol group of cysteine which comprises peroxide, most preferably hydrogen peroxide, in an amount of at least 90% mol/mol relative to the total amount of oxidizing agent capable of oxidizing the thiol group of cysteine, and
having:
   a pH in the range of 7.5-9.5, most preferably 7.7-8.5,
   a total protein content of 2-9% w/w relative to the weight of the oxidizing whey protein solution, most preferably 3-8% w/w,
   a beta-lactoglobulin (BLG) content of at least 50% w/w relative to total protein,
   a protein content of at least 86% w/w relative to total solids, most preferably at least 90% w/w
   a total fat content of at most 1% w/w relative to total solids, most preferably at most 0.2% w/w,
and wherein the oxidizing whey protein solution furthermore:
   i) has a temperature in the range of 20-65 degrees C., and most preferably 30-65 degrees C.,
b) incubating the oxidizing whey protein solution under one or more conditions that allow for oxidation of the free thiol of at least some of the BLG molecules of the oxidizing whey protein solution, which one or more conditions involve:
   I) the oxidizing whey protein solution having temperature in the range of 20-65 degrees C., and most preferably 30-60 degrees C.,
and wherein the molar ratio between:
   the amount of oxidizing agent capable of oxidizing the thiol group of cysteine consumed during step b) but excluding any removal of excess oxidizing agent at the end of step b), and
   the initial amount of free thiol groups in step a) is 4:1-20:1, and most preferably 5:1-15:1
wherein step b) furthermore involves:
   adjusting the pH of the oxidizing whey protein solution to be in the range of 7.5-9.5, most preferably 7.7-8.5,
operating step b) to reduce the amount of free thiol groups of the oxidizing whey protein solution to at most 10 micromol/g protein, and most preferably at most 5 micromol/g protein,
that no additional oxidizing agent is added during step b),
terminating the oxidation of step b) by addition of catalase,
c) subjecting the oxidized whey protein solution obtained from step b) to a heat-treatment step which involves heating to a temperature of at least 75 degrees C. for a duration sufficient to inactivate the catalase, most preferably 80-95 degrees C. for a duration sufficient to inactivate the catalase,
d) drying a liquid feed comprising at least the protein derived from the oxidized whey protein solution of step b), and wherein:
   the protein derived from of the oxidized whey protein solution obtained from step b) preferably contributes with at least 90% w/w of the protein of the liquid feed, and most preferably at least 99% w/w,
   the liquid feed has a protein content in the range of 8-22% w/w, most preferably 10-18%/w
   the liquid feed having a pH in the range of 6.7-7.5, and most preferably 6.8-7.3,
and wherein the drying involves spray-drying.

The pressure of the oxidizing whey protein solutions in the above-mentioned particularly preferred embodiment is typically 0.5-99 bar, and most preferably 1-30 bar.

The oxidized whey protein composition of the invention is preferably obtainable by the above-mentioned particularly preferred embodiment.

Instead of drying, the oxidized whey protein solution obtained from step c), or a protein concentrate thereof, may be filled directly into a container, preferably an sterile container by aseptic filling and sealing. Alternatively, if the oxidized whey protein solution obtained from step c), or the protein concentrate thereof, is not already sterile, it may be subjected to heat-sterilisation as described herein.

A further particularly preferred embodiment of the method comprises:
a) processing a whey protein source, which is a WPI, to provide an oxidizing whey protein solution comprising:
   oxidizing agent capable of oxidizing the thiol group of cysteine which comprises peroxide, most preferably hydrogen peroxide, in an amount of at least 90% mol/mol relative to the total amount of oxidizing agent capable of oxidizing the thiol group of cysteine, and
having:
   a pH in the range of 7.5-9.5, most preferably 7.7-8.5,
   a total protein content of 2-9% w/w relative to the weight of the oxidizing whey protein solution, most preferably 3-8% w/w,
   a beta-lactoglobulin (BLG) content of at least 40% w/w relative to total protein, most preferably at least 50% w/w relative to total protein,
   a protein content of at least 86% w/w relative to total solids, most preferably at least 90% w/w
   a total fat content of at most 1% w/w relative to total solids, most preferably at most 0.2% w/w,
and wherein the oxidizing whey protein solution furthermore:
   i) has a temperature in the range of 0-65 degrees C., most preferably 30-65 degrees C.,
b) incubating the oxidizing whey protein solution under one or more conditions that allow for oxidation of the free thiol of at least some of the BLG molecules of the oxidizing whey protein solution, which one or more conditions involve:
   I) the oxidizing whey protein solution having temperature in the range of 20-65 degrees C., most preferably 30-65 degrees C.,
and wherein the molar ratio between:
   the amount of oxidizing agent capable of oxidizing the thiol group of cysteine consumed during step b) but excluding any removal of excess oxidizing agent at the end of step b), and
   the initial amount of free thiol groups in step a) is 1:1-10:1, and most preferably 1:1-5:1,
wherein step b) furthermore involves:
   operating step b) to reduce the amount of free thiol groups of the oxidizing whey protein solution to at most 10 micromol/g protein, and most preferably at most 5 micromol/g protein,
   terminating the oxidation of step b) by addition of catalase,
c) subjecting the oxidized whey protein solution obtained from step b) to a heat-treatment step which involves heating to a temperature of at least 75 degrees C. for a duration sufficient to inactivate the catalase, most preferably 80-95 degrees C. for a duration sufficient to inactivate the catalase,
d) preferably, drying a liquid feed comprising at least the protein derived from the oxidized whey protein solution of step b), and wherein the drying involves spray-drying.

The pressure of the oxidizing whey protein solutions in the above-mentioned particularly preferred embodiment is typically 0.5-99 bar, and most preferably 1-30 bar.

The oxidized whey protein composition of the invention is preferably obtainable by the above-mentioned particularly preferred embodiment.

Instead of drying, the oxidized whey protein solution obtained from step c), or a protein concentrate thereof, may be filled directly into a container, preferably an sterile container by aseptic filling and sealing. Alternatively, if the oxidized whey protein solution obtained from step c), or the protein concentrate thereof, is not already sterile, it may be subjected to heat-sterilisation as described herein.

A further particularly preferred embodiment of the method comprises:
a) processing a whey protein source, which is a WPI, to provide an oxidizing whey protein solution comprising:
   oxidizing agent capable of oxidizing the thiol group of cysteine which comprises peroxide, most preferably hydrogen peroxide, in an amount of at least 90% mol/mol relative to the total amount of oxidizing agent capable of oxidizing the thiol group of cysteine, and
having:
   a pH in the range of 7.5-9.5, most preferably 7.7-8.5,
   a total protein content of 2-9% w/w relative to the weight of the oxidizing whey protein solution, most preferably 3-8% w/w,
   a beta-lactoglobulin (BLG) content of at least 40% w/w relative to total protein, most preferably at least 50% w/w relative to total protein,
   a protein content of at least 86% w/w relative to total solids, most preferably at least 90% w/w
   a total fat content of at most 1% w/w relative to total solids, most prefearbly at most 0.2% w/w,
and wherein the oxidizing whey protein solution furthermore:
   i) has a temperature in the range of 0-65 degrees C., most preferably 30-65 degrees C.,
and wherein:
   the molar ratio between:
      the oxidizing agent capable of oxidizing the thiol group of cysteine, and
      the total amount of free thiol groups
of the oxidizing whey protein solution of step a) is 2:1-30:1, and most preferably 4:1-15:1,
b) incubating the oxidizing whey protein solution under one or more conditions that allow for oxidation of the free thiol of at least some of the BLG molecules of the oxidizing whey protein solution, which one or more conditions involve:
   I) the oxidizing whey protein solution having temperature in the range of 20-65 degrees C., most preferably 30-65 degrees C.,
wherein step b) furthermore involves:
   operating step b) to reduce the amount of free thiol groups of the oxidizing whey protein solution to at most 10 micromol/g protein, and most preferably at most 5 micromol/g protein, and
   terminating the oxidation of step b) by addition of catalase,
c) subjecting the oxidized whey protein solution obtained from step b) to a heat-treatment step which involves heating to a temperature of at least 75 degrees C. for a duration sufficient to inactivate the catalase, most preferably 80-95 degrees C. for a duration sufficient to inactivate the catalase,
d) preferably, drying a liquid feed comprising at least the protein derived from the oxidized whey protein solution of step b), and wherein the drying involves spray-drying.

The pressure of the oxidizing whey protein solutions in the above-mentioned particularly preferred embodiment is typically 0.5-99 bar, and most preferably 1-30 bar.

The oxidized whey protein composition of the invention is preferably obtainable by the above-mentioned particularly preferred embodiment.

Instead of drying, the oxidized whey protein solution obtained from step c), or a protein concentrate thereof, may be filled directly into a container, preferably an sterile container by aseptic filling and sealing. Alternatively, if the oxidized whey protein solution obtained from step c), or the protein concentrate thereof, is not already sterile, it may be subjected to heat-sterilisation as described herein.

Yet another particularly preferred embodiment of the method comprises:
a) processing a whey protein source, which is a WPI, to provide an oxidizing whey protein solution comprising:
   oxidizing agent capable of oxidizing the thiol group of cysteine which comprises peroxide, most preferably hydrogen peroxide, in an amount of at least 90% mol/mol relative to the total amount of oxidizing agent capable of oxidizing the thiol group of cysteine, and
having:
   a pH in the range of 7.5-9.5, most preferably 7.7-8.5,
   a total protein content of 2-9% w/w relative to the weight of the oxidizing whey protein solution, most preferably 3-8% w/w,
   a beta-lactoglobulin (BLG) content of at least 40% w/w relative to total protein, most preferably at least 50% w/w relative to total protein,
   a protein content of at least 86% w/w relative to total solids, most preferably at least 90% w/w
   a total fat content of at most 1% w/w relative to total solids, most prefearbly at most 0.2% w/w,
and wherein the oxidizing whey protein solution furthermore:
   i) has a temperature in the range of 0-65 degrees C., most preferably 30-65 degrees C.,
and wherein:
   the molar ratio between:
      the oxidizing agent capable of oxidizing the thiol group of cysteine, and
      the total amount of free thiol groups of the oxidizing whey protein solution of step a) is 2:1-30:1, and most preferably 4:1-15:1,
b) incubating the oxidizing whey protein solution under one or more conditions that allow for oxidation of the free thiol of at least some of the BLG molecules of the oxidizing whey protein solution, which one or more conditions involve:
   I) the oxidizing whey protein solution having temperature in the range of 20-65 degrees C., most preferably 30-65 degrees C.,
wherein step b) furthermore involves:
   operating step b) to reduce the amount of free thiol groups of the oxidizing whey protein solution to at most 10 micromol/g protein, and most preferably at most 5 micromol/g protein, and
d) preferably, drying a liquid feed comprising at least the protein derived from the oxidized whey protein solution of step b), and wherein the drying involves spray-drying.

The pressure of the oxidizing whey protein solutions in the above-mentioned particularly preferred embodiment is typically 0.5-99 bar, and most preferably 1-30 bar.

The oxidized whey protein composition of the invention is preferably obtainable by the above-mentioned particularly preferred embodiment.

Instead of drying, the oxidized whey protein solution obtained from step b), or a protein concentrate thereof, may be filled directly into a container, preferably an sterile container by aseptic filling and sealing. Alternatively, if the oxidized whey protein solution obtained from step b), or the protein concentrate thereof, is not already sterile, it may be subjected to heat-sterilisation as described herein.

Another particularly preferred embodiment of the method comprises:
a) processing a whey protein source, which is a WPI, to provide an oxidizing whey protein solution comprising:
   oxidizing agent capable of oxidizing the thiol group of cysteine which comprises peroxide, most preferably hydrogen peroxide, in an amount of at least 90% mol/mol relative to the total amount of oxidizing agent capable of oxidizing the thiol group of cysteine, and
having:
   a pH in the range of 7.5-9.5, most preferably 7.7-8.5,
   a total protein content of 2-9% w/w relative to the weight of the oxidizing whey protein solution, most preferably 3-8% w/w,
   a beta-lactoglobulin (BLG) content of at least 40% w/w relative to total protein, most preferably at least 50% w/w relative to total protein,
   a protein content of at least 86% w/w relative to total solids, most preferably at least 90% w/w
   a total fat content of at most 1% w/w relative to total solids, most preferably at most 0.2% w/w,
and wherein:
   the molar ratio between:
      the oxidizing agent capable of oxidizing the thiol group of cysteine, and
      the total amount of free thiol groups
of the oxidizing whey protein solution of step a) is 1:1.5-10:1, even more preferably 1:1-8:1, and most preferably 1:1-3:1,
the oxidizing whey protein solution furthermore:
   i) has a temperature in the range of 0-65 degrees C., most preferably 30-65 degrees C.
b) incubating the oxidizing whey protein solution under one or more conditions that allow for oxidation of the free thiol of at least some of the BLG molecules of the oxidizing whey protein solution, which one or more conditions involve:
   I) the oxidizing whey protein solution having temperature in the range of 20-65 degrees C., most preferably 30-65 degrees C.,
wherein step b) furthermore involves:
   operating step b) to reduce the initial amount of free thiol groups of the oxidizing whey protein solution of step a) to 30-80% of the initial amount, and most preferably to 50-75% of the initial amount,
   optionally, terminating the oxidation of step b) by addition of catalase,
c) subjecting the oxidized whey protein solution obtained from step b) to a heat-treatment step which involves heating to a temperature of at 70-95 degrees C. for 2 seconds-40 minutes,
d) preferably, drying a liquid feed comprising at least the protein derived from the oxidized whey protein solution of step b, and wherein the drying involves spray-drying.

The pressure of the oxidizing whey protein solutions in the above-mentioned particularly preferred embodiment is typically 0.5-99 bar, and most preferably 1-30 bar.

The oxidized whey protein composition of the invention is preferably obtainable by the above-mentioned particularly preferred embodiment.

Instead of drying, the oxidized whey protein solution obtained from step b), or a protein concentrate thereof, may be filled directly into a container, preferably an sterile container by aseptic filling and sealing. Alternatively, if the oxidized whey protein solution obtained from step b), or the protein concentrate thereof, is not already sterile, it may be subjected to heat-sterilisation as described herein.

Yet a particularly preferred embodiment of the method comprising:
a) processing a whey protein source, which is a WPI, to provide an oxidizing whey protein solution comprising:
   oxidizing agent capable of oxidizing the thiol group of cysteine which comprises peroxide, most preferably hydrogen peroxide, in an amount of at least 90% mol/mol relative to the total amount of oxidizing agent capable of oxidizing the thiol group of cysteine, and
having:
   a pH in the range of 7.5-9.5, most preferably 7.7-8.5,
   a total protein content of 2-9% w/w relative to the weight of the oxidizing whey protein solution, most preferably 3-8% w/w,
   a beta-lactoglobulin (BLG) content of at least 40% w/w relative to total protein, most preferably at least 50% w/w relative to total protein,
   a protein content of at least 86% w/w relative to total solids, most preferably at least 90% w/w
   a total fat content of at most 1% w/w relative to total solids, most preferably at most 0.2% w/w,
and wherein:
   the molar ratio between:
      the oxidizing agent capable of oxidizing the thiol group of cysteine, and
      the total amount of free thiol groups
of the oxidizing whey protein solution of step a) is 1:1.5-10:1, even more preferably 1:1.5-8:1, and most preferably 1:1.5-3:1,
   the oxidizing whey protein solution furthermore:
      i) has a temperature in the range of 0-65 degrees C., most preferably 30-65 degrees C.
b) incubating the oxidizing whey protein solution under one or more conditions that allow for oxidation of the free thiol of at least some of the BLG molecules of the oxidizing whey protein solution, which one or more conditions involve:
   I) the oxidizing whey protein solution having temperature in the range of 20-65 degrees C., most preferably 30-65 degrees C.,
wherein step b) furthermore involves:
   operating step b) to reduce the initial amount of free thiol groups of the oxidizing whey protein solution of step a) to 30-80% of the initial amount, and most preferably to 50-75% of the initial amount,
   optionally, terminating the oxidation of step b) by addition of catalase,
c) subjecting the oxidized whey protein solution obtained from step b) to a heat-treatment step which involves heating to a temperature of at 70-95 degrees C. for 2 seconds-40 minutes,
d) preferably, drying a liquid feed comprising at least the protein derived from the oxidized whey protein solution of step b, and wherein the drying involves spray-drying.

The pressure of the oxidizing whey protein solutions in the above-mentioned particularly preferred embodiment is typically 0.5-99 bar, and most preferably 1-30 bar.

The oxidized whey protein composition of the invention is preferably obtainable by the above-mentioned particularly preferred embodiment.

Instead of drying, the oxidized whey protein solution obtained from step c), or a protein concentrate thereof, may be filled directly into a container, preferably an sterile container by aseptic filling and sealing. Alternatively, if the oxidized whey protein solution obtained from step c), or the protein concentrate thereof, is not already sterile, it may be subjected to heat-sterilisation as described herein.

Yet another particularly preferred embodiment of the method comprises:
a) processing a whey protein source, which is a WPI, to provide an oxidizing whey protein solution comprising:
   oxidizing agent capable of oxidizing the thiol group of cysteine which comprises peroxide, most preferably hydrogen peroxide, in an amount of at least 90% mol/mol relative to the total amount of oxidizing agent capable of oxidizing the thiol group of cysteine, and
having:
   a pH in the range of 7.5-9.5, most preferably 7.7-8.5,
   a total protein content of 2-9% w/w relative to the weight of the oxidizing whey protein solution, most preferably 3-8% w/w,
   a beta-lactoglobulin (BLG) content of at least 40% w/w relative to total protein, most preferably at least 50% w/w relative to total protein,
   a protein content of at least 86% w/w relative to total solids, most preferably at least 90% w/w
   a total fat content of at most 1% w/w relative to total solids, most prefearbly at most 0.2% w/w,
and wherein:
   the molar ratio between:
      the oxidizing agent capable of oxidizing the thiol group of cysteine, and
      the total amount of free thiol groups
of the oxidizing whey protein solution of step a) is 1:1.5-10:1, even more preferably 1:1-8:1, and most preferably 1:1-3:1,
   the oxidizing whey protein solution furthermore:
      i) has a temperature in the range of 0-65 degrees C., most preferably 30-65 degrees C.
b) incubating the oxidizing whey protein solution under one or more conditions that allow for oxidation of the free thiol of at least some of the BLG molecules of the oxidizing whey protein solution, which one or more conditions involve:
   I) the oxidizing whey protein solution having temperature in the range of 20-65 degrees C., most preferably 30-65 degrees C.,
wherein step b) furthermore involves:
   operating step b) to reduce the initial amount of free thiol groups of the oxidizing whey protein solution of step a) to 30-80% of the initial amount, and most preferably to 50-75% of the initial amount,
   optionally, terminating the oxidation of step b) by addition of catalase,
c) subjecting the oxidized whey protein solution obtained from step b) to a heat-treatment step which involves heating to a temperature of at 70-95 degrees C. for a duration sufficient to reduce the amount of free thiol groups of the oxidizing whey protein solution to at most 10 micromol/g protein, and most preferably at most 5 micromol/g protein,
d) preferably, drying a liquid feed comprising at least the protein derived from the oxidized whey protein solution of step b, and wherein the drying involves spray-drying.

The pressure of the oxidizing whey protein solutions in the above-mentioned particularly preferred embodiment is typically 0.5-99 bar, and most preferably 1-30 bar.

The oxidized whey protein composition of the invention is preferably obtainable by the above-mentioned particularly preferred embodiment.

Instead of drying, the oxidized whey protein solution obtained from step c), or a protein concentrate thereof, may be filled directly into a container, preferably an sterile container by aseptic filling and sealing. Alternatively, if the oxidized whey protein solution obtained from step c), or the protein concentrate thereof, is not already sterile, it may be subjected to heat-sterilisation as described herein.

A further particularly preferred embodiment of the method comprises:
a) processing a whey protein source, which is a WPI, to provide an oxidizing whey protein solution comprising:
   oxidizing agent capable of oxidizing the thiol group of cysteine which comprises peroxide, most preferably hydrogen peroxide, in an amount of at least 90% mol/mol relative to the total amount of oxidizing agent capable of oxidizing the thiol group of cysteine, and
having:
   a pH in the range of 7.5-9.5, most preferably 7.7-8.5,
   a total protein content of 2-9% w/w relative to the weight of the oxidizing whey protein solution, most preferably 3-8% w/w,
   a beta-lactoglobulin (BLG) content of at least 40% w/w relative to total protein, most preferably at least 50% w/w relative to total protein,
   a protein content of at least 86% w/w relative to total solids, most preferably at least 90% w/w
   a total fat content of at most 1% w/w relative to total solids, most prefearbly at most 0.2% w/w,
and wherein:
   the molar ratio between:
      the oxidizing agent capable of oxidizing the thiol group of cysteine, and
      the total amount of free thiol groups
of the oxidizing whey protein solution of step a) is 1:1.5-10:1, even more preferably 1:1.5-8:1, and most preferably 1:1.5-3:1,
   the oxidizing whey protein solution furthermore:
      i) has a temperature in the range of 0-65 degrees C., most preferably 30-65 degrees C.
b) incubating the oxidizing whey protein solution under one or more conditions that allow for oxidation of the free thiol of at least some of the BLG molecules of the oxidizing whey protein solution, which one or more conditions involve:
   I) the oxidizing whey protein solution having temperature in the range of 20-65 degrees C., most preferably 30-65 degrees C.,
wherein step b) furthermore involves:
   operating step b) to reduce the initial amount of free thiol groups of the oxidizing whey protein solution of step a) to 30-80% of the initial amount, and most preferably to 50-75% of the initial amount,
   optionally, terminating the oxidation of step b) by addition of catalase,
c) subjecting the oxidized whey protein solution obtained from step b) to a heat-treatment step which involves heating to a temperature of at 70-95 degrees C. for a duration sufficient to reduce the amount of free thiol groups of the oxidizing whey protein solution to at most 10 micromol/g protein, and most preferably at most 5 micromol/g protein,
d) preferably, drying a liquid feed comprising at least the protein derived from the oxidized whey protein solution of step b, and wherein the drying involves spray-drying.

The pressure of the oxidizing whey protein solutions in the above-mentioned particularly preferred embodiment is typically 0.5-99 bar, and most preferably 1-30 bar.

The oxidized whey protein composition of the invention is preferably obtainable by the above-mentioned particularly preferred embodiment.

Instead of drying, the oxidized whey protein solution obtained from step c), or a protein concentrate thereof, may be filled directly into a container, preferably an sterile container by aseptic filling and sealing. Alternatively, if the oxidized whey protein solution obtained from step c), or the protein concentrate thereof, is not already sterile, it may be subjected to heat-sterilisation as described herein.

A further particularly preferred embodiment of the method comprises:
a) processing a whey protein source, which is a WPI, to provide an oxidizing whey protein solution comprising:
   oxidizing agent capable of oxidizing the thiol group of cysteine which comprises peroxide, most preferably hydrogen peroxide, in an amount of at least 90% mol/mol relative to the total amount of oxidizing agent capable of oxidizing the thiol group of cysteine, and
having:
   a pH in the range of 7.5-9.5, most preferably 7.7-8.5,
   a total protein content of 2-9% w/w relative to the weight of the oxidizing whey protein solution, most preferably 3-8% w/w,
   a beta-lactoglobulin (BLG) content of at least 40% w/w relative to total protein, most preferably at least 50% w/w relative to total protein,
   a protein content of at least 86% w/w relative to total solids, most preferably at least 90% w/w
   a total fat content of at most 1% w/w relative to total solids, most prefearbly at most 0.2% w/w,
and wherein:
   the molar ratio between:
      the oxidizing agent capable of oxidizing the thiol group of cysteine, and
      the total amount of free thiol groups
of the oxidizing whey protein solution of step a) is 1:1.5-10:1, even more preferably 1:1-8:1, and most preferably 1:1-3:1,
   the oxidizing whey protein solution furthermore:
      i) has a temperature in the range of 0-160 degrees C., most preferably 0-65 degrees C.
b) incubating the oxidizing whey protein solution under one or more conditions that allow for oxidation of the free thiol of at least some of the BLG molecules of the oxidizing whey protein solution, which one or more conditions involve:
   I) the oxidizing whey protein solution having temperature in the range of 70-160 degrees C., most preferably 75-100 degrees C.,
wherein step b) furthermore involves:
   operating step b) to reduce the amount of free thiol groups of the oxidizing whey protein solution to at most 10 micromol/g protein, and most preferably at most 5 micromol/g protein,
   preferably, wherein the duration of step b) is at most 1 hour, and most preferably at most 10 minutes,
d) preferably, drying a liquid feed comprising at least the protein derived from the oxidized whey protein solution of step b), and wherein the drying involves spray-drying.

The pressure of the oxidizing whey protein solutions in the above-mentioned particularly preferred embodiment is typically 0.5-99 bar, and most preferably 1-30 bar.

The oxidized whey protein composition of the invention is preferably obtainable by the above-mentioned particularly preferred embodiment.

Instead of drying, the oxidized whey protein solution obtained from step b), or a protein concentrate thereof, may be filled directly into a container, preferably an sterile container by aseptic filling and sealing. Alternatively, if the oxidized whey protein solution obtained from step b), or the protein concentrate thereof, is not already sterile, it may be subjected to heat-sterilisation as described herein.

Another particularly preferred embodiment of the method comprises:
a) processing a whey protein source, which is a WPI, to provide an oxidizing whey protein solution comprising:
   oxidizing agent capable of oxidizing the thiol group of cysteine which comprises peroxide, most preferably hydrogen peroxide, in an amount of at least 90% mol/mol relative to the total amount of oxidizing agent capable of oxidizing the thiol group of cysteine, and
having:
   a pH in the range of 7.5-9.5, most preferably 7.7-8.5,
   a total protein content of 2-9% w/w relative to the weight of the oxidizing whey protein solution, most preferably 3-8% w/w,
   a beta-lactoglobulin (BLG) content of at least 40% w/w relative to total protein, most preferably at least 50% w/w relative to total protein,
   a protein content of at least 86% w/w relative to total solids, most preferably at least 90% w/W
   a total fat content of at most 1% w/w relative to total solids, most prefearbly at most 0.2% w/w,
and wherein:
   the molar ratio between:
      the oxidizing agent capable of oxidizing the thiol group of cysteine, and
      the total amount of free thiol groups
of the oxidizing whey protein solution of step a) is 1:1.5-10:1, even more preferably 1:1.5-8:1, and most preferably 1:1.5-3:1,
   the oxidizing whey protein solution furthermore:
      i) has a temperature in the range of 0-160 degrees C., most preferably 0-65 degrees C.
b) incubating the oxidizing whey protein solution under one or more conditions that allow for oxidation of the free thiol of at least some of the BLG molecules of the oxidizing whey protein solution, which one or more conditions involve:
   I) the oxidizing whey protein solution having temperature in the range of 70-160 degrees C., most preferably 75-100 degrees C.,
wherein step b) furthermore involves:
   operating step b) to reduce the amount of free thiol groups of the oxidizing whey protein solution to at most 10 micromol/g protein, and most preferably at most 5 micromol/g protein,
   preferably, wherein the duration of step b) is at most 1 hour, and most preferably at most 10 minutes,
d) preferably, drying a liquid feed comprising at least the protein derived from the oxidized whey protein solution of step b), and wherein the drying involves spray-drying.

The pressure of the oxidizing whey protein solutions in the above-mentioned particularly preferred embodiment is typically 0.5-99 bar, and most preferably 1-30 bar.

The oxidized whey protein composition of the invention is preferably obtainable by the above-mentioned particularly preferred embodiment.

Instead of drying, the oxidized whey protein solution obtained from step b), or a protein concentrate thereof, may be filled directly into a container, preferably an sterile container by aseptic filling and sealing. Alternatively, if the oxidized whey protein solution obtained from step b), or the protein concentrate thereof, is not already sterile, it may be subjected to heat-sterilisation as described herein.

An even further particularly preferred embodiment of the method comprises:
a) processing a whey protein source, which is a WPI, to provide an oxidizing whey protein solution comprising:
   oxidizing agent capable of oxidizing the thiol group of cysteine which comprises peroxide, most preferably hydrogen peroxide, in an amount of at least 90% mol/mol relative to the total amount of oxidizing agent capable of oxidizing the thiol group of cysteine, and
having:
   a pH in the range of 7.5-9.5, most preferably 7.7-8.5,
   a total protein content of 2-9% w/w relative to the weight of the oxidizing whey protein solution, most preferably 3-8% w/w,
   a beta-lactoglobulin (BLG) content of at least 40% w/w relative to total protein, most preferably at least 50% w/w relative to total protein,
   a protein content of at least 86% w/w relative to total solids, most preferably at least 90% w/w
   a total fat content of at most 1% w/w relative to total solids, most preferably at most 0.2% w/w,
and wherein:
   the molar ratio between:
      the oxidizing agent capable of oxidizing the thiol group of cysteine, and
      the total amount of free thiol groups
of the oxidizing whey protein solution of step a) is 1:1.5-10:1, even more preferably 1:1-8:1, and most preferably 1:1-3:1,
   the oxidizing whey protein solution furthermore:
      i) has a temperature in the range of 0-160 degrees C., most preferably 0-65 degrees C.
b) incubating the oxidizing whey protein solution under one or more conditions that allow for oxidation of the free thiol of at least some of the BLG molecules of the oxidizing whey protein solution, which one or more conditions involve:
   I) the oxidizing whey protein solution having temperature in the range of 100-160 degrees C., most preferably 130-150 degrees C., preferably for a duration sufficient to provide a sterile oxidized whey protein solution,
wherein step b) furthermore involves:
   operating step b) to reduce the amount of free thiol groups of the oxidizing whey protein solution to at most 10 micromol/g protein, and most preferably at most 5 micromol/g protein,
   preferably, wherein the duration of step b) is at most 1 hour, and most preferably at most 10 minutes,
and wherein the oxidized whey protein solution obtained from step b), or a protein concentrate thereof, is filled into a container, preferably a sterile container by aseptic filling and sealing to provide a sterile, packaged liquid oxidized whey protein solution.

The pressure of the oxidizing whey protein solutions in the above-mentioned particularly preferred embodiment is typically 0.5-99 bar, and most preferably 1-30 bar.

The oxidized whey protein composition of the invention is preferably obtainable by the above-mentioned particularly preferred embodiment.

Yet a particularly preferred embodiment of the method comprises:
a) processing a whey protein source, which is a WPI, to provide an oxidizing whey protein solution comprising:
   oxidizing agent capable of oxidizing the thiol group of cysteine which comprises peroxide, most preferably hydrogen peroxide, in an amount of at least 90% mol/mol relative to the total amount of oxidizing agent capable of oxidizing the thiol group of cysteine, and
having:
   a pH in the range of 7.5-9.5, most preferably 7.7-8.5,
   a total protein content of 2-9% w/w relative to the weight of the oxidizing whey protein solution, most preferably 3-8% w/w,
   a beta-lactoglobulin (BLG) content of at least 40% w/w relative to total protein, most preferably at least 50% w/w relative to total protein,
   a protein content of at least 86% w/w relative to total solids, most preferably at least 90% w/W
   a total fat content of at most 1% w/w relative to total solids, most prefearbly at most 0.2% w/w,
and wherein:
   the molar ratio between:
      the oxidizing agent capable of oxidizing the thiol group of cysteine, and
      the total amount of free thiol groups
of the oxidizing whey protein solution of step a) is 1:1.5-10:1, even more preferably 1:1.5-8:1, and most preferably 1:1.5-3:1,
   the oxidizing whey protein solution furthermore:
      i) has a temperature in the range of 0-160 degrees C., most preferably 0-65 degrees C.
b) incubating the oxidizing whey protein solution under one or more conditions that allow for oxidation of the free thiol of at least some of the BLG molecules of the oxidizing whey protein solution, which one or more conditions involve:
   I) the oxidizing whey protein solution having temperature in the range of 100-160 degrees C., most preferably 130-150 degrees C., preferably for a duration sufficient to provide a sterile oxidized whey protein solution,
wherein step b) furthermore involves:
   operating step b) to reduce the amount of free thiol groups of the oxidizing whey protein solution to at most 10 micromol/g protein, and most preferably at most 5 micromol/g protein,
   preferably, wherein the duration of step b) is at most 1 hour, and most preferably at most 10 minutes,
and wherein the oxidized whey protein solution obtained from step b), or a protein concentrate thereof, is filled into a container, preferably a sterile container by aseptic filling and sealing to provide a sterile, packaged liquid oxidized whey protein solution.

The pressure of the oxidizing whey protein solutions in the above-mentioned particularly preferred embodiment is typically 0.5-99 bar, and most preferably 1-30 bar.

The oxidized whey protein composition of the invention is preferably obtainable by the above-mentioned particularly preferred embodiment.

Yet an aspect of the invention pertains to an oxidized whey protein composition having:
a protein content of at least 30% w/w relative to total solids,
preferably, a fat content of at most 3% w/w relative to total solids,
at most 15 micromol free thiol groups/g protein,
preferably, a tryptophan content of at least 0.7% w/w relative to total protein,
preferably, a methionine content of at least 0.3% w/w relative to total protein,
preferably, a kynurenine content of at most 0.2 micrograms/mg protein,
preferably, a content of protein-bound sulfur in the range of 100-600 micromol/g protein,
preferably, a content of protein-bound cysteine residues that form disulfide bonds in the range of 150-400 micromol/g protein
preferably, an weight average molecular weight of the protein in the range of 18 kDa and 10000 kDa, more preferably between 50-8000 kDa, and most preferably 80-5000 kDa, and
preferably, at least 60% w/w of the protein has a molecular weight between 18 kDa and 10000 kDa, more preferably at least 80% w/w, even more preferably at least 90% w/w, and most preferably at least 99% w/w.

The oxidized whey protein composition typically has a pH in the range of 5.5-9.5.

In some preferred embodiments of the invention, the oxidized whey protein composition has a pH in the range of 5.5-9.5, more preferably 6.0-8.5, even more preferably 6.2-8.0, and most preferably 6.5-7.5.

In some preferred embodiments of the invention, the oxidized whey protein composition has a total protein content of at least 30% w/w relative to the total solids of the oxidized whey protein composition, more preferably at least 50% w/w, even more preferably at least 75% w/w and most preferably at least 85% w/w relative to the total solids of the oxidized whey protein composition.

Preferably, the oxidized whey protein composition has a total protein content in the range of 30-99% w/w relative to the total solids of the oxidized whey protein composition, more preferably 50-97% w/w, even more preferably 75-96% w/w, and most preferably at least 85-95% w/w relative to the total solids of the oxidized whey protein composition.

Preferably, the oxidized whey protein composition has a total fat content of at most 3% w/w relative to total solids.

Even lower levels of fat are typically preferred and it is often preferred that the oxidized whey protein composition has a total fat content of at most 1% w/w relative to total solids, more preferably at most 0.5% w/w, even more preferably at most 0.2% w/w, and most preferably at most 0.1% w/w relative to total solids.

The oxidized whey protein composition may contain carbohydrate in various amounts.

However, it is often preferred that the oxidized whey protein composition has a carbohydrate content of at most 65% w/w relative to total solids.

Even lower levels of carbohydrate are typically preferred and it is often preferred that the oxidized whey protein composition has a carbohydrate content of at most 20% w/w relative to total solids, more preferably at most 8% w/w, even more preferably at most 2% w/w, and most preferably at most 0.2% w/w relative to total solids.

The oxidized whey protein composition preferably has an ash content of at most 8% w/w relative to total solids, more preferably at most 6% w/w, even more preferably at most 5% and most preferably at most 4.0%.

In some preferred embodiments of the present invention, the oxidized whey protein composition has an ash content of 0.4-8% w/w relative to total solids, more preferably 0.5-6% w/w, even more preferably 0.5-5% w/w and most preferably 0.6-4.0% w/w relative to total solids.

The oxidized whey protein composition preferably has a combined content of magnesium and calcium at most 1% w/w relative to total solids, more preferably at most 0.7% w/w, even more preferably at most 0.5% and most preferably at most 0.2%.

In some preferred embodiments of the present invention, the oxidized whey protein composition has combined content of magnesium and calcium of 0.01-1% w/w relative to total solids, more preferably at most 0.001-0.7% w/w, even more preferably 0.01-0.5% w/w and most preferably 0.01-0.2% w/w relative to total solids.

The inventors have seen indications that oxidized whey protein composition that contain even up to 15 micromol free thiol groups/g protein can provide a reduced level of unpleasant odours, relative to non-oxidized whey protein, in heat-treated whey protein beverages that contain 3% whey protein.

In some preferred embodiments of the invention, the oxidized whey protein composition comprises free thiol groups in an amount of at most 15 micromol/g protein, more preferably at most 14 micromol/g protein, even more preferably at most 13 micromol/g protein, and most preferably at most 12 micromol/g protein.

In some preferred embodiments of the invention, the oxidized whey protein composition comprises free thiol groups in an amount of 0.001-15 micromol/g protein, more preferably 0.01-14 micromol/g protein, even more preferably 0.01-13 micromol/g protein, and most preferably 0.01-12 micromol/g protein.

However, it is often preferred that the oxidized whey protein composition contains lower levels of free thiol groups, particularly when the oxidized whey protein composition is to be used for heat-treated, high protein beverages, e.g. containing 6% whey protein or higher. Thus, in some preferred embodiments of the invention the oxidized whey protein composition comprises free thiol groups in an amount of at most 10 micromol/g protein, more preferably at most 8 micromol/g protein, more preferably at most 5 micromol/g protein, even more preferably at most 3 micromol/g protein, and most preferably at most 2 micromol/g protein.

Preferably, the oxidized whey protein composition comprises free thiol groups in an amount of 0.01-10 micromol/g protein, more preferably 0.01-8 micromol/g protein, more preferably 0.01-5 micromol/g protein, even more preferably 0.01-3 micromol/g protein, and most preferably 0.01-2 micromol/g protein.

Even lower levels of free thiol groups may be desired, and in some preferred embodiments of the invention, the oxidized whey protein composition comprises free thiol groups in an amount of at most 1 micromol/g protein, more preferably at most 0.7 micromol/g protein, even more preferably at most 0.5 micromol/g protein, and most preferably at most 0.2 micromol/g protein.

In some preferred embodiments of the invention, the oxidized whey protein composition has a tryptophan content of at least 0.7% w/w relative to total protein, more preferably at least 0.8% w/w, even more preferably at least 0.9% w/w, and most preferably at least 1.0% w/w relative to total protein.

Preferably, the oxidized whey protein composition has a tryptophan content of 0.7-3% w/w relative to total protein, more preferably 0.8-2.6% w/w, even more preferably 0.9-2.4% w/w, and most preferably 1.0-2.2% w/w relative to total protein.

Alternatively, but also preferred, the oxidized whey protein composition often has a tryptophan content of 0.7-3% w/w relative to total protein, more preferably 0.8-3% w/w, even more preferably 0.9-3% w/w, and most preferably 1.0-3% w/w relative to total protein.

In some preferred embodiments of the invention, the oxidized whey protein composition has a methionine content of at least 0.3% w/w relative to total protein, more preferably at least 0.4% w/w, even more preferably at least 0.5% w/w, and most preferably at least 0.6% w/w relative to total protein.

Preferably, the oxidized whey protein composition has a methionine content of 0.3-3.3% w/w relative to total protein, more preferably 0.4-3.2% w/w, even more preferably 0.5-3.2% w/w, and most preferably 0.6-3.2% w/w relative to total protein.

Increased lower limits of methionine are often preferred, and in some preferred embodiments of the present invention the oxidized whey protein composition has a methionine content of 1.0-3.3% w/w relative to total protein, more preferably 1.3-3.2% w/w, even more preferably 1.6-3.2% w/w, and most preferably 1.8-3.2% w/w relative to total protein.

Preferably, the oxidized whey protein composition has a kynurenine content of at most 0.2 micrograms/mg protein, more preferably at most 0.05 micrograms/mg protein, even more preferably at most 0.01 micrograms/mg protein, and most preferably at most 0.001 micrograms/mg protein. It is particularly preferred that the oxidized whey protein composition does not contain detectable kynurenine.

The content of kynurenine is quantified according to Poojary et al.; “Selective and sensitive UHPLC-ESI-Orbitrap MS method to quantify protein oxidation markers”; Talanta, Volume 234, 1 Nov. 2021 (available online July 2021).

Kynurenine is a useful marker of tryptophan oxidation, it is believed by the inventors to be partially responsible for the development of yellow colour in heat-sterilized whey protein beverages based on protein that has been subjected to excessive oxidation, and it is furthermore not desired from a health perspective.

Preferably, the oxidized whey protein composition has a content of protein-bound sulfur in the range of 100-600 micromol/g protein, more preferably in the range of 200-500 micromol/g protein, and most preferably in the range of 250-500 micromol/g protein.

Preferably, the oxidized whey protein composition has a content of protein-bound cysteine residues that form disulfide bonds in the range of 150-400 micromol/g protein, more preferably 160-350, and most preferably 170-300 micromol/g protein.

The inventors have found that it is advantageous that the particle size of the protein of oxidized whey protein composition is no larger than 10000 kDa and preferably smaller to avoid the development of opaqueness in transparent beverage applications and furthermore to avoid increased viscosity during concentration and drying of the oxidized whey protein.

In some preferred embodiments of the invention, the oxidized whey protein composition has a weight average molecular weight of the protein in the range of 18 kDa and 10000 kDa, more preferably 30-9000 kDa, even more preferably 50-8000 kDa, and most preferably 80-5000 kDa.

Preferably, at least 60% w/w of the protein of the oxidized whey protein composition has a molecular weight between 18 kDa and 10000 kDa, more preferably at least 80% w/w, even more preferably at least 90% w/w, and most preferably at least 99% w/w.

More preferably, at least 60% w/w of the protein of the oxidized whey protein composition has a molecular weight between 50 kDa and 8000 kDa, more preferably at least 80% w/w, even more preferably at least 90% w/w, and most preferably at least 99% w/w.

Even more preferably, at least 60% w/w of the protein of the oxidized whey protein composition has a molecular weight between 80 kDa and 5000 kDa, more preferably at least 80% w/w, even more preferably at least 90% w/w, and most preferably at least 99% w/w.

In other preferred embodiments of the invention, the oxidized whey protein composition has a weight average molecular weight of the protein in the range of 18 kDa and 200 kDa, more preferably between 30-150 kDa, and most preferably between 30-100 kDa.

The inventors have found that the smaller the weight average molecular weight of the protein the higher total protein concentration is feasible during concentration, e.g. by ultrafiltration or nanofiltration, prior to spray-drying.

Preferably, at least 60% w/w of the protein of the oxidized whey protein composition has a molecular weight between 18 kDa and 200 kDa, more preferably at least 80% w/w, even more preferably at least 90% w/w, and most preferably at least 99% w/w.

More preferably, at least 60% w/w of the protein of the oxidized whey protein composition has a molecular weight between 18 kDa and 150 kDa, more preferably at least 80% w/w, even more preferably at least 90% w/w, and most preferably at least 99% w/w.

Even more preferably, at least 60% w/w of the protein of the oxidized whey protein composition has a molecular weight between 18 kDa and 100 kDa, more preferably at least 80% w/w, even more preferably at least 90% w/w, and most preferably at least 99% w/w.

The inventors has seen indications that it may be beneficial that a significant protein of the oxidized whey protein composition has a molecular weight of at least 30 kDa, which may be due to dimerisation of oxidized BLG.

Thus, preferably, at least 60% w/w of the protein of the oxidized whey protein composition has a molecular weight between 30 kDa and 200 kDa, more preferably at least 80% w/w, even more preferably at least 90% w/w, and most preferably at least 99% w/w.

More preferably, at least 60% w/w of the protein of the oxidized whey protein composition has a molecular weight between 30 kDa and 150 kDa, more preferably at least 80% w/w, even more preferably at least 90% w/w, and most preferably at least 99% w/w.

Even more preferably, at least 60% w/w of the protein of the oxidized whey protein composition has a molecular weight between 30 kDa and 100 kDa, more preferably at least 80% w/w, even more preferably at least 90% w/w, and most preferably at least 99% w/w.

The oxidized whey protein composition is preferably prepared by a method that involves oxidation of a whey protein source, preferably an aqueous solution of the whey protein source. Preferred embodiments of whey protein source have been described herein. Whey protein sources that are whey protein isolates are particularly preferred.

In some preferred embodiments of the invention, the oxidized whey protein composition of the invention is obtainable by the method described herein.

In some preferred embodiments of the invention, the oxidized whey protein composition is in the form of a liquid, and preferably an aqueous liquid. The oxidized whey protein composition in the form of a liquid preferably has a solids content of at most 0.1-50% w/w, more preferably 1-35% w/w, even more preferably 5-30% w/w, and most preferably 10-30% w/w.

In some preferred embodiments of the invention, the oxidized whey protein composition is in the form of a solid, and preferably a powder which preferably has been prepared by spray-drying. The oxidized whey protein composition in the form of a powder preferably has a solids content of at least 90% w/w, more preferably at least 93% w/w, even more preferably at least 94% w/w, and most preferably at least 95% w/w.

The part of the oxidized whey protein composition and the oxidizing whey protein solution that does not contribute to the solids content is preferably water.

The part of the oxidized whey protein composition that does not contribute to the solids content preferably comprises water in an amount of at least 80% w/w, more preferably at least 90% w/w, even more preferably 95% w/w, and more preferably at least 99% w/w.

In a particularly preferred embodiment of the invention the oxidized whey protein composition has:
a protein content of at least 86% w/w relative to total solids, and most preferably at least 90% relative to total solids,
a fat content of at most 1% w/w relative to total solids, and most preferably at most 0.2%,
at most 10 micromol free thiol groups/g protein, and most preferably at most 5 micromol free thiol groups/g protein,
a tryptophan content of 0.7-3% w/w relative to total protein, and most preferably 1.0-3% w/w relative to total protein,
a methionine content of 0.3-3.3% w/w relative to total protein, and most preferably 1.3-3.2% w/w relative to total protein,
a kynurenine content of at most 0.2 micrograms/mg protein, and most preferably at most 0.01 micrograms/mg protein.

In the above-mentioned particularly preferred embodiment of the invention, the oxidized whey protein composition preferably has:
a content of protein-bound sulfur in the range of 100-600 micromol/g protein, and
a content of protein-bound cysteine residues that form disulfide bonds in the range of 150-400 micromol/g protein.

Additionally, in the above-mentioned particularly preferred embodiment of the invention, the the oxidized whey protein composition preferably has:
a content of protein-bound sulfur in the range of 100-600 micromol/g protein, and
a content of protein-bound cysteine residues that form disulfide bonds in the range of 150-400 micromol/g protein.

It is furthermore often preferred that at least 60% w/w of the protein of the the oxidized whey protein composition of the above-mentioned particularly preferred embodiment has a molecular weight between 30 kDa and 9000 kDa, more preferably at least 80% w/w, even more preferably at least 90% w/w, and most preferably at least 99% w/w.

The pH of the above-mentioned particularly preferred embodiment of the oxidized whey protein composition is preferably in the range of 6.2-8.0, and most preferably 6.5-7.5.

In some pepi the oxidized whey protein composition is a sterile oxidized whey protein composition, and preferably a packaged, sterile oxidized whey protein composition. Preferably in the form of a sterile, liquid oxidized whey protein composition or a sterile, powdered, oxidized whey protein composition.

Yet an aspect of the invention pertains to a process of producing a food product comprising:
processing the oxidized whey protein composition described herein, and/or
combining the oxidized whey protein composition described and/or the processed oxidized whey protein composition with one or more further ingredients, and optionally processing the combination.

A preferred example of a food product is a heat-treated, and preferably heat-sterilized, beverage having a pH of 5.5-8.5.

Thus, a more specific aspect of the invention pertains to a process of producing a heat-treated, and preferably heat-sterilized, beverage having a pH of 5.5-8.5, more preferably 6.5-7.5, the process comprises:
1) combining oxidized whey protein composition as described herein with one or more further ingredients to obtain a liquid mixture having a pH of 5.5-8.5, more preferably 6.5-7.5, and comprising:
   the oxidized whey protein composition in an amount sufficient to contribute with at least 0.5% w/w protein, and
   water,
2) packaging the liquid mixture in a container, preferably a sterile container, and
wherein the liquid mixture is heat-treated, and preferably heat-sterilised, prior to and/or after packaging.

The oxidized whey protein composition as described herein is preferably the only protein source of the food product or of the heat-sterilized beverage, and therefore also of the liquid mixture.

The inventors have found that it is advantageous that the content of free thiol groups of the liquid mixture is kept low prior to the heat treatment to prevent the formation of unpleasant odours similar to the odour of rotten eggs.

Thus, in some preferred embodiments of the invention, the liquid mixture contains, prior to the heat-sterilisation, at most 60 micromol free thiol groups/100 g liquid mixture, more preferably at most 40 micromol free thiol groups/100 g liquid mixture, even more preferably at most 30 micromol free thiol groups/100 g liquid mixture, and most preferably at most 30 micromol free thiol groups/100 g liquid mixture.

Even lower contents of free thiol groups are often required, and in some preferred embodiments of the invention the liquid mixture contains, prior to the heat-sterilisation, at most 20 micromol free thiol groups/100 g liquid mixture, more preferably at most 15 micromol free thiol groups/100 g liquid mixture, even more preferably at most 10 micromol free thiol groups/100 g liquid mixture, and most preferably at most 5 micromol free thiol groups/100 g liquid mixture.

The liquid mixture preferably comprising a total amount of protein in the range of 0.5-15% w/w relative to the weight of the liquid mixture, more preferably 1-10% w/w relative to the weight of the liquid mixture, even more preferably 2-9% w/w relative to the weight of the liquid mixture, and most preferably 3-8% w/w relative to the weight of the liquid mixture.

Alternatively, but also preferred, the liquid mixture may comprise a total amount of protein in the range of 4-15% w/w relative to the weight of the liquid mixture, more preferably 5-14% w/w relative to the weight of the liquid mixture, even more preferably 6-13% w/w relative to the weight of the liquid mixture, and most preferably 8-12% w/w relative to the weight of the liquid mixture.

Oxidized whey protein composition of the invention preferably contributes with at least 30% w/w of the total protein of the liquid mixture, more preferably at least 50% w/w of the total protein, even more preferably at least 70% w/w of the total protein, and most preferably at least 80% w/w of the total protein.

Even higher contributions are often preferred, and in some preferred embodiments of the present invention, the oxidized whey protein composition of the invention contributes with at least 90% w/w of the total protein of the liquid mixture, more preferably at least 95% w/w of the total protein, even more preferably at least 99% w/w of the total protein, and most preferably 100% w/w of the total protein.

If the oxidized whey protein composition is used in combination with other protein sources. It is preferred to use sources that have a relatively low content of free thiol groups.

In some preferred embodiments of the present invention, the liquid mixture comprises total protein in an amount of at least 15% w/w relative to total solids, more preferably at least 20% w/w, and most preferably at least 25% w/w, and most preferably at least 30% w/w relative to total solids.

The total protein may contribute with an even larger portion of the total solids, e.g. when the beverage is intended as a sports protein beverage. Thus, in some preferred embodiments of the present invention, the liquid mixture comprises total protein in an amount of at least 80% w/w relative to total solids, more preferably at least 90% w/w, even more preferably at least 92% w/w, and most preferably at least 94% w/w relative to total solids.

The liquid mixture typically has a solids content of 0.5-50% w/w, more preferably 1-35% w/w, even more preferably 2-20% w/w, and most preferably 3-10% w/w.

The part of the liquid mixture that is not made up of solids preferably comprises water. The part of the liquid mixture that is not made up of solids preferably comprises water in an amount of at least 80% w/w, more preferably at least 90% w/w, even more preferably 95% w/w, and more preferably at least 99% w/W.

In some preferred embodiments of the present invention, the liquid mixture has a calorie content of at most 100 kcal/100 g, more preferably at most 80 kcal/100 g, even more preferred at most 70 kcal/100 g, and most preferably at most 60 kcal/100 g. Preferably, the liquid mixture may have a calorie content of 2-100 kcal/100 g, more preferably at 4-80 kcal/100 g, even more preferred 8-70 kcal/100 g, and most preferably 12-60 kcal/100 g. These embodiments are preferred for e.g. sports applications where the protein source is a primary energy source.

In other preferred embodiments of the present invention, the liquid mixture has a calorie content of more than 100 kcal/100 g, more preferably at least 120 kcal/100 g, even more preferred at least 140 kcal/100 g, and most preferably at least 150 kcal/100 g. Preferably, the liquid mixture may have a calorie content of 101-300 kcal/100 g, more preferably at 120-280 kcal/100 g, even more preferred 140-270 kcal/100 g, and most preferably 150-260 kcal/100 g. These embodiments are preferred for e.g. clinical nutrition where the protein source is accompanied by substantial amounts of carbohydrate and fat.

The compositional features and preferences described in the context of the heat-treated beverage equally apply to the liquid mixture.

The pH of the liquid mixture may span from slightly acidic to slightly alkaline.

Near-pH-neutral liquid mixtures are particularly preferred for the production of near-PH neutral beverages. In some preferred embodiments of the present invention, the liquid mixture has a pH in the range of 5.5-8.0, more preferably 6.0-7.5, even more preferred 6.2-7.3, and most preferred 6.3-7.2.

In other preferred embodiments of the present invention, the liquid mixture has a pH in the range of 6.0-7.5, more preferably 6.2-7.5, and most preferred 6.3-7.5.

In further preferred embodiments of the present invention, the liquid mixture has a pH in the range of 6.0-8.0, more preferably 6.6-7.7, even more preferred 6.7-7.6, and most preferred 6.8-7.5.

Generally, any suitable food acid or food base may be used to adjust the pH of the liquid mixture. Those skilled in the art will recognize suitable means for adjusting the pH. Suitable food bases include sodium or potassium carbonate, sodium or potassium hydrogen carbonate, or ammonium hydroxide. Alternatively, KOH or NaOH may be employed to adjust the pH. Suitable food acids include e.g. citric acid, hydrochloric acid, malic acid or tartaric acid or phosphoric acid.

In some preferred embodiments of the present invention, the liquid mixture has a viscosity of at most 200 cP at 20 degrees C. and at a shear rate of 300 s⁻¹, more preferably at most 100 cP at 20 degrees C. and at a shear rate of 300 s⁻¹, even more preferred at most 50 cP at 20 degrees C. and a shear rate of 300 s⁻¹, and most preferred at most 20 cP at 20 degrees C. and a shear rate of 300 s⁻¹.

The liquid mixture is typically prepared by mixing the appropriate ingredients with the oxidized whey protein composition. If powder ingredients are used, it is often preferred that these are allowed to hydrate prior to the heat-treatment and similarly if may be preferred that the liquid mixture is homogenized prior to the heat-treatment.

In some preferred embodiments, the oxidized whey protein composition is provided in the form of a powder, and is preferably mixed water or an aqueous liquid and allow to hydrate prior to the heat-treatment.

In other preferred embodiments, the oxidized whey protein composition is provided in the form of a liquid, e.g. the oxidized whey protein solution obtained from step b) or from step c). In some preferred embodiments, the oxidized whey protein composition is the oxidized whey protein solution obtained from step b) and contains catalase, which has been used to eliminate residual peroxide oxidizing agent. The oxidized whey protein solution obtained from step b) is not subjected to step c) but is:
mixed with one or more further ingredients required to produce the beverage,
optionally subjected to homogenisation,
subjected to heat-sterilisation by heating it to a temperature in the range of 140-150 degrees for 1-10 seconds,
cooling the heat-sterilised beverage, and
filling the sterile beverage aseptically into suitable sterile containers, which are subsequently sealed.

The inventors have found that the heat-sterilization in such a beverage process can replace step c) of the method mentioned herein and both inactivates the catalase and contributes to additional reduction in the content of free thiol groups.

The packaging of step 2) may be any suitable packaging technique, and any suitable container may be used for packaging the liquid mixture.

However, in a preferred embodiment of the invention, the packaging of step 2) is aseptic packaging, i.e. the liquid mixture is packaged under aseptic conditions. For example, the aseptic packaging may be performed by using an aseptic filling system, and it preferably involves filling the liquid mixture into one or more aseptic container(s).

Aseptic filling and sealing are particularly preferred if the liquid mixture already is sterile or very low in microorganisms prior to filling.

Examples of useful containers are bottles, cartons, bricks, and/or bags.

The heat-treatment of the process preferably subjects the liquid mixture to a temperature of at least 70 degrees C.

In some preferred embodiments of the inventive process, the liquid mixture of step 1) is subjected to a heat-treatment comprising at least pasteurisation and then packaged in step 2).

In another embodiment of the inventive process, the packaged liquid mixture of step 2) is subjected to a heat-treatment comprising at least pasteurisation.

In some preferred embodiments, the heat-treatment involves heating the liquid mixture to a temperature in the range of 70-80 degrees C.

In some preferred embodiments of the invention, the temperature of the heat-treatment is in the range of 70-80 degrees C., preferably in the range of 70-79 degrees C., more preferably in the range of 71-78 degrees C., even more preferably in the range of 72-77 degrees C., and most preferably in the range of 73-76 degrees C., such as approx. 75 degrees C.

Preferably, the duration of the heat-treatment, when performed in the temperature range 70-80, for 1 second to 60 minutes. The highest exposure times are best suited for the lowest temperatures of the temperature range and vice versa.

In other preferred embodiments, the temperature of the heat-treatment is at 70 degrees C. for at least 60 minutes, or preferably at 75 degrees C. for at least 45 minutes, or preferably at 80 degrees C. for at least 30 minutes, or preferably at 85 degrees C. for at least 22 minutes, or preferably at 90 degrees C. for at least 10 minutes.

In particularly preferred embodiments of the invention, the heat-treatment provides 70-78 degrees C. for 1 second to 30 minutes, more preferably 71-77 degrees C. for 1 minute to 25 minutes, and even more preferred 72-76 degrees C. for 2 minutes to 20 minutes.

In some preferred embodiments of the invention, the process of the heat-treatment involves heating to a temperature of 85° C.-95 degrees C. for 1 to 30 minutes.

For example, the temperature of the heat-treatment may be at least 81 degrees C., preferably at least 91 degrees C., preferably at least 95 degrees C., more preferred at least 100 degrees C., even more preferred at least 120 degrees C., and most preferred at least 140 degrees C.

In some particularly preferred embodiments of the invention, the heat-treatment involves heating the liquid mixture to a temperature in the range of 100-160 degrees C. for a duration sufficient to sterilize the liquid mixture. This preferably involves heating the liquid mixture to a temperature in the range of 120 to 155 degrees C. for a duration sufficient to obtain sterility, typically 0.1 seconds to 10 minutes, and more preferably 140 to 155 degrees C. for a duration sufficient to obtain sterility, typically for 0.1-30 seconds. A heat-treatment of a liquid that renders the liquid sterile is also referred to as a heat-sterilisation.

Another preferred heat-treatment is a sterilizing UHT-type treatment which typically involves a temperature in the range of 135-146 degrees C. and for a duration sufficient to obtain sterility, typically a duration in the range of 1-10 seconds.

Alternatively, but also preferred, the heat-treatment may involve a temperature in the range of 145-180 degrees C. and for a duration sufficient to obtain sterility, typically a duration in the range of 0.01-2 seconds, and more preferably a temperature in the range of 150-180 degrees C. and a duration in the range of 0.01-0.3 seconds.

The implementation of the heat-treatment may involve the use of equipment such as a plate or tubular heat exchanger, scraped surface heat exchanger or a retort system. Alternatively, and particularly preferred for heat-treatments above 95 degrees C., direct steam-based heating may be employed, e.g. using direct steam injection, direct steam infusion, or spray-cooking. Additionally, such direct steam-based heating is preferably used in combination with flash cooling. Suitable examples of implementation of spray-cooking are found in WO2009113858A1, which is incorporated herein for all purposes. Suitable examples of implementation of direct steam injection and direct steam infusion are found in WO2009113858A1 and WO 2010/085957 A3, which are incorporated herein for all purposes. General aspects of high-temperature treatment are e.g. found in “Thermal technologies in food processing” ISBN 185573558 X, which is incorporated herein by reference for all purposes.

In some preferred embodiments of the invention, the heat-treatment involves, or even consists of, retort heat-treatment, preferably at a temperature of at least 80 degrees C., and more preferably at a temperature of at least 95 degrees C., even more preferably at least 100 degrees C., and most preferably at least 120 degrees C., and preferably for a duration sufficient to render the treated liquid sterile.

In other preferred embodiments of the invention, the heat-treatment involves, or even consists of, steam infusion or spray cooking, preferably at a temperature of at least 100 degrees C., and more preferably at a temperature of at least 120 degrees C., even more preferably at least 130 degrees C., and most preferably at least 140 degrees C., and preferably for a duration sufficient to render the treated liquid sterile.

In some preferred embodiments of the invention, pasteurisation is combined with a physical microbial reduction.

Useful examples of physical microbial reduction involve one or more of germ filtration, UV radiation, high pressure treatment, pulsed electric field treatment, and ultrasound.

In some preferred embodiments of the invention, the heat-treatment is a sterilizing heat-treatment and hence results in a sterile liquid mixture and therefore a sterile beverage. Such sterilisation may e.g. be obtained by combining germ filtration and pasteurisation or by performing heat-treatment at at least 100 degrees C. and for a duration sufficient to obtain sterilisation.

It is beneficial that the liquid mixture is subjected to cooling after the heat-treatment. According to a preferred embodiment of the inventive process, following the heat-treatment, the heat-treated liquid mixture is cooled to preferably 0 to 70 degrees C., preferably 0 to 60 degrees C., even more preferably 0 to 30 degrees C., and most preferably 0-20 degrees C.

If the heat-treatment does not sterilize the liquid mixture, the heat-treated liquid mixture is preferably cooled to 0 to 15 degrees C. after the heat-treatment, more preferably to 1 to 10 degrees C., and most preferably 1-5 degrees C.

The cooling may take place prior to a filling step or after a filling step.

The cooling typically involve flash cooling and/or conventional heat-exchangers.

At least partial cooling by flash cooling is often preferred, particularly after heat-sterilizing heat-treatment. Flash cooling typically strips some of the volatile compounds of the cooled liquid. Whey protein beverages having a pH in the range of 5.5-8.5 are particularly prone to the development of unpleasant odours during heat-treatment and these unpleasant odours are partially stripped from the heat-treated liquid and released in the proximity of the flash cooling system. This is a disadvantage as it exposes the personnel operating the heat-treatment system to an annoying smell and may furthermore be associated with health issues.

The inventors have found that, advantageously, the flash-cooling of heat-treated beverages based on the present oxidized whey protein compositions releases much less and sometimes even none of such unpleasant odours.

The process of the invention can be implemented as a batch process, a semi-batch process, or a continuous process.

Another specific aspect of the invention pertains to a process of producing a heat-treated, and preferably heat-sterilized beverage, comprising performing step a), step b), and optionally step c) of the method described herein to obtained the oxidized whey protein composition and subsequently packaging the oxidized whey protein composition according to step 2) as described herein.

If the oxidized whey protein composition is to used directly as a beverage is preferred that step b) and/or c) involves a heat-sterilizing heat-treatment, i.e. a heat-treatment that renders the treated liquid sterile.

As mentioned above, such as heat-treatment typically requires that the liquid to be treated is heated to a temperature in the range of 100-160 degrees C. for a duration sufficient to sterilize the liquid. Suitable time/temperature combinations for such as heat-treatments are described herein.

Yet an aspect of the invention pertains to a food product comprising the oxidized whey protein composition of the invention, preferably in an amount to contribute with protein in an amount of at least 0.5% w/w relative to the weight of the food product. The food product preferably furthermore contains at least one non-whey component.

By the term “non-whey component” is meant a component that neither is present in the oxidized whey protein composition nor in a non-oxidized whey protein concentrate.

A more narrow aspect of the invention pertains to a heat-treated, and preferably heat-sterilized, beverage having a pH of 5.5-8.5, the beverage comprising the oxidized whey protein composition as described herein in an amount sufficient to contribute with at least 0.5% w/w protein.

A benefit of the present heat-treated beverage is that it has a better smell than comparable prior art beverages and the inventors have observed that the present beverage have a surprisingly low content of H₂S.

The heat-treated beverage preferably has a pH of 5.5-8.5, more preferably of 6.0-8.0, even more preferably 6.3-7.5, and most preferably 6.5-7.5.

Preferably the heat-treated, and preferably heat-sterilized, beverage having a pH of 5.5-8.5 has a content of H₂S of at most 5 micromol/L, more preferably 3 micromol/L, even more preferably 1.0 micromol/L, and most preferably at most 0.7 micromol/L.

It is particularly preferred that the heat-treated, and preferably heat-sterilized, beverage having a pH of 5.5-8.5 has a content of H₂S 1 hour after production of at most 5 micromol/L, more preferably 3 micromol/L, even more preferably 1.0 micromol/L, and most preferably at most 0.7 micromol/L.

It is furthermore preferred that the heat-treated, and preferably heat-sterilized, beverage having a pH of 5.5-8.5 has a content of H₂S 7 days after production of at most 5 micromol/L, more preferably 3 micromol/L, even more preferably 1.0 micromol/L, and most preferably at most 0.7 micromol/L.

The inventors have found the above-mentioned, heat-treated beverages to have a particularly favourable smell relative to comparable heat-treated, pH-neutral whey protein-containing beverages of the prior art.

It is particularly preferred that the heat-treated beverage is sterile.

The heat-treated beverage is preferably a packaged, heat-treated beverage and is preferably packaged in a closed container, such as e.g. a bottle. Such packaged, heat-treated beverages are highly preferred by the consumers and typically have both a long shelf-life at ambient temperature and can be transported and ingested where the consumer desires.

In some preferred embodiments of the present invention, the heat-treated beverage has a shelf-life at an ambient temperature of at least 6 months, more preferably at least 1 year, and even more preferably at least 2 years.

The heat-treated beverage preferably comprising a total amount of protein in the range of 0.5-15% w/w relative to the weight of the beverage, more preferably 1-10% w/w relative to the weight of the beverage, even more preferably 2-9% w/w relative to the weight of the beverage, and most preferably 3-8% w/w relative to the weight of the beverage.

Alternatively, but also preferred, the heat-treated beverage may comprise a total amount of protein in the range of 4-15% w/w relative to the weight of the heat-treated beverage, more preferably 5-14% w/w relative to the weight of the heat-treated beverage, even more preferably 6-13% w/w relative to the weight of the liquid mixture, and most preferably 8-12% w/w relative to the weight of the heat-treated beverage.

Oxidized whey protein composition of the invention preferably contributes with at least 30% w/w of the total protein of the heat-treated beverage, more preferably at least 50% w/w of the total protein, even more preferably at least 70% w/w of the total protein, and most preferably at least 80% w/w of the total protein.

Even higher contributions are often preferred, and in some preferred embodiments of the present invention, oxidized whey protein composition of the invention contributes with at least 90% w/w of the total protein of the heat-treated beverage, more preferably at least 95% w/w of the total protein, even more preferably at least 99% w/w of the total protein, and most preferably 100% w/w of the total protein.

If the oxidized whey protein composition is used in combination with other protein sources, it is preferred to use sources that have a relatively low content of free thiol groups.

In some preferred embodiments of the present invention, the heat-treated beverage preferably comprises total protein in an amount of at least 15% w/w relative to total solids, more preferably at least 20% w/w, and most preferably at least 25% w/w, and most preferably at least 30% w/w relative to total solids. The lower end of these ranges are particularly preferred for beverages for clinical nutrition which often contain significant amounts of fat and carbohydrate in addition to protein.

The total protein may contribute with an even larger portion of the total solids, e.g. when the beverage is intended as a sports protein beverage. Thus, in some preferred embodiments of the present invention, the heat-treated beverage comprises total protein in an amount of at least 80% w/w relative to total solids, more preferably at least 90% w/w, even more preferably at least 92% w/w, and most preferably at least 94% w/w relative to total solids.

The heat-treated beverage preferably has a solids content of 0.5-50% w/w, more preferably 1-35% w/w, even more preferably 2-20% w/w, and most preferably 3-10% w/w.

The part of the heat-treated beverage that is not made up of solids preferably comprises water. The part of the heat-treated beverage that is not made up of solids preferably comprises water in an amount of at least 80% w/w, more preferably at least 90% w/w, even more preferably 95% w/w, and more preferably at least 99% w/w.

Some preferred embodiments of the present invention, the heat-treated beverage has a calorie content of at most 100 kcal/100 g, more preferably at most 80 kcal/100 g, even more preferred at most 70 kcal/100 g, and most preferably at most 60 kcal/100 g. Preferably, the heat-treated beverage may have a calorie content of 2-100 kcal/100 g, more preferably at 4-80 kcal/100 g, even more preferred 8-70 kcal/100 g, and most preferably 12-60 kcal/100 g. These embodiments are preferred e.g. for sports applications where the protein source is a primary energy source.

In other preferred embodiments of the present invention, the heat-treated beverage has a calorie content of more than 100 kcal/100 g, more preferably at least 120 kcal/100 g, even more preferred at least 140 kcal/100 g, and most preferably at least 150 kcal/100 g. Preferably, the heat-treated beverage may have a calorie content of 101-300 kcal/100 g, more preferably at 120-280 kcal/100 g, even more preferred 140-270 kcal/100 g, and most preferably 150-260 kcal/100 g. These embodiments are preferred for e.g. clinical nutrition where the protein source is accompanied by substantial amounts of carbohydrate and fat.

The heat-treated beverage of the present invention may comprise other macronutrients than proteins, such as e.g. carbohydrate and/or lipid.

In some embodiments of the invention, the heat-treated beverage furthermore comprises carbohydrates. The total carbohydrate content in the heat-treated beverage of the invention depends on the intended use of the heat-treated beverage.

The carbohydrate of the packaged heat-treated beverage is preferably provided by one or more sources of carbohydrate.

Useful carbohydrate sources may be selected from the group consisting of: sucrose, maltose, dextrose, galactose, maltodextrin, corn syrup solids, sucromalt, glucose polymers, corn syrup, modified starches, resistant starches, rice-derived carbohydrates, isomaltulose, white sugar, glucose, fructose, lactose, high fructose corn syrup, honey, sugar alcohols, fructooligosaccharides, soy fiber, corn fiber, guar gum, konjac flour, polydextrose, fibersol, and combinations thereof. In some embodiments of the invention, the packaged heat-treated beverage comprises non-digestible sugars like fructans, the fructan comprises inulin or fructo-oligosaccharides.

In some preferred embodiments of the invention, the heat-treated beverage comprises carbohydrates between 0 to 95% of the total energy content of the beverage, more preferably in a range between 10 to 85% of the total energy content of the beverage, even more preferably in a range between 20 to 75% of the total energy content of the beverage, and most preferably in a range between 30 to 60% of the total energy content of the beverage.

The determination of the energy contribution of nutrients in a nutritional product is well-known to the skilled person, and involves calculating the energy contribution of the each groups of nutrients relative to the total energy content. For example, carbohydrate is known to contribute with 4.0 kcal/g carbohydrate, protein is known to contribute with 4.0 kcal/g protein, and fat is known to contribute with 9.0 kcal/g fat. The total energy content is determined by burning the composition in question in a bomb calorimeter.

Even lower carbohydrate content is often preferred, thus in some preferred embodiments of the invention preferably in a range between 0 to 30% of the total energy content of the beverage more preferably in a range between 0 to 20% of the total energy content of the beverage even more preferably in a range between 0 to 10% of the total energy content of the beverage.

In some preferred embodiments of the present invention, the beverage is particularly useful as a sports beverage and comprises e.g. a total amount of carbohydrate of at most 75% of the total energy content of the beverage (E %), more preferably at most 40 E %, even more preferably at most 10 E %, and most preferably at most 5 E %.

In some preferred embodiments of the present invention, the packaged heat-treated beverage is particularly useful as a nutritionally incomplete nutritional supplement and comprises e.g. a total amount of carbohydrate in a range between 70-95% of the total energy content of the beverage (E %), preferably 80-90 E %.

In some preferred embodiments of the present invention, the heat-treated beverage comprises a total amount of carbohydrate in a range between 30-60% of the total energy content of the beverage, and most preferably in a range between 35-50 E %. Such beverages are particularly useful for nutritionally complete beverages.

In some embodiments of the invention, the heat-treated beverage furthermore comprises at least one additional ingredient selected from the group consisting of vitamins, flavouring agents, minerals, sweeteners, antioxidants, food acid, lipids, carbohydrate, prebiotics, probiotics, and a combination thereof.

The additional ingredients can be used to adjust the nutrient contribution and the taste and flavour characteristics of the beverage.

In one embodiment of the invention, the beverage comprises at least one high-intensity sweetener (HIS). At least one HIS is preferably selected from the group consisting of aspartame, cyclamate, sucralose, acesulfame salt, neotame, saccharin, stevia extract, a steviol glycoside such as e.g. rebaudioside A, or a combination thereof.

In some embodiments of the invention, it is particularly preferred that the sweetener comprises or even consists of one or more high-intensity sweeteners.

HIS is both found among both natural and artificial sweeteners and typically have a sweetening intensity of at least 10 times that of sucrose.

If used, the total amount of HIS of the beverage is typically in the range of 0.001-2% w/w. Preferably, the total amount of HIS is in the range of 0.005-1% w/w. Most preferably, the total amount of HIS is in the range of 0.01-0.5% w/w.

The choice of the sweetener may depend on the beverage to be produced, e.g. high-intensity sweeteners (e.g. aspartame, acesulfame-K or sucralose) may be used in beverages where no energy contribution from the sweetener is desired, whereas for beverages having a natural profile natural sweeteners (e.g. steviol glycosides, sorbitol or sucrose) may be used.

It may furthermore be preferred that the sweetener comprises or even consists of one or more polyol sweetener(s). Non-limiting examples of useful polyol sweeteners are maltitol, mannitol, lactitol, sorbitol, inositol, xylitol, threitol, galactitol or combinations thereof. If used, the total amount of polyol sweetener of the beverage is typically in the range of 1-20% w/w. More preferably the total amount of polyol sweetener of the beverage is in the range of 2-15% w/w. Even more preferably, the total amount of polyol sweetener may be in the range of 4-10% w/w.

In some preferred embodiments of the invention, the heat-treated beverage comprises:
a total amount of carbohydrate of at most 1% w/w, more preferably at most 0.5% w/w, and most preferably at most 0.1% w/w, and
a total amount of HIS in the range of 0.001-2% w/w, more preferably in the range of 0.005-1% w/w, and most preferably in the range of 0.01-0.5% w/w.

In some embodiments of the invention, the heat-treated beverage furthermore comprises lipids. The total lipid content in the heat-treated beverage of the invention depends on the intended use of the heat-treated beverage.

In some preferred embodiments of the invention, the heat-treated beverage has a lipid content between 0 to 50% of the total energy content of the beverage, or preferably in a range between 0 to 40% of the total energy content of the beverage, or preferably in a range between 0 to 30% of the total energy content of the beverage or preferably in a range between 0 to 20% of the total energy content of the beverage or preferably in a range between 0 to 10% of the total energy content of the beverage or preferably in a range between 0 to 5% of the total energy content of the beverage.

In some preferred embodiments of the present invention, the beverage comprises a total amount of lipid of at most 10 E %, more preferably at most 5 E %, and most preferably at most 1 E %.

In some preferred embodiments of the present invention, the heat-treated beverage is particularly useful as a nutritionally incomplete nutritional supplement and comprises e.g. a total amount of lipid of at most 10% of the total energy content of the beverage, preferably at most 1 E %.

In some preferred embodiments of the present invention, the beverage comprises a total amount of carbohydrate of at most 10 E %, more preferably at most 5 E %, and most preferably at most 1 E %.

In some preferred embodiments of the present invention, the heat-treated beverage has a viscosity of at most 200 cP at 20 degrees C. and at a shear rate of 300 s⁻¹, more preferably at most 100 cP at 20 degrees C. and at a shear rate of 300 s⁻¹, even more preferred at most 50 cP at 20 degrees C. and at a shear rate of 300 s⁻¹, and most preferred at most 20 cP at 20 degrees C. and at a shear rate of 300 s⁻¹.

The inventors have found that the oxidized whey protein composition of the invention is useful for tranparent beverages, and in some preferred embodiments of the present invention, the heat-treated beverage has a turbidity of at most 400 NTU, more preferably at most 100 NTU, even more preferably at most 50 NTU, and most preferably at most 20 NTU.

In some preferred embodiments of the present invention, the beverage, e.g. in the form of a sports beverage, comprises:
a total amount of protein in the range of 0.5-15% w/w relative to the weight of the beverage, more preferably 1-10% w/w relative to the weight of the beverage, even more preferably 2-9% w/w relative to the weight of the beverage, and most preferably 3-8% w/w relative to the weight of the beverage,
a total amount of carbohydrate of at most 75% of the total energy content of the beverage (E %), more preferably at most 40 E %, even more preferably at most 10 E %, and most preferably at most 5 E %, and
a total amount of lipid of at most 10 E %, more preferably at most 6 E %, even more preferably at most 3 E %, and most preferably at most 1 E %.

In other preferred embodiments of the present invention, the beverage, e.g. in the form of a low carbohydrate sports beverage, comprises:
a total amount of protein in the range of 0.5-15% w/w relative to the weight of the beverage, more preferably 1-10% w/w relative to the weight of the beverage, even more preferably 2-9% w/w relative to the weight of the beverage, and most preferably 3-8% w/w relative to the weight of the beverage,
a total amount of carbohydrate of at most 10 E %, more preferably at most 6 E %, even more preferably at most 3 E %, and most preferably at most 1 E %,
a total amount of lipid of at most 5 E %, more preferably at most 4 E %, even more preferably at most 3 E %, and most preferably at most 1 E %, and
a total amount of HIS in the range of 0.001-2% w/w, more preferably in the range of 0.005-1% w/w, and most preferably in the range of 0.01-0.5% w/w.

In other preferred embodiments of the present invention, the packaged heat-treated beverage, e.g. in the form of a nutritionally complete beverage, comprises:
a total amount of protein in the range of 0.5-15% w/w relative to the weight of the beverage, more preferably 1-10% w/w relative to the weight of the beverage, even more preferably 2-9% w/w relative to the weight of the beverage, and most preferably 3-8% w/w relative to the weight of the beverage,
a total amount of carbohydrate in a range between 30-60% of the total energy content of the beverage, and most preferably in a range between 35-50 E % and
a total amount of lipid in the range of 20-50% of the total energy content, more preferably in a range between 25-45 E %, and most preferably 30-40 E %.

In some preferred embodiments of the present invention, the heat-treated beverage has a pH in the range of 6.2-7.5, most preferably 6.8-7.5, and comprises:
a total amount of protein in the range of 0.5-15% w/w relative to the weight of the beverage, more preferably 1-10% w/w relative to the weight of the beverage, even more preferably 2-9% w/w relative to the weight of the beverage, and most preferably 3-8% w/w relative to the weight of the beverage,
   and wherein protein from the oxidized whey protein composition provides at least 50% w/w of the total protein of the heat-treated beverage, more preferably at least 70% w/w, even more preferably at least 90% w/w, and most preferably 100% w/w of the total protein of the heat-treated beverage.

In other preferred embodiments of the present invention, the heat-treated beverage has a pH in the range of 6.2-7.5, most preferably 6.8-7.5, and comprises:
a total amount of protein in the range of 4-15% w/w relative to the weight of the beverage, more preferably 5-14% w/w relative to the weight of the beverage, even more preferably 6-13% w/w relative to the weight of the beverage, and most preferably 8-12% w/w relative to the weight of the beverage,
   and wherein protein from the oxidized whey protein composition provides at least 50% w/w of the total protein of the heat-treated beverage, more preferably at least 70% w/w, even more preferably at least 90% w/w, and most preferably 100% w/w of the total protein of the heat-treated beverage.

The contents of the carbohydrates and fat of the heat-treated beverage may vary and depend on the application.

In some preferred embodiments of the present invention, the heat-treated beverage, e.g. in the form of a sports beverage, comprises:
a total amount of carbohydrate of at most 75% of the total energy content (E %) of the beverage, more preferably at most 40 E %, even more preferably at most 10 E %, even more preferably at most 5 E %, and most preferably at most 1 E %, and
a total amount of lipid of at most 10 E %, more preferably at most 6 E %, even more preferably at most 3 E %, and most preferably at most 1 E %.

In other preferred embodiments of the present invention, the packaged heat-treated beverage, e.g. in the form of a nutritionally complete beverage, comprises:
a total amount of carbohydrate in a range between 30-60% of the total energy content of the beverage, and most preferably in a range between 35-50 E % and
a total amount of lipid in the range of 20-50% of the total energy content, more preferably in a range between 25-45 E %, and most preferably 30-40 E %.

The food product, and particularly the heat-treated beverage, is preferably obtainable by the process of the invention.

Yet an aspect of the invention pertains to a food ingredient comprising:
the solids of the oxidized whey protein composition described herein, and
one or more further ingredient(s), preferably selected from:
   a dairy ingredient, preferably a non-oxized dairy ingredient,
   a plant-based ingredient,
   a non-dairy carbohydrate source,
   a flavouring agent, and/or
   a sweetener (sweet carb/polyol/HIS).

Further details in relation to the food ingredient are described in the numbered embodiments found below.

Yet an aspect of the invention pertains to the use of an oxidized whey protein composition, preferably the oxidized whey protein composition of the invention, as a food ingredient, preferably for improving the odour and/or reducing the level of unpleasant odour similar to the odour of rotten eggs of heat-sterilized, beverages having a pH in the range of 5.5-8.5, preferably having a whey protein content of at least 3% w/w, and preferably heat-sterilized using indirect heat-treatment.

Some particularly preferred embodiments of the invention are described in the following numbered embodiments.

Numbered embodiment 1. A method of producing an oxidized whey protein composition, the method comprising
a) processing a whey protein source to provide an oxidizing whey protein solution comprising:
   oxidizing agent capable of oxidizing the thiol group of cysteine, and
having:
   a pH in the range of 6.5-9.5,
   a total protein content of at least 1% w/w relative to the weight of the oxidizing whey protein solution,
   a beta-lactoglobulin (BLG) content of at least 10% w/w relative to total protein
   preferably, a protein content of at least 30% w/w relative to total solids,
   preferably, a total fat content of at most 3% w/w relative to total solids,
and wherein the oxidizing whey protein solution furthermore:
   i) has a temperature in the range of 0-160 degrees C., and/or
   ii) is pressurized to a pressure in the range of 20-4000 bar
b) incubating the oxidizing whey protein solution under one or more conditions that allow for oxidation of the free thiol of at least some of the BLG molecules of the oxidizing whey protein solution, preferably to reduce the amount of free thiol groups of the oxidizing whey protein solution to at most 15 micromol/g protein, which one or more conditions involve:
   I) the oxidizing whey protein solution having temperature in the range of 0-160 degrees C., and/or
   II) the oxidizing whey protein solution is pressurized to a pressure in the range of 20-4000 bar,
c) optionally, yet preferably, subjecting the oxidized whey protein solution obtained from step b) or a protein concentrate thereof to a heat-treatment step which involves heating to a temperature of at least 60 degrees C.,
d) optionally, yet preferably, drying a liquid feed comprising at least the protein derived from the oxidized whey protein solution obtained from step b).

Numbered embodiment 1a. A method of producing an oxidized whey protein composition, the method comprising
a) processing a whey protein source to provide an oxidizing whey protein solution comprising:
   oxidizing agent capable of oxidizing the thiol group of cysteine, and
having:
   a pH in the range of 6.5-9.5,
   a total protein content of at least 1% w/w relative to the weight of the oxidizing whey protein solution,
   a beta-lactoglobulin (BLG) content of at least 10% w/w relative to total protein
   preferably, a protein content of at least 30% w/w relative to total solids,
   preferably, a total fat content of at most 3% w/w relative to total solids, and wherein the oxidizing whey protein solution furthermore:
      i) has a temperature in the range of 0-65 degrees C., and/or
      ii) is pressurized to a pressure in the range of 100-4000 bar,
b) incubating the oxidizing whey protein solution under one or more conditions that allow for oxidation of the free thiol of at least some of the BLG molecules of the oxidizing whey protein solution, preferably to reduce the amount of free thiol groups of the oxidizing whey protein solution to at most 15 micromol/g protein, which one or more conditions involve:
   I) the oxidizing whey protein solution having temperature in the range of 0-65 degrees C., and/or
   II) the oxidizing whey protein solution is pressurized to a pressure in the range of 100-4000 bar,
c) optionally, yet preferably, subjecting the oxidized whey protein solution obtained from step b) or a protein concentrate thereof to a heat-treatment step which involves heating to a temperature of at least 60 degrees C.,
d) optionally, yet preferably, drying a liquid feed comprising at least the protein derived from the oxidized whey protein solution obtained from step b).

Numbered embodiment 2. The method according to numbered embodiment 1 wherein the oxidizing agent capable of oxidizing the thiol group of cysteine comprises or even consists of a peroxide, ozone, dioxygen, or a combination thereof.

Numbered embodiment 3. The method according to any of the preceding numbered embodiments wherein the oxidizing agent capable of oxidizing the thiol group of cysteine is a peroxide selected from the group consisting of hydrogen peroxide, benzoyl peroxide, and a mixture thereof.

Numbered embodiment 4. The method according to any of the preceding numbered embodiments wherein the oxidizing agent is generated electrochemically.

Numbered embodiment 5. The method according to any of the preceding numbered embodiments wherein the oxidizing agent is generated enzymatically.

Numbered embodiment 6. The method according to any of the preceding numbered embodiments wherein the molar ratio between:
the oxidizing agent capable of oxidizing the thiol group of cysteine, and
the total amount of free thiol groups
   of the oxidizing whey protein solution of step a) is at least 1:2, more preferably at least 1:1, even more preferably at least 2:1, and most preferably at least 3:1.

Numbered embodiment 7. The method according to any of the preceding numbered embodiments wherein the molar ratio between:
the oxidizing agent capable of oxidizing the thiol group of cysteine, and
the total amount of free thiol groups
   of the oxidizing whey protein solution of step a) is 1:2-200:1, more preferably 1:2-100:1, even more preferably 1:1-30:1, and most preferably 1:1-15:1.

Numbered embodiment 8. The method according to any of the preceding numbered embodiments wherein the oxidizing whey protein solution of step a) has a pH in the range of 7.0-9.5, more preferably 7.1-8.5, even more preferably 7.2-8.5, and most preferably 7.4-8.2.

Numbered embodiment 9. The method according to any of the preceding numbered embodiments wherein the oxidizing whey protein solution of step a) has a pH in the range of 6.5-8.5, more preferably 6.6-8.0, even more preferably 6.7-7.5, and most preferably 6.8-7.3.

Numbered embodiment 10. The method according to any of the preceding numbered embodiments wherein the oxidizing whey protein solution of step a) has a total protein content of at least 2% w/w relative to the weight of the oxidizing whey protein solution, more preferably at least 3% w/w, even more preferably at least 5% w/w and most preferably at least 6% w/w.

Numbered embodiment 11. The method according to any of the preceding numbered embodiments wherein the oxidizing whey protein solution of step a) has a total protein content in the range of 1-30% w/w relative to the weight of the oxidizing whey protein solution, more preferably 3-20% w/w, even more preferably 4-15% w/w, and most preferably at least 6-10% w/w.

Numbered embodiment 12. The method according to any of the preceding numbered embodiments wherein the oxidizing whey protein solution of step a) has a total protein content in the range of 1-12% w/w relative to the weight of the oxidizing whey protein solution, more preferably 3-11% w/w, even more preferably 4-10% w/w, and most preferably 5-9% w/w.

Numbered embodiment 13a. The method according to any of the preceding numbered embodiments wherein the oxidizing whey protein solution of step a) has a total protein content of at least 30% w/w relative to the total solids of the oxidizing whey protein solution, more preferably at least 50% w/w, even more preferably at least 75% w/w and most preferably at least 85% w/w relative to the total solids of the oxidizing whey protein solution.

Numbered embodiment 13b. The method according to any of the preceding numbered embodiments wherein the oxidizing whey protein solution of step a) has a total protein content in the range of 30-99% w/w relative to the total solids of the oxidizing whey protein solution more preferably 50-97% w/w, even more preferably 75-96% w/w, and most preferably at least 85-95% w/w relative to the total solids of the oxidizing whey protein solution.

Numbered embodiment 14. The method according to any of the preceding numbered embodiments wherein the oxidizing whey protein solution of step a) has a BLG content of at least 20% w/w relative to the total protein of the oxidizing whey protein solution, more preferably at least 40% w/w, even more preferably at least 45% w/w and most preferably at least 50% w/w relative to the total protein of the oxidizing whey protein solution.

Numbered embodiment 15. The method according to any of the preceding numbered embodiments wherein the oxidizing whey protein solution of step a) has a BLG content of at least 55% w/w relative to the total protein of the oxidizing whey protein solution, more preferably at least 60% w/w, even more preferably at least 80% w/w and most preferably at least 90% w/w relative to the total protein of the oxidizing whey protein solution.

Numbered embodiment 16. The method according to any of the preceding numbered embodiments wherein the oxidizing whey protein solution of step a) has a BLG content in the range of 10-99% w/w relative to the total protein of the oxidizing whey protein solution, more preferably 45-98% w/w, even more preferably 80-96% w/w, and most preferably 90-95% w/w relative to the total protein of the oxidizing whey protein solution.

Numbered embodiment 17. The method according to any of the preceding numbered embodiments wherein the oxidizing whey protein solution of step a) has a BLG content in the range of 10-90% w/w relative to the total protein of the oxidizing whey protein solution, more preferably 20-80% w/w, even more preferably 30-75% w/w, and most preferably 45-70% w/w relative to the total protein of the oxidizing whey protein solution.

Numbered embodiment 18. The method according to any of the preceding numbered embodiments wherein the oxidizing whey protein solution of step a) has a total fat content of at most 1% w/w relative to total solids, more preferably at most 0.5% w/w, even more preferably at most 0.2% w/w, and most preferably at most 0.1% w/w relative to total solids.

Numbered embodiment 19. The method according to any of the preceding numbered embodiments wherein condition i) involves the oxidizing whey protein solution of step a) having a temperature in the range of 5-65 degrees C., more preferably 10-65 degrees C., even more preferably 30-60 degrees C., and most preferably 40-55 degrees C.

Numbered embodiment 19a. The method according to any of the preceding numbered embodiments wherein condition i) involves the oxidizing whey protein solution of step a) having a temperature in the range of 66-160 degrees C., more preferably 70-145 degrees C., even more preferably 75-120 degrees C., and most preferably 80-100 degrees C.

Numbered embodiment 20. The method according to any of the preceding numbered embodiments wherein condition ii) involves that the oxidizing whey protein solution of step a) is subjected to a pressure in the range of 100-4000 bar, more preferably 200-3500 bar, even more preferably 300-3000 bar, and most preferably 500-2500 bar.

Numbered embodiment 20a. The method according to any of the preceding numbered embodiments wherein condition ii) involves that the oxidizing whey protein solution of step a) is subjected to a pressure in the range of 25-1000 bar, more preferably 30-500 bar, even more preferably 35-300 bar, and most preferably 40-200 bar.

Numbered embodiment 21. The method according to any of the preceding numbered embodiments wherein step a) comprises condition i).

Numbered embodiment 22. The method according to any of the preceding numbered embodiments wherein step a) comprises condition ii).

Numbered embodiment 23. The method according to any of the preceding numbered embodiments wherein step a) comprises both features i) and ii).

Numbered embodiment 24. The method according to any of the preceding numbered embodiments wherein the processing of the whey protein source in step a) involves:
I) contacting, preferably by combining or mixing, the whey protein source with at least oxidizing agent capable of oxidizing the thiol of cysteine, and optionally further ingredients,
II) if required, pH adjustment to obtain a pH in the range of 6.5-9.5
III) optionally, pressurisation to obtain a pressure in the range of 20-4000 bar
IV) optionally, adjustment of the temperature to a temperature in the range of 0-160 degrees C.

Numbered embodiment 24a. The method according to any of the preceding numbered embodiments wherein the processing of the whey protein source in step a) involves:
I) contacting, preferably by combining or mixing, the whey protein source with at least oxidizing agent capable of oxidizing the thiol of cysteine, and optionally further ingredients,
II) if required, pH adjustment to obtain a pH in the range of 6.5-9.5
III) optionally, pressurisation to obtain a pressure in the range of 100-4000 bar
IV) optionally, adjustment of the temperature to a temperature in the range of 0-65 degrees C.

Numbered embodiment 25. The method according to any of the preceding numbered embodiments wherein step b) reduces, or is performed to reduce, the initial amount of free thiol groups of the oxidizing whey protein solution of step a) to at most 80% of the initial amount, more preferably to at most 76%, even more preferably to at most 73%, and most preferably to at most 70% of the initial amount.

Numbered embodiment 26. The method according to any of the preceding numbered embodiments wherein step b) reduces, or is performed to reduce, the initial amount of free thiol groups of the oxidizing whey protein solution of step a) to 20-80% of the initial amount, more preferably to 30-80%, even more preferably to 50-75%, and most preferably to 60-75% of the initial amount.

Numbered embodiment 27. The method according to any of the preceding numbered embodiments wherein step b) reduces, or is performed to reduce, the initial amount of free thiol groups of the oxidizing whey protein solution of step a) to at most 30% of the initial amount, more preferably to at most 25%, even more preferably to at most 20%, and most preferably to at most 15% of the initial amount.

Numbered embodiment 28. The method according to any of the preceding numbered embodiments wherein step b) reduces, or is performed to reduce, the initial amount of free thiol groups of the oxidizing whey protein solution of step a) to at most 10% of the initial amount, more preferably to at most 5%, even more preferably to at most 3%, and most preferably to at most 1% of the initial amount.

Numbered embodiment 29. The method according to any of the preceding numbered embodiments wherein step b) reduces, or is performed to reduce, the initial amount of free thiol groups of the oxidizing whey protein solution of step a) to 0.01-30% of the initial amount, more preferably 0.02-25%, even more preferably 0.05-20%, and most preferably to 0.1-10% of the initial amount.

Numbered embodiment 30. The method according to any of the preceding numbered embodiments wherein step b) reduces, or is performed to reduce, the amount of free thiol of the oxidizing whey protein solution at most 10 micromol/g protein, more preferably at most 8 micromol/g protein, more preferably at most 5 micromol/g protein, even more preferably at most 3 micromol/g protein, and most preferably at most 2 micromol/g protein.

Numbered embodiment 31. The method according to any of the preceding numbered embodiments wherein step b) reduces, or is performed to reduce, the amount of free thiol of the oxidizing whey protein solution to at most 1 micromol/g protein, more preferably at most 0.7 micromol/g protein, even more preferably at most 0.5 micromol/g protein, and most preferably at most 0.2 micromol/g protein.

Numbered embodiment 32. The method according to any of the preceding numbered embodiments wherein step b) involves adjusting the pH during the oxidation to a pH in the range of 6.5-9.5, more preferably 7.0-8.5, even more preferably 7.2-8.5, and most preferably 7.5-8.5.

Numbered embodiment 33. The method according to any of the preceding numbered embodiments wherein the molar ratio between:
the amount of oxidizing agent consumed during step b) but excluding any removal of the excess oxidizing agent at the end of step b), and
the initial amount of free thiol groups in step a) is 1:2-30:1, more preferably 1:2-25:1, even more preferably 1:1-20:1, and most preferably 1:1-15:1.

Numbered embodiment 34. The method according to any of the preceding numbered embodiments wherein the molar ratio between:
the amount of oxidizing agent capable of oxidizing the thiol group of cysteine consumed during step b) but excluding any removal of excess oxidizing agent at the end of step b), and
the initial amount of free thiol groups in step a) is 2:1-30:1, more preferably 3:1-25:1, even more preferably 4:1-20:1, and most preferably 5:1-15:1.

Numbered embodiment 35. The method according to any of the preceding numbered embodiments wherein the molar ratio between:
the amount of oxidizing agent capable of oxidizing the thiol group of cysteine consumed during step b) but excluding any removal of excess oxidizing agent at the end of step b), and
the initial amount of free thiol groups in step a) is 1:4-15:1, more preferably 1:3-10:1, even more preferably 1:2-5:1, and most preferably 1:2-2:1.

Numbered embodiment 36. The method according to any of the preceding numbered embodiments, the method of the invention does not involve the addition of sulphites and/or does not involve sulphitolysis.

Numbered embodiment 37. The method according to any of the preceding numbered embodiments wherein the one or more conditions of step b) involve I) the oxidizing whey protein solution having a temperature in the range of 5-65 degrees C., more preferably 10-65 degrees C., even more preferably 30-60 degrees C., and most preferably 40-60 degrees C.

Numbered embodiment 37a. The method according to any of the preceding numbered embodiments wherein the one or more conditions of step b) involve I) the oxidizing whey protein solution having a temperature in the range of 66-160 degrees C., more preferably 70-145 degrees C., even more preferably 75-120 degrees C., and most preferably 80-100 degrees C.

Numbered embodiment 38. The method according to any of the preceding numbered embodiments wherein the temperature of the oxidizing whey protein solution of step b) is held within the desired temperature range for a duration sufficient to reduce the initial amount of free thiol groups of the oxidizing whey protein solution of step a) to at most 80% of the initial amount, more preferably to at most 76%, even more preferably to at most 73%, and most preferably to at most 70% of the initial amount.

Numbered embodiment 39. The method according to any of the preceding numbered embodiments wherein the temperature of the oxidizing whey protein solution of step b) is held within the desired temperature range for a duration sufficient to reduce the initial amount of free thiol groups of the oxidizing whey protein solution of step a) to 20-80% of the initial amount, more preferably to 30-80%, even more preferably to 50-75%, and most preferably to 60-75% of the initial amount.

Numbered embodiment 40. The method according to numbered embodiment 38, wherein the temperature of the oxidizing whey protein solution of step b) is held within the desired temperature range for a duration sufficient to reduce the initial amount of free thiol groups of the oxidizing whey protein solution of step a) to at most 30% of the initial amount, more preferably to at most 25%, even more preferably to at most 20%, and most preferably to at most 15% of the initial amount.

Numbered embodiment 41. The method according to any of the preceding numbered embodiments wherein the condition of step b) involves II) that the oxidizing whey protein solution is subjected to a pressure in the range of 100-4000 bar, more preferably 200-3500 bar, even more preferably 300-3000 bar, and most preferably 500-2500 bar.

Numbered embodiment 41a. The method according to any of the preceding numbered embodiments wherein the condition of step b) involves II) that the oxidizing whey protein solution is subjected to a pressure in the range of 25-1000 bar, more preferably 30-500 bar, even more preferably 35-300 bar, and most preferably 40-200 bar.

Numbered embodiment 42. The method according to any of the preceding numbered embodiments wherein the pressure of the oxidizing whey protein solution of step b) is held within the desired pressure range for a duration sufficient to reduce the initial amount of free thiol groups of the oxidizing whey protein solution of step a) to at most 80% of the initial amount, more preferably to at most 76%, even more preferably to at most 73%, and most preferably to at most 70% of the initial amount.

Numbered embodiment 43. The method according to any of the preceding numbered embodiments wherein the pressure of the oxidizing whey protein solution of step b) is held within the desired pressure range for a duration sufficient to reduce the initial amount of free thiol groups of the oxidizing whey protein solution of step a) to 20-80% of the initial amount, more preferably to 30-80%, even more preferably to 50-75%, and most preferably to 60-75% of the initial amount.

Numbered embodiment 44. The method according to numbered embodiment 42, wherein the oxidizing whey protein solution of step b) is subjected to the pressure for a duration sufficient to reduce the initial amount of free thiol groups of the oxidizing whey protein solution of step a) to at most 30% of the initial amount, more preferably to at most 25%, even more preferably to at most 20%, and most preferably to at most 15% of the initial amount.

Numbered embodiment 45. The method according to any of the preceding numbered embodiments wherein step b) involves increasing the temperature of the oxidizing whey protein solution during step b) to the maximum oxidation temperature with a heating rate of at most 2 degrees C. per minute, more preferably at most 1 degrees C. per minute, even more preferably at most 0.3 degrees C. per minute, and most preferably at most 0.1 degrees C. per minute.

Numbered embodiment 46. The method according to any of the preceding numbered embodiments wherein step b) does not involve adding or generating additional oxidizing agent capable of oxidizing the thiol group of cysteine during step b).

Numbered embodiment 47. The method according to any of the preceding numbered embodiments wherein step b) involves adding or generating additional oxidizing agent capable of oxidizing the thiol group of cysteine during step b).

Numbered embodiment 48. The method according to any of the preceding numbered embodiments wherein the duration of step b) is at most 48 hours, more preferably at most 36 hours, even more preferably at most 30 hours, and most preferably at most 25 hours.

Numbered embodiment 49. The method according to any of the preceding numbered embodiments wherein the duration of step b) is 0.1-48 hours, more preferably 3-36 hours, even more preferably 5-30 hours, and most preferably 10-25 hours.

Numbered embodiment 50. The method according to any of the preceding numbered embodiments wherein the duration of step b) is at most 12 hours, more preferably at most 6 hours, even more preferably at most 3 hours, and most preferably at most 1 hour.

Numbered embodiment 50a. The method according to any of the preceding numbered embodiments wherein the duration of step b) is at most 10 minutes, more preferably at most 6 minutes, even more preferably at most 3 minutes, and most preferably at most 2 minutes.

Numbered embodiment 51. The method according to any of the preceding numbered embodiments wherein the duration of step b) is 0.1-12 hours, more preferably 0.1-6 hours, even more preferably 0.1-3 hours, and most preferably 0.1-1 hour.

Numbered embodiment 51a. The method according to any of the preceding numbered embodiments wherein the duration of step b) is 0.1 second-10 minutes, more preferably 1 second-6 minutes, even more preferably 5 seconds-3 minutes, and most preferably 10 second-2 minutes.

Numbered embodiment 52. The method according to any of the preceding numbered embodiments wherein step b) involves allowing the oxidation to proceed until substantially all oxidizing agent capable of oxidizing the thiol group of cysteine has been used.

Numbered embodiment 53. The method according to any of the preceding numbered embodiments wherein step b) involves stopping the oxidation by contacting the oxidizing whey protein solution with a component, preferably catalase that eliminates the residual oxidizing agent capable of oxidizing the thiol group of cysteine.

Numbered embodiment 54. The method according to any of the preceding numbered embodiments furthermore comprising c) which involves subjecting the oxidized whey protein solution obtained from step b) to a heat-treatment step.

Numbered embodiment 55. The method according to any of the preceding numbered embodiments furthermore comprising step d) of drying a liquid feed comprising at least the protein derived from of the oxidized whey protein solution obtained from step b).

Numbered embodiment 56. An oxidized whey protein composition having:
a protein content of at least 30% w/w relative to total solids,
preferably, a fat content of at most 3% w/w relative to total solids,
at most 15 micromol free thiol groups/g protein,
preferably, a tryptophan content of at least 0.7% w/w relative to total protein,
preferably, a methionine content of at least 0.3% w/w relative to total protein,
preferably, a kynurenine content of at most 0.2 micrograms/mg protein,
preferably, a content of protein-bound sulfur in the range of 100-600 micromol/g protein, and
preferably, a content of protein-bound cysteine residues that form disulfide bonds in the range of 150-400 micromol/g protein.

Numbered embodiment 57. The oxidized whey protein composition according to numbered embodiment 56 which is obtainable by oxidation of a whey protein source as described herein, preferably by a method according to one or more of numbered embodiments 1-49.

Numbered embodiment 58. The oxidized whey protein composition according to any of the numbered embodiments 56-57 in the form of a liquid or a solid, and preferably a powder.

Numbered embodiment 59. A process of producing a food product comprising:
processing the oxidized whey protein composition, and/or
combining the oxidized whey protein composition according to one or more of numbered embodiments 56-58 or the processed oxidized whey protein composition with one or more further ingredients, and optionally processing the combination.

Numbered embodiment 60. A process of producing a heat-treated, and preferably heat-sterilized, beverage having a pH of 5.5-8.5, more preferably 6.5-7.5, the process comprises:
1) combining oxidized whey protein composition according to one or more of numbered embodiments 50-52 with one or more further ingredients to obtain a liquid mixture having a pH of 5.5-8.5 and the liquid mixture comprising:
   the oxidized whey protein composition in an amount sufficient to contribute with at least 0.5% w/w protein,
   preferably, sweetener and/or flavour, and
   water,
2) packaging the liquid mixture in a container,
wherein the liquid mixture is subjected to heat-sterilisation prior to and/or after packaging.

Numbered embodiment 61. The process according to numbered embodiment 60 wherein the liquid mixture, prior to the heat-sterilisation, contains at most 60 micromol free thiol groups/100 g liquid mixture, more preferably at most 40 micromol free thiol groups/100 g liquid mixture, even more preferably at most 30 micromol free thiol groups/100 g liquid mixture, and most preferably at most 30 micromol free thiol groups/100 g liquid mixture.

Numbered embodiment 62. The process according to numbered embodiment 60 or 61 wherein the liquid mixture, prior to the heat-sterilisation, contains at most 20 micromol free thiol groups/100 g liquid mixture, more preferably at most 15 micromol free thiol groups/100 g liquid mixture, even more preferably at most 10 micromol free thiol groups/100 g liquid mixture, and most preferably at most 5 micromol free thiol groups/100 g liquid mixture.

Numbered embodiment 63. A food product comprising the oxidized whey protein composition according to one or more of numbered embodiments 56-58, preferably in an amount to contribute with protein in an amount of at least 0.5% w/w relative to the weight of the food product.

Numbered embodiment 64. A heat-treated, preferably heat-sterilized, beverage having a pH of 5.5-8.5, and more preferably 6.5-7.5, the beverage comprising the oxidized whey protein composition according to one or more of numbered embodiments 56-58 in an amount sufficient to contribute with at least 0.5% w/w protein.

Numbered embodiment 65. The heat-treated, preferably heat-sterilized, beverage according to numbered embodiment 64 having a content of H₂S of at most 5 micromol/L, more preferably 3 micromol/L, even more preferably 1.0 micromol/L, and most preferably at most 0.7 micromol/L.

Numbered embodiment 66. The heat-treated, preferably heat-sterilized, beverage according to numbered embodiment 64 or 65 having a content of H₂S 1 hour after production of at most 5 micromol/L, more preferably 3 micromol/L, even more preferably 1.0 micromol/L, and most preferably at most 0.7 micromol/L.

Numbered embodiment 67. The heat-treated, preferably heat-sterilized, beverage according to any of numbered embodiments 64-66 having a content of H₂S 7 days after production of at most 5 micromol/L, more preferably 3 micromol/L, even more preferably 1.0 micromol/L, and most preferably at most 0.7 micromol/L.

Numbered embodiment 68. The heat-treated, preferably heat-sterilized, beverage according to any of numbered embodiments 64-67 comprising a total amount of protein in the range of 0.5-15% w/w relative to the weight of the beverage, more preferably 1-10% w/w relative to the weight of the beverage, even more preferably 2-9% w/w relative to the weight of the beverage, and most preferably 3-8% w/w relative to the weight of the beverage.

Numbered embodiment 69. The heat-treated, preferably heat-sterilized, beverage according to any of numbered embodiments 64-68 comprises oxidized whey protein composition according to one or more of numbered embodiments 56-58 in an amount sufficient to contribute with at least 30% w/w of the total protein of the heat-treated beverage, more preferably at least 50% w/w of the total protein, even more preferably at least 70% w/w of the total protein, and most preferably at least 80% w/w of the total protein.

Numbered embodiment 70. The heat-treated, preferably heat-sterilized, beverage according to any of numbered embodiments 64-69 comprises oxidized whey protein composition according to one or more of numbered embodiments 56-58 in an amount sufficient to contribute with at least 90% w/w of the total protein of the heat-treated beverage, more preferably at least 95% w/w of the total protein, even more preferably at least 99% w/w of the total protein, and most preferably 100% w/w of the total protein.

Numbered embodiment 71. The heat-treated, preferably heat-sterilized, beverage according to any of numbered embodiments 64-70 comprising total protein in an amount of at least 50% w/w relative to total solids, more preferably at least 60% w/w, even more preferably at least 70% w/w, and most preferably at least 80% w/w relative to total solids.

Numbered embodiment 72. The heat-treated, preferably heat-sterilized, beverage according to any of numbered embodiments 64-71 comprising total protein in an amount of at least 80% w/w relative to total solids, more preferably at least 90% w/w, even more preferably at least 92% w/w, and most preferably at least 94% w/w relative to total solids.

Numbered embodiment 73. The heat-treated, preferably heat-sterilized, beverage according to any of numbered embodiments 64-72 having a solids content of 0.5-50% w/w, more preferably 1-35% w/w, even more preferably 2-20% w/w, and most preferably 3-10% w/w.

Numbered embodiment 74. The food product according to any of numbered embodiments 63-73 obtainable according to a process according to one or more of numbered embodiments 60-62.

Numbered embodiment 75. A food ingredient comprising:
the solids of the oxidized whey protein composition according to one or more of numbered embodiment 56-58, and
one or more further ingredient(s), preferably selected from:
   a dairy ingredient, preferably a non-oxized dairy ingredient,
   a plant-based ingredient,
   a non-dairy carbohydrate source,
   a flavouring agent, and/or
   a sweetener (sweet carb/polyol/HIS).

Numbered embodiment 76. The food ingredient according to numbered embodiment 75 wherein the one or more further ingredient(s) comprise a dairy ingredient comprising one or more of micellar casein, non-oxidized whey protein, caseinomacropeptide, ultrafiltration permeate of milk or whey, denatured whey protein, and a combination thereof.

Numbered embodiment 77. The food ingredient according to numbered embodiment 75 or 76 wherein the one or more further ingredient(s) comprise a plant-based ingredient which preferably comprises one or more of soy protein, pea protein, plant-based dietary fiber, and a combination thereof.

Numbered embodiment 78. The food ingredient according to any one of numbered embodiment 75-77 wherein the one or more further ingredient(s) comprise a non-dairy carbohydrate source which preferably comprises one or more of sucrose, maltodextrin, non-dairy oligosaccharide, non-dairy polysaccharide.

Numbered embodiment 79. The food ingredient according to any one of numbered embodiment 75-78 wherein the one or more further ingredient(s) comprise a sweetener, which preferably comprises one or more of a carbohydrate sweetener, a polyol, a high intensity sweetener, and a combination thereof.

Numbered embodiment 80. The food ingredient according to any one of numbered embodiment 75-79 wherein the solids of the oxidized whey protein composition according to one or more of numbered embodiment 56-58 contribute with 0.5-95% w/w of the weight of the food ingredient, more preferably 1-90% w/w, even more preferably 5-85% w/w, and most preferably 10-80% w/w of the weight of the food ingredient.

In the context of the present invention the term “solids of the oxidized whey protein composition” pertain to the solid matter (including protein, carbohydrate, lipid and minerals) that remains if all water is removed from an oxidized whey protein composition. “Solids of the oxidized whey protein composition” may e.g. be provided by an oxidized whey protein composition in the form of a powder or in the form of a liquid.

Numbered embodiment 81. The food ingredient according to any one of numbered embodiment 75-80 wherein the solids of the oxidized whey protein composition according to one or more of numbered embodiment 56-58 contribute with 0.5-60% w/w of the weight of the food ingredient, more preferably 1-50% w/w, even more preferably 5-40% w/w, and most preferably 10-30% w/w of the weight of the food ingredient.

Numbered embodiment 82. The food ingredient according to any one of numbered embodiment 75-81 wherein the solids of the oxidized whey protein composition according to one or more of numbered embodiment 56-58 contribute with 0.5-95% w/w of the protein of the food ingredient, more preferably 1-90% w/w, even more preferably 5-85% w/w, and most preferably 10-80% w/w of the protein of the food ingredient.

Numbered embodiment 83. The food ingredient according to any one of numbered embodiment 75-82 wherein the solids of the oxidized whey protein composition according to one or more of numbered embodiment 56-58 contribute with 0.5-60% w/w of the protein of the food ingredient, more preferably 1-50% w/w, even more preferably 5-40% w/w, and most preferably 10-30% w/w of the protein of the po food ingredient wder.

Numbered embodiment 84. The food ingredient according to any one of numbered embodiment 75-83 comprising free thiol groups in an amount of at most 15 micromol/g protein, more preferably at most 14 micromol/g protein, even more preferably at most 13 micromol/g protein, and most preferably at most 12 micromol/g protein.

Numbered embodiment 85. The food ingredient according to any one of numbered embodiment 75-84 comprising free thiol groups in an amount of 0.001-15 micromol/g protein, more preferably 0.01-14 micromol/g protein, even more preferably 0.01-13 micromol/g protein, and most preferably 0.01-12 micromol/g protein.

Numbered embodiment 86. The food ingredient according to any one of numbered embodiment 75-85 comprising free thiol groups in an amount of at most 10 micromol/g protein, more preferably at most 8 micromol/g protein, more preferably at most 5 micromol/g protein, even more preferably at most 3 micromol/g protein, and most preferably at most 2 micromol/g protein.

Numbered embodiment 87. The food ingredient according to any one of numbered embodiment 75-86 comprising free thiol groups in an amount of 0.01-10 micromol/g protein, more preferably 0.01-8 micromol/g protein, more preferably 0.01-5 micromol/g protein, even more preferably 0.01-3 micromol/g protein, and most preferably 0.01-2 micromol/g protein.

Numbered embodiment 88. The food ingredient according to any one of numbered embodiment 75-87 in the form of a liquid, preferably using water as the main solvent, and more preferably using water as the only solvent.

Numbered embodiment 89. The food ingredient according to any one of numbered embodiment 75-87 in the form of a powder, preferably comprising water in an amount of at most 6% w/w.

Numbered embodiment 90. The food ingredient according to numbered embodiment 89 wherein the powder is prepared by dry-blending of the oxidized whey protein composition according to one or more of numbered embodiment 56-58 in the form of a powder with one or more further ingredient(s) in powder form.

Numbered embodiment 91. The food ingredient according to numbered embodiment 89 wherein the powder is prepared by drying a liquid according to numbered embodiment 88, preferably by spray-drying.

Numbered embodiment 100. Use of an oxidized whey protein composition, preferably the oxidized whey protein composition according to one or more of numbered embodiment 56-58 as a food ingredient, preferably for improving the odour and/or reducing the unpleasant odour similar to the odour of rotten eggs of heat-sterilized, beverages having a pH in the range of 5.5-8.5, preferably having a whey protein content of at least 3% w/w, and preferably heat-sterilized using indirect heat-treatment.

The present invention has been described above with reference to specific embodiments. However, other embodiments than the above described are equally possible within the scope of the invention. The different features and steps of various embodiments and aspects of the invention may be combined in other ways than those described herein unless it is stated otherwise.

### EXAMPLES

### Methods of Analysis

### Analysis A: Total Protein

The total protein content (true protein) of a sample is determined by:

1) Determining the total nitrogen of the sample following ISO 8968-1/2|IDF 020-1/2-Milk—Determination of nitrogen content-Part 1/2: Determination of nitrogen content using the Kjeldahl method.

2) Determining the non-protein nitrogen of the sample following ISO 8968-4|IDF 020-4-Milk—Determination of nitrogen content-Part 4: Determination of non-protein-nitrogen content.
3) Calculating the total amount protein as (m_{total nitrogen}−m_{non-protein-nitrogen})*6.38.

### Analysis B: pH

All pH values are measured using a pH glass electrode and are normalised to 25 degrees C. The pH glass electrode (having a temperature compensation) is rinsed carefully before and calibrated before use.

When the sample is in liquid form, then pH is measured directly in the liquid solution and normalized to 25 degrees C.

When the sample is a powder, 10 grams of a powder is dissolved in 90 ml of demineralised water at room temperature while stirring vigorously. The pH of the solution is then measured and normalized to 25 degrees C.

### Analysis C: Viscosity

The viscosity was estimated using a Viscoman by Gilson at 22° C. and reported at a shear rate of about 300 s⁻¹.

Analysis D: Quantification of H₂S using a H₂S Sensor

The level of H2S was measured by a microsensor (SULF-NPLR, needle type, Unisense A/S, Denmark), which is connected to a single channel amplifier (Monometter-9514, Unisense A/S, Denmark). The obtained H2S signal is shown as milli volt which can be used as indicator of H2S levels in the sample, and logged in the software “LOGGER” provided by Unisense A/S. The microsensor was calibrated at each day before use and a H2S calibration kit, supplied by the manufacturer (Calkit-H2S, Unisense A/S, Denmark) is used. The highest concentration of H2S in the calibration kit was further diluted 10 times, according to section 7 in the manual (version November 2020, Unisense A/S). The concentration of the H2S can be converted automatically by the software in the unit of μM.

To measure samples from simulated or pilot-scale UHT, samples were equilibrated for 30 minutes at 20 degrees C. and the sensor needle was pierced through the silicon sealing and into the liquid phase of the sample. Triplicates were carried out for each sample.

### Analysis E: Free and Total Thiol Groups

The content of free and total thiol groups in whey protein samples was quantified using the methods described by Kurz et al (2020) using equipment identical to that used by the authors. The free thiols (SH) content in samples is typically reported in micromoles per gram of protein with the protein content determined by the total protein method of analysis A.

Kurz, F., Hengst, C., & Kulozik, U. (2020). RP-HPLC method for simultaneous quantification of free and total thiol groups in native and heat aggregated whey proteins. MethodsX, 101112.

### Analysis F1: Quantification of Amino Acids

Amino acids were quantified by the method described by:

Zainudin M A M, Poojary M M, Jongberg S, Lund M N. Light exposure accelerates oxidative protein polymerization in beef stored in high oxygen atmosphere. Food Chem. 299 (2019) 125132. All were frozen to −80° C. immediately after preparation, transported on dry ice and again kept at −80° C. until analyzed.

0.5 mg protein was hydrolyzed using deaerated 4 M methanesulfonic acid (with 0.2% w/v tryp-tamine) in a Pico Tag hydrolysis vial in vacuo for 17 h 30 min at 110° C.

Neutralized dry hydrolysates were mixed with aminoacproic acid (internal standard) and derivatized with o-phthalaldehyde/3-mercaptopropionic acid and fluorenylmethyloxycarbonyl chloride. The derivatized amino acids were analyzed using a UHPLC-FLD system equipped with a Agilent AdvanceBio AAA column. Quantification (internal standard calibration) of each amino acid was carried out based on an eight point calibration curve constructed using authentic standards.

### Analysis F2: Quantification of Amino Acid Oxidation

Protein oxidation products were determined by the method described by:

Mahesha M. Poojary, Brijesh K. Tiwari, Marianne N. Lund, Selective and sensitive UHPLC-ESI-Orbitrap MS method to quantify protein oxidation markers, Talanta Volume 234 (2021), 122700.

All samples analyzed by analysis were frozen to −80° C. immediately after preparation, transported on dry ice and again kept at −80° C. until analyzed.

0.5 mg protein was hydrolysed using deaerated 4 M methanesulfonic acid (with 0.2% w/v tryp-tamine) in a Pico Tag hydrolysis vial in vacuo for 17 h 30 min at 110° C.

Neutralized dry hydrolysates were mixed with 5-methyltryptophan (internal standard) and analyzed using a UHPLC-FLD system equipped with a Waters Aquity HSS T3 column.

Quantification (internal standard calibration) of each amino acid was carried out based on an eight point calibration curve constructed using authentic standards.

Analysis G: Determination of Molecular Weight and Intrinsic Viscosity after Oxidation by GPC Analysis

The molecular weight of protein species in whey protein samples was analyzed by size exclusion chromatography using a SEC-MALS-IV—RI HPLC system essentially consisting of Thermo ISO.3100SD pump, WPS-3000TSL autosampler and Refractomax 521 refractive index detector. The system was further equipped with a Wyatt miniDawn TREOS II light scattering detector and a Wyatt Viscostar online viscometer.

All samples were diluted to 1% protein in eluent (10 mM phosphate, 30 mM NaCl pH 7.0 and 0.1% proclin) and 10 μl was separated in the eluent at 0.75 ml/min using 1× Bio-SEC-5 guard+2×300 Å BioSEC-5.

The instrument provides results well within 10% of aLA, BLG and BSA standards.

Data analysis: Weight-average molecular weight and weight-average intrinsic viscosity were determined using the Astra software [v7.3.2.19] by integration of all signals eluting before the void volume, i.e. both monomer, oligomer and larger aggregate species.

### Analysis H: Determination of Residual Hydrogen Peroxide

Residual hydrogen peroxide was determined using a quantitative colorimetric assay according to manufacturers description (Abcam ab102500 Hydrogen Peroxide Assay Kit (Colorimetric/Flu-orometric; version 6 Last Updated 8 Jan. 2019) using a Synergy Mx microplate reader. All samples were diluted in 10 mM phosphate pH 7.0 relative to the amount of H2O2 initially added to secure that the residual H2O2 concentration in 50 μl sample was within linear range of assay, i.e. 0-5 nmol H2O2/well; using H2O2 standard supplied with assay kit.

A calibration curve containing 0-5 nmol H2O2/well was established as described by the manufacturer using H2O2 standard supplied with assay kit.

The concentration of H2O2 in samples was determined from the calibration curve and sample dilution.

### Analysis I: Quantification of Non-Reducible Lanthionine and Lysinoalanine Cross-Links in Whey Protein Samples

The amount of lanthionine in WPI samples was determined as described by:

Mahesha M. Poojary et al., “Liquid chromatography quadrupole-Orbitrap mass spectrometry for the simultaneous analysis of advanced glycation end products and protein-derived cross-links in food and biological matrices,” Journal of Chromatography A, Volume 1615, 2020 with the modification of using columns and solvents from analysis F2.

All samples analyzed by analysis I were frozen to −80° C. immediately after preparation, transported on dry ice and again kept at −80° C. until analyzed.

In brief, a sample corresponding to 0.5 mg protein was hydrolysed using deaerated 6 M hydrochloric acid (with thioglycolic acid) in a Pico Tag hydrolysis vial in vacuo for 22 h at 110° C. The dried hydrolysates were mixed with lysine-d4 (internal standard) and analyzed using an LC-MS system equipped with a Waters Aquity HSS T3 column. Quantification (internal standard calibration) of LAL and LAN was carried out based on an eight point calibration curve constructed using authentic standards.

### Analysis J: Determination of Non-H2S Smells in Thermally Treated Samples

Whey protein beverages were analysed for non-H2S smells using a Dynamic Headspace sampling method combined with separation using Gas Chromatography and identification using Mass Spectroscopy. The non-H2S smells in beverages were all measured in triplicates. The samples were subjected to UHT treatment as described in Example 1 and the content of H2S was determined according to Analysis D. Samples from several thermally treated vials were collected to allow transfer of 5 ml sample to 100 mL blue-cap flasks. 1.5 uL of a 100 ppm 2-hexanone-5-methyl internal standard solution was added to reach a final concentration of 30 ppb.

Adsorbent traps (Tenax TA/Graphitized Carbon/Carboxen 1000, Restek Corporation) were attached to the bottles and the beverages were placed in a thermostatically controlled water bath at 20° C. and sparred with 100 ml/min nitrogen for 1 hour while being stirred.

The adsorbent traps were desorbed at 300° C. for 15 min (Turbomatrix ATD 350, Perkin Elmer) using a 50 ml/min hydrogen flow, into a cold trap (Perkin Elmer) packed with Tenax TA 60/80 (Sigma-Aldrich) and Carbopack X (Sigma Aldrich). The desorbed volatiles were focused at 4° C. for 15 min and then injected onto a gas chromatograph column through a transfer line by raising the temperature of the trap to 300° C., using a 3:1 split. The Gas Chromatograph (Agilent Technologies, 7890A GC-MS) was equipped with a DB-Wax column (30 m×250 μm, film thickness 0.25 μm, Agilent technologies).

The gradient program included an isothermal step at 35° C. for 10 minutes a ramp to 240° C. at 8° C./min, followed by a 5 min isothermal step. The GC was connected to a single quadrupole mass spectrometer (5975C Agilent Technologies). The MS transfer line temperature was 250° C. and the ion source temperature was 200° C. The mass spectrometer was scanned over a mass to charge (m/z) range of 20-400 and the spectra were obtained using a fragmentation voltage of 70 eV.

An MS database (NIST MS search version 2.0) was used to identify the volatile compounds. In addition, all of the compounds were verified by comparison of mass spectral data and retention times with authentic reference compounds. The quantity of identified volatile compounds was calculated using a semi-quantitative approach using the concentration and peak area of the internal standard 2-Hexanone-5-Methyl.

### Analysis K: Sensory Evaluation of UHT Treated Whey Protein Isolates

The sensory analysis of the UHT treated beverages were performed at the department of Food science at Aarhus University.

An attribute list prior to the final tasting/smelling session was made. The attributes were rated on a 15 cm scale with 0=low intensity and 15=high intensity.

### Odour Evaluation:

Due to the volatility of the odour compounds of the products, the samples were served in the original bottle. The panellists had to open the bottle themselves and evaluate the odour. For every panellist and every different repetition, a new bottle was used.

### Flavour and Mouthfeel Evaluation:

The flavour of the drinks was evaluated by excluding the orthro-nasal odour effect. In this effort, the samples were left open for an hour, to make sure that as little volatiles as possible are present during the evaluation. In addition, the samples were presented in small plastic cups with straws. This way, the panellists did not smell directly the samples when tasting. In addition, panellists used spittoons/spitting cups for this flavour evaluation of the samples.

The statistical analysis was conducted in ‘Panelcheck’ software using a 3-way ANOVA test for multiple replicates. Samples were fixed and panel was set to random.

Duncan's test (Software used: XLSTAT) implying least significance difference values (pairwise comparisons of groups associated to a letter) was used to evaluate significant differences between samples.

### Analysis L: Quantification of Native BLG/ALA/CMP by RP-HPLC Analysis

Protein samples/powders were prepared by dilute to 2% protein in MQ water. The solution is filtered through 0.22 μm filter to remove protein agglomerates. For each sample, the same volume was loaded on an UPLC system (ACQUITY UPLC H-Class, WATERS) with a UPLC column (Protein BEH C4; 300 Å; 1.7 μm; 150×2.1 mm) and detected at 214 nm.

The samples were run using the following conditions:
Buffer A: Milli-Q water, 0.1% w/w TFA
Buffer B: HPLC grade acetonitrile, 0.1% w/w TFA
Flow: 0.4 ml/min
Gradient: 0-6.00 minutes 24-45% B; 6.00-6.50 minutes 45-90% B; 6.50-7.00 minutes 90% B; 7.00-7.50 minutes 90-24% B and 7.50-10.00 minutes 24% B.

The area of the BLG/ALA/CMP peaks was used to quantify the amount BLG/ALA/CMP protein using a standard curve prepared using a pure BLG/ALA/CMP protein standard (BLG Sigma L0130). Samples were diluted further and reinjected if outside linear range.

### Analysis M: Quantification of Total Solids

The total solids of a solution may be determined according NMKL 110 2 Edition, 2005 (Total solids (Water)-Gravimetric determination in milk and milk products). NMKL is an abbreviation for “Nordisk Metodikkomite for Næringsmidler”.

The water content of the solution can be calculated as 100% minus the relative amount of total solids (% w/w).

### Analysis N: Quantification of Fat Content

The amount of lipid is determined according to ISO 1211:2010 (Determination of Fat Content-Rose-Gottlieb Gravimetric Method).

### Analysis O: Quantification of Lactose Content

The total amount of lactose is determined according to ISO 5765-2:2002 (IDF 79-2:2002) “Dried milk, dried ice-mixes and processed cheese-Determination of lactose content-Part 2: Enzymatic method utilizing the galactose moiety of the lactose”.

### Analysis P: Characterisation of Mineral Composition

The total amounts of calcium, magnesium, sodium, potassium, and phosphorus are determined using a procedure in which the samples are first decomposed using microwave digestion, and then the total amount of mineral(s) is determined using an ICP apparatus.

### Apparatus:

The microwave is from Anton Paar and the ICP is an Optima 2000DV from PerkinElmer Inc.

### Materials:

1 M HNO₃
Yttrium in 2% HNO₃

Suitable standards for calcium, magnesium, sodium, potassium, and phosphorus in 5% HNO₃

### Pre-Treatment:

Weigh out 0.2 gram of powder sample or 1 g of liquid samples and transfer the powder to a microwave digestion tube. Add 5 mL 1M HNO₃. Digest the samples in the microwave in accordance with microwave instructions. Place the digested tubes in a fume cupboard, remove the lid and let volatile fumes evaporate.

### Measurement Procedure:

Transfer pre-treated sample to DigiTUBE using a known amount of Milli-Q water. Add a solution of yttrium in 2% HNO₃ to the digestion tube (about 0.25 mL per 50 mL diluted sample) and dilute to known volume using Milli-Q water. Analyse the samples on the ICP using the procedure described by the manufacturer.

A blind sample is prepared by diluting a mixture of 10 mL 1M HNO₃ and 0.5 mL solution of yttrium in 2% HNO₃ to a final volume of 100 mL using Milli-Q water.

At least 3 standard samples are prepared having concentrations which bracket the expected sample concentrations.

The detection limit for liquid samples is 0.005 g/100 g sample for Ca, Na, K and Phosphor and 0.0005 g/100 g sample for Mg. The detection limit for powder samples is 0.025 g/100 g sample for Ca, Na, K and Pho and 0.0005 g/100 g sample for Mg.

### Analysis Q: Determination of Turbidity

Turbidity is the cloudiness or haziness of a fluid caused by large number of particles that are generally invisible to the naked eye, similar to smoke in air.

Turbidity is measured in nephelometric turbidity units (NTU).

20 mL beverages/samples were added to NTU-glass and placed in the Turbiquant® 3000 IR Turbidimeter. The NTU-value was measured after stabilisation and repeated twice.

### Example 1: Gentle Thiol Oxidation at pH 8.0 and Low Temperature

In this experiment, the inventors documented the initial discovery and demonstrated the feasibility of reducing or removing the unpleasant odour similar to the odour of rotten eggs of pH-neutral, UHT treated whey protein beverages by gentle, low temperature oxidation of free thiols of whey protein at pH 8.0.

In the present and the following Examples, the reference to “unpleasant odour” means unpleasant odour similar to the odour of rotten eggs.

### Materials and Methods:

Solutions containing 10 or 6% w/w protein based on the powders WPI-A (99.6% native BLG) and WPI-B (50% BLG), respectively, were prepared by mixing powder with ultrapure water (18.2 MOhm) and subsequently allowing the mixture to hydrate under gentle stirring for 1 hour at about 20 degrees C. after which the inventors observed no remaining powder particles and the solution becomes transparent. Characteristics of the powders used in the investigations are described in Table 1.

TABLE 1
Composition of exemplary whey protein isolates
(BLG = beta-lactoglobulin; SH = free thiol;
BDL = below limit of detection; TS = total solids)

| | WPI-A | WPI-B |
|---|---|---|
| Protein/TS | 96% | 94% |
| BLG relative to total protein | 99.6% | 50% |
| ALA relative to total protein | <1% | 20% |
| cGMP relative to total protein | <1% | 19% |
| Free thiol in micromol/gram | 54 | 21.6 |
| protein | | |
| Na, % of TS | 0.28 | 0.5 |
| K, % of TS | 0.67 | 1.19 |
| Mg, % of TS | 0.003 | 0.006 |
| Ca, % of TS | 0.02 | 0.066 |
| pH of 6% solution | 7.0 | 6.7 |
| Lactose % | ≤0.1 | ≤0.1 |
| Fat % | ≤0.1 | ≤0.1 |

The pH of whey protein solutions was adjusted and measured to 8.0 at 20° C. using 3M NaOH and 15 mL samples in 20 mL Duran GL 18 reagent glasses with screw-cap lids with aliqouts kept for reference purposes. The WPI samples in reagent glasses were thermally equilibrated to 10, 25, 40, 50 or 60° C. in a water bath. Hydrogen peroxide (H2O2) was added to a H2O2:BLG molar ratio of 5:1 or 8:1 as described in Table 2 based on molarity of a 30% w:w H2O2 solution with a density of 1.11 g/mL and molecular weight of 34.01 g/mol of 9.79M and the molar concentration of BLG obtainable from Analysis L and the molecular weight of BLG of 18.4 kDa. A similar 6% WPI-B sample set adjusted to pH 6.5 and incubated at 10 and 25° C. in the presence of 8:1 H2O2:BLG were produced.

BLG typically constitutes about 50% or more of the protein of whey protein and is furthermore the primary source of free thiols of whey protein (BLG contains one free thiol group per molecule). The molar concentration of native BLG in a whey protein composition is therefore a good approximation to the molar content of free thiol groups of whey protein composition. Thus, it makes sense to select the dosage of oxidizing agent relative to the content of native BLG of the whey protein composition.

Table 2 provides an overview of reaction conditions at the start of the incubation for 18 hours after which samples were taken for analysis of residual H2O2 (according to Analysis H) followed by the addition of catalase (3.65 mL Catazyme 25 L per 150 L liquid product) to stop further H2O2 oxidation of the WPI samples by dismutation of H2O2.

The residual free thiol groups in proteins and potential aggregation of the oxidized whey protein composition as a consequence of treatment were analysed by GPC-MALS according to Analysis E and G, respectively.

### UHT-Simulation:

To evaluate the influence of oxidative treatments on the development of unpleasant odour, the samples were subjected to UHT-like treatment as described below:

The pH of samples was adjusted to 7.0 and diluted to 6% protein. 1.0 mL of the oxidized whey protein solutions were transferred to 2 mL GC vials (Mikrolab no ML 33003VU) and crimp-sealed using aluminium lids (Mikrolab ML 33032) and an electronic crimper (Thermo Scientific CRMA60180-ECRH11KI). The samples were visually inspected for signs of haziness and monitored while inversed as a first probe for indication of flow properties.

The sealed vials (at room temperature) were transferred to an aluminium heating block of a Mikrolab supertherm system (Control unit ML 306228 and heating unit ML3062409, Mikrolab A/S, Denmark) with holes drilled by the manufacturer to match the dimensions of the vials 2 mL GC vials. The block was preheated to 160 degrees C. and the samples were kept in the block for 160 seconds. The temperature reached 100 degrees C. in about 40 seconds, about 120 degrees C. in 65 seconds and reaches 140 C after 100 seconds of incubation and 150 degC after 160 seconds. After incubation in the heating block, the samples were transferred to an ice-water bath to rapidly quench reactions leading to development of unpleasant odour. H2S was measured directly within sealed vials according to Analysis D.

The UHT-simulation by incubation of the samples in the aluminium block at 160 degrees C. for 160 seconds had been shown by the inventors to closely simulate a traditional UHT treatment at 143° C. for 4 sec using indirect heating with a plate-heat exchanger. The inventors had furthermore found that the aluminium block at 160 degrees C. for 160 seconds results in equal amounts of unpleasant odour as determined by the content of H2S as the indirect UHT treatment at 143° C. for 4 seconds.

The inventors ranked the perception of unpleasant sulfuric/rotten odour by sensory evaluation from samples 24 hours after simulated UHT treatment. The vials were decapped immediately prior to the evaluation and the “unpleasant sulfuric odour” was evaluated on a scale from 0-15 where 0 is the low intensity of water and 15 correspond to the high intensity of a 10 μM H2S standard prepared according to Analysis D.

TABLE 2
Process detailed of the samples of modified WPI.

| Protein source | WPI-A | WPI-B |
|---|---|---|
| Total protein concentration | 10% | 6% |
| Incubation temperature, ° C. | 10, 25, 40 | 10, 25, 40, 50 or 60 |
| pH at 20° C. | 8.0 | 8.0 |
| H2O2:BLG molar ratio | 5:1 | 8:1 |
| Duration of oxidation, | 18 hr | 18 hr |
| hours | | |

### Results:

The inventors have studied the development of unpleasant odour in whey protein isolates (WPI) subjected to harsh heat treatments at neutral pH such as treatment at 143° C. for 2-16 seconds and by use of H2S selective electrodes surprisingly found that the strong sulfuric off-flavour developed in such whey protein isolate beverage compositions predominantly consists of hydrogen sulfide that likely originate from beta-elimination of cysteine to hydrogen sulfide and dehydroalanine. Indeed, the inventors confirmed that the unpleasant odour consists primarily of H2S by use of gas chromatography/mass spectroscopy and gas chromatography/flame photometric detection.

As shown in Table 3, the inventors surprisingly found that certain conditions allowing oxidation of the whey protein isolate and they found a direct relation between the consumption of hydrogen peroxide and reduction residual thiols in the process and the resulting reduction of the development of unpleasant odour similar to the odour of rotten eggs in UHT treated samples.

The inventors were particularly surprised to find it necessary to heat exemplary WPI samples (WPI-A and WPI-B in Table 2) above ambient temperatures such as 40° C. to allow the reaction between free thiols and hydrogen peroxide to proceed even when incubating at an elevated pH of 8.0 for up to at least 18 hours. Indeed, the inventors observed no reduction in free thiol content of 6% WPI WPI-B samples incubated with 8:1 H2O2:BLG at 10 or 25° C. at pH 6.5 and the oxidation of thiols can thus not be expected to efficiently occur under typical industrial process conditions where low temperatures are desired to arrest microbial growth.

A strong H2S odour was detected in the UHT treated, non-oxidized sample WPI-A1 and the inventors found that the strongly perceived odour similar to rotten eggs (sensory score of 10) was further associated with a high measured electrode potential of 92 mV.

In contrast, sample WPI-A4 which was subjected to treatment with 5:1 H2O2:BLG at 40° C. at pH 8.0 resulted in a 93% consumption of added H2O2 resulting in an 81% reduction in free thiols. The oxidation significantly reduced unpleasant odour after UHT simulation to a score of 4 which was found to be similar to the level of a non-heated 6% WPI-A sample. After the UHT simulation, sample WPI-A4 furthermore has a H2S electrode potential of only 9 mV which confirmed a significant reduction of the development of H2S and hence of unpleasant odour. Unpleasant odour was not measured or evaluated for samples treated at 10-25° C. (sample WPI-A2 and WPI-A3, respectively). However, based on the consumption of H2O2 and accompanying decrease in residual free thiols, the inventors found that the use of higher temperatures was preferred to obtain more efficient thiol elimination and thereby reduction in H2S after UHT treatment.

The same pattern was observed for WPI-B samples exposed to oxidizing agent at 10 to 60° C. with 8:1 H2O2:BLG molar ratio (Samples WPI-B2 to WPI-B6, respectively). The non-oxidized sample produced a strong, unpleasant odour similar to the odour of rotten eggs (sensory score of 9) as also demonstrated by the high electrode potential of 214 mV found to be equivalent to a concentration of 10.4 μM. When the incubation temperature was gradually increased from 10 to 60° C. (WPI-B2 to WPI-B6, see Table 3), the perceived unpleasant odour decreased to a score of 4 and was found to be comparable to non-heated 6% WPI-B in samples WPI-B4 to WPI-B5. Equally, these samples had low levels of measured H2S. Similar to the samples based on WPI-A, a relation between consumed H2O2, residual thiols and unpleasant odour from subsequent UHT treatment was also observed from the samples based on WPI-B.

Adding to the requirement to use elevated temperatures, the inventors were surprised to find that efficient oxidation such as those observed in sample WPI-B4 to WPI-B6 also led to the aggregation of the proteins as shown by the increase in weight-averaged molecular weight (Mw) from 75 to 5590 kDa (corresponding to the Mw about from about 4 to about 300 BLG molecules) with increasing temperature from 40-60° C., see Table 3. The high molecular weight of protein in sample WPI-B6 was visually detectable through a slight haze and viscous behaviour during inversion of the sample.

The inventors further observed that no or little aggregation was apparent in samples WPI-B2 (29.3 kDa) and WPI-B3 (44.1 kda) treated at lower temperatures which clearly support the need for a certain level of protein unfolding to allow the oxidation process to proceed. Once sufficient unfolding is accomplished (such as WPI-A4 and WPI-B4), the oxidation may proceed with minimal aggregation whereas increased unfolding lead to increased or excessive aggregation (e.g. WPI-B5 and WPI-B6).

The inventors have here demonstrated that unpleasant odour can be reduced and eliminated by oxidation of WPI preparations across a wide range of whey protein isolate compositions with BLG contents ranging from about 100% to about 50% relative to total protein exemplified by sample WPI-A4, WPI-B4 to WPI-B6, respectively, see Table 3.

TABLE 3
Influence of temperature on free thiol oxidation during treatment with
H2O2 and generation of unpleasant odour during and after UHT treatment.

| | | | Residual | Residual | | Perceived | | |
|---|---|---|---|---|---|---|---|---|
| | | H2O2:BLG | free SH, | H2O2 | H2S | unpleasant | | |
| Experiment | | molar | micromol/g | (% of | microsensor, | odour | Mw, | |
| no.: | Temperature | ratio | protein | added) | mV/μM | Scale 0-15 | kDa | Visual |
| WPI- | — | — | 54 | — | 92 mV/n.d. | 10 | n.d. | Clear |
| A1 | | | | | | | | |
| WPI- | 10° C. | 5:1 | 32 | 40% | n.d. | n.d. | n.d. | Clear |
| A2 | | | | | | | | |
| WPI- | 25° C. | 5:1 | 22 | 21% | n.d. | n.d. | n.d. | Clear |
| A3 | | | | | | | | |
| WPI- | 40° C. | 5:1 | 10 | 7% | 9 mV/n.d. | 4 | n.d. | Clear |
| A4 | | | | | | | | |
| WPI- | — | — | 21.5 | — | 214/10.4 | 9 | 27.4 | Clear |
| B1 | | | | | | | | |
| WPI- | 10° C. | 8:1 | 13 | 59% | n.d. | n.d. | 29.3 | Clear |
| B2 | | | | | | | | |
| WPI- | 25° C. | 8:1 | 8.3 | 39% | 90.9/5.0 | 4 | 44.1 | Clear |
| B3 | | | | | | | | |
| WPI- | 40° C. | 8:1 | 1.1 | 25% | 27.4/1.1 | 4 | 75.0 | Clear |
| B4 | | | | | | | | |
| WPI- | 50° C. | 8:1 | 1.6 | 13% | 20.2/0.8 | 4 | 832 | Clear |
| B5 | | | | | | | | |
| WPI- | 60° C. | 8:1 | 0.4 | 14% | n.d. | n.d. | 5591 | Slight |
| B6 | | | | | | | | haze, |
| | | | | | | | | viscous |

### Conclusions:

The inventors have found that UHT treatment of samples previously subjected to oxidation under conditions allowing a significant reduction in free thiols show a reduced level of unpleasant odour similar to the odour of rotten eggs.

A significantly reduced level of unpleasant odour was perceived in samples characterized by a free thiol content of 10 micromol SH/g protein in the 6% whey protein beverage compositions and levels of unpleasant odour of less than or equal to 5.0 microM H2S was perceived as significantly reduced relative to the non-oxidized reference by sensory testing and unpleasant odour levels below 2 microM H2S were hardly perceived or not perceived at all by sensory testing.

The inventors have demonstrated that oxidation of free thiol in whey protein and particularly in BLG, which is the primary source of free thiol groups in whey protein, can be reduced under controlled conditions.

The inventors have furthermore found that the combination of a specific pH range and temperature range is beneficial for efficient oxidation of the free thiols of whey protein.

### Example 2a: Investigating the Impact of the Used Level of Oxidant

In the experiments described in these examples, the inventors investigated the impact of the used amount oxidant at an incubation temperature of 40 degrees C. and a duration of the incubation period of 20 hours.

### Method:

An 8.6% WPI solution pH 8.0 (20° C.) comprising 43.2 g/L BLG (about 2.35 mM) was prepared from WPI-B as outlined in Example 1, except that the administered H2O2 was varied from 0:1 to 178:1 molar ratio (H2O2:BLG) by addition of 30% H2O2 followed by mixing. All the solutions were incubated for 20 hours at 40° C.

After incubation, residual H2O2 was measured according to Analysis H.

For further analysis and to avoid excessive oxidation in subsequent processing steps, catalase (3.65 mL Catazyme 25 L per 150 L liquid whey protein product) was added to the sample to eliminate residual H2O2. Residual free thiols were measured according to Analysis E

The loss of individual amino acids by the oxidation was measured and the presence of amino acids in the oxidized whey protein samples was evaluated according to Analyses F1 and F2. The development of H2S-related odour was evaluated after thermal treatment as described in Example 1 (using the aluminium block of 160 degrees C. for 160 seconds). All the samples were stored at room temperature for 24 h before H2S analysis.

The level of non-native crosslinking arising from the conversion of cysteine to dehydroalanine via beta-elimination and further reaction with lysine or cysteine residues was evaluated by Analysis I after UHT treatment of the oxidized sample ad decapping of the vials using the electronic crimper equipped with decapper jaws (Thermo Scientific CRMA60180-ECRH11KI). The perception of unpleasant odour was evaluated as described in example 1.

### Results

As seen in Table 4, the inventors found that the amount of residual H2O2 increases with increasing dosage and that the fraction of residual peroxide relative to the amount initially added increases steeply above a 10:1 stoichiometry (sample WPI-B16) with as much as 29-49% of the H2O2 added initially remaining after incubation for 20 hours at a constant temperature 40° C. and molar ratios of 17:1 to 178:1 (Sample WPI-B18 to WPI-B21).

It was further found that free thiols were essentially depleted via the oxidation step as evidenced by approx. 2.2 micromol SH/g protein or less at H2O2:BLG molar ratios of 8:1 (sample WPI-B15) and above (samples WPI-B16 to WPI-B21) suggesting efficient elimination of residues responsible for the development of unpleasant odour similar to the odour of rotten eggs.

However, the inventors found that even a reduction to 7.5 micromol SH/g protein, which was found to lead to 1.35 microM H2S in sample WPI-B12 after simulated UHT treatment, was perceived to be similar to the 6% non-heated, non-oxidized WPI-B reference with a score of 4 on a scale from 0-15. The non-oxidized 6% WPI-B9 sample producing high levels of H2S was ranked with a score of 9.

Remarkably, samples WPI-B12 to WPI-B21 demonstrate that a content of free thiol groups of at most 10 micromol/g protein led to at most about 5 microM H2S after simulated UHT, which led to a level of unpleasant odour which was significantly reduced relative to the heat-treated references WPI-B9, but at a level similar to the 6% non-heated, non-oxidized WPI-B reference.

TABLE 4
Determining the minimum sufficient amount of oxidant during
incubation at a constant low temperature of 40 degrees C.

| | | | | | Free | | | |
|---|---|---|---|---|---|---|---|---|
| | | | Residual | | thiol, | | | |
| | | | H2O2, | | μmol/g | | H2S | Percieved |
| | | | mM | | protein | | microsensor, | unpleasant |
| Sample | H2O2:BLG | Temperature | (%) | | (%) | | μM | odour |
| WPI- | 0:1 | 40 | — | | 21.6 | (100%) | 10.03 | 9 |
| B9 | | | | | | | | |
| WPI- | 1.7:1 | 40 | 0.04 | (1%) | n.d. | | 5.4 | n.d. |
| B10 | | | | | | | | |
| WPI- | 3.5:1 | 40 | 0.3 | (3%) | n.d. | | 4.6 | n.d. |
| B11 | | | | | | | | |
| WPI- | 5:1 | 40 | n.d. | | 7.5 | (35%) | 1.35 | <5 |
| B12 | | | | | | | | |
| WPI- | 6:1 | 40 | n.d. | | 5.5 | (25%) | 0.64 | <5 |
| B13 | | | | | | | | |
| WPI- | 7:1 | 40 | n.d. | | 3.8 | (17%) | 0.35 | <5 |
| B14 | | | | | | | | |
| WPI- | 8:1 | 40 | 2.6 | (14%) | 2.2 | (10%) | 0.19 | <5 |
| B15 | | | | | | | | |
| WPI- | 10:1 | 40 | 4 | (16%) | 0.5 | (2.3%) | 0.09 | n.d. |

| B16 | | | | | | | |
|---|---|---|---|---|---|---|---|
| WPI- | 12:1 | 40 | n.d. | | <LOD | <LOD | n.d. |
| B17 | | | | | | | |
| WPI- | 17:1 | 40 | 12 | (29%) | <LOD | <LOD | <5 |
| B18 | | | | | | | |
| WPI- | 36:1 | 40 | 30 | (36%) | <LOD | <LOD | n.d. |
| B19 | | | | | | | |
| WPI- | 89:1 | 40 | 91 | (44%) | <LOD | <LOD | n.d. |
| B20 | | | | | | | |
| WPI- | 178:1 | 40 | 202 | (49%) | <LOD | <LOD | n.d. |
| B21 | | | | | | | |

<LOD = below level of detection;
n.d. = not determined

### Conclusion:

The inventors have found that a certain level of oxidation is required for sufficient elimination of free thiols to obtain a noticeable reduction in the development and perception of unpleasant odour similar to the odour of rotten eggs during and after UHT treatment of whey protein beverages. The inventors found that a reduced level of unpleasant odour evaluated both analytically and as perceived odour was consistently linked with residual free thiol contents of about 10 micromol SH/g protein or less resulting in about 5 μM H2S or less.

### Example 2b: Investigating Oxidative Damage

The inventors have observed that whey protein oxidation processes for beverage production in the prior art (see US2016/0235082 A1) gave rise to beverages of poor visual qualities, particularly to the development of turbidity and/or yellow colour.

The inventors speculated that these undesired features arise as a consequence of harsh heat treatments such as UHT in the presence of high concentrations of oxidant.

### Method:

A 13.5% w/w WPI solution was prepared by mixing WPI-B powder with MilliQ water, the pH was adjusted to 6.5 using 5% HCl, followed by a dilution in MQ water to reach a final protein concentration of 13% w/w. A BLG content of 65 g/L (approx. 3.54 mM) was measured according to Analysis L. Aliqouts of the 13% WPI-B PH 6.5 samples were kept for reference purposes. 30% hydrogen peroxide (H2O2) was mixed into the WPI solution in varying amounts corresponding to molar ratios of 0:1-174:1 H2O2:BLG (see table 5).

1.0 mL aliqouts of 13% WPI samples were subjected to UHT simulation as described in Example 1 (using an aluminium block at 160 degrees C. for 160 seconds). After cooling, the vials were visually inspected, decapped and the residual, non-reacted H2O2 was determined using Analysis H. Residual thiol was measured using Analysis E. The loss of individual amino acids in the process was determined and the presence of amino acid oxidation products was evaluated according to Analysis F1 and F2, respectively. The level of non-native lanthionine crosslinking arising from the conversion of cysteine to dehydroalanine via beta-elimination and further reaction with cysteine residues was evaluated according to Analysis I after UHT treatment of the oxidized sample.

### Results:

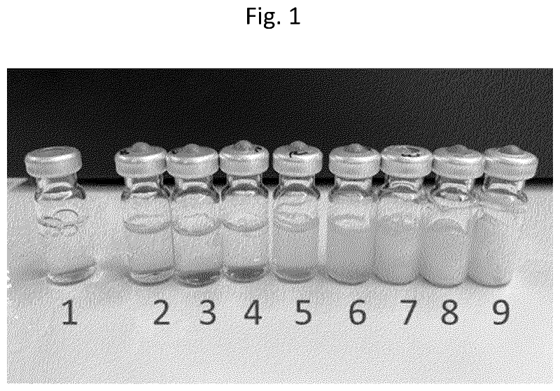

The results of the experiments are summarized in Table 5, and a photograph of the samples WPI-B22 to WPI-B30 is furthermore shown in FIG. 1.

The inventors observed the development of opaqueness in most samples and furthermore noticed the development of yellow colour in samples subjected to UHT treatment with high levels of H2O2, in particular samples WPI-B26, WPI-B27, WPI-B29 and WPI-B30. This indicated that the excessive H2O2 dosages in combination with UHT treatment lead to undesired and excessive amino acid oxidation resulting e.g. in such colour changes.

Additionally, the inventors found that the presence of 85:1 H2O2:BLG during UHT treatment of 13% WPI-B (WPI-B29) caused a significant and undesired loss of tryptophan residues and further to the development of oxidation products from both tyrosine and tryptophan residues, see Table 7. The inventors have seen indications that the yellow colour is caused by the detected tryptophan oxidation products dioxindolylalanine (DiOia) and kynurenine (kyn).

Furthermore, oxidation of tyrosine to oxidized tyrosine (o-Tyr) and di-tyrosine (Di-Tyr) are considered indicators of excessive oxidation.

In contrast to sample WPI-B29, Table 7 shows no significant change in tyrosine or tryptophan residues for WPI-B15 (example 2A) after the more gentle oxidation step at 40° C. with 8:1 molar ratio (H2O2:BLG) and subsequent dismutation of excess oxidant by catalase. No oxidation products of tyrosine (e.g. di-tyr and o-tyr) or tryptophan (e.g. kynurenine and DiOia-2) was observed in sample WPI-B22 (Non-processed WPI-B) or WPI-B9 (no H2O2 added).

WPI-B15 further showed significantly lower levels of lanthionine after UHT treatment compared to both WPI-B9 (non-oxidized) and WPI-B29 (UHT in presence of H2O2). The values were surprisingly close to the level of non-modified, non-heated WPI-B (Table 7). This clearly suggests that the oxidation process reduces the formation of the protein degradation products otherwise leading to the formation of non-natural lanthionine crosslinks.

Interestingly, sample WPI-B20 (40° C./20 hr, 89:1) did not show degradation of tyrosine and tryptophan which is most likely a consequence of the addition of catalase before the UHT treatment, clearly indicating that high levels of H2O2 at high temperatures are not desired. However, an undesired formation of kynurenine, a tryptophan degradation product, was detected and highlights the need for controlled H2O2 dosages.

TABLE 5
UHT treatment (160 C./160 seconds) of samples
in the presence of hydrogen peroxide.

| | | Residual H2O2 | | |
|---|---|---|---|---|
| Sample | H2O2:BLG | after UHT, mM | Liquid/gel | Comments |
| WPI-B22 | Non- | n.d. | Liquid | Clear |
| | heated 0:1 | | | |
| WPI-B23 | 0:1 | n.d. | Gelled | White |
| WPI-B24 | 1.7:1 | n.d. | Gelled | White |
| WPI-B25 | 3.3:1 | n.d. | Gelled | White |
| WPI-B26 | 8:1 | n.d. | Gelled | Turbid/white |
| WPI-B27 | 17:1 | 12 (19%) | Viscous liquid | Turbid |
| | | | gelling in 24 hr | |
| WPI-B28 | 34:1 | 29 (23%) | Liquid | |
| WPI-B29 | 85:1 | 101 (32%) | Liquid | Yellow |
| | | | | appearance |
| WPI-B30 | 174:1 | 188 (30%) | Liquid | Yellow |
| | | | | appearance |

TABLE 6
Overview of exemplary WPI samples from the present
examples with/without oxidation step and UHT treatment.

| Raw | WPI-B22 | WPI-B9 | | | |
|---|---|---|---|---|---|
| material | (ref.) | ref. | WPI-B15 | WPI-B20 | WPI-B29 |
| pH | 6.7 | 8.0 | 8.0 | 8.0 | 6.5 |
| Protein-% | 8.6 | 8.4 | 8.4 | 8.4 | 13 |
| Oxidation | None | 20 hr | 20 hr | 20 hr | None |
| step | | incubation | incubation | incubation | |
| | | without | at 40 C. | at 40 C. | |
| | | added | with 8:1 | with 89:1 | |
| | | H2O2 | H2O2: | H2O2: | |
| | | | BLG | BLG | |
| Post- | none | Catalase | Catalase | Catalase | None |
| treatment | | | | | |
| Final | 8.0% | 8.0% | 8.0% | — | 13% |
| protein | | | | | |
| Final | 7.0 | 7.0 | 7.0 | — | 6.5 |
| beverage | | | | | |
| pH | | | | | |
| UHT | none | 160° C./ | 160° C./ | — | 160° C./ |
| treatment | | 160 sec | 160 sec | | 160 sec in |
| | | | | | presence |
| | | | | | of 85:1 |
| | | | | | H2O2:BLG |

TABLE 7
Characteristics of WPI samples after oxidation process. LLOQ = lowest
level of quantification. The no statistically significant difference in the Tyr
contents of the samples were found but WPI-B29 has a significantly higher
level of Tyr degradation products than the other oxidized WPI samples.

| | | | | | LLOQ |
|---|---|---|---|---|---|
| Sample code: | WPI-B22 | WPI-B9 | WPI-B15 | WPI-B29 | μg/mL |
| Met % | 2.12 ± 0.21 | 2.01 ± 0.17 | 0.36 ± 0.03 | 0.45 ± 0.02 | 0.15 |
| Tyr % | 2.72 ± 0.28 | 2.73 ± 0.26 | 2.79 ± 0.14 | 2.83 ± 0.11 | 0.18 |
| Trp % | 1.85 ± 0.21 | 1.86 ± 0.18 | 1.86 ± 0.11 | 0.65 ± 0.03 | 0.20 |
| Lanthionine, | 1.2 ± 0.1 | 16.09 ± 0.9 | 5.7 ± 0.5 | 18.2 ± 1.0 | 0.001 |
| μg/mL | | | | | |
| o-Tyr, | <LOD* | <LOD* | <LOD* | 3.1 ± 0.6 | 0.0352 |
| μg/ml | | | | | |
| DiTyr, | <LOD* | <LOD* | <LOD* | 4.7 ± 0.3 | 0.0351 |
| μg/ml | | | | | |
| DiOia | <LOD* | <LOD* | <LOD* | 37.2 ± 1.2 | 0.1082 |
| (dioxindolyl- | | | | | |
| alanine), | | | | | |
| μg/ml | | | | | |
| Kynurenine, | <LOD* | <LOD* | <LOD* | 27.9 ± 6.3 | 0.0693 |
| μg/ml | | | | | |

*Less than LLOQ and not detected by manual inspection of chromatograms, i.e. not detectable.

### Conclusion:

The inventors have observed that processing which involves direct UHT treatment of WPI-solutions in the presence of H2O2 at high levels followed by bottling leads to undesired oxidation of amino acids such as tryptophan and gives rise to the formation of degradation products such as kynurenine and DiOia. Additionally, the inventors observed the formation of either opaqueness or yellow colour in such solutions and have seen indications that the colour formation may be associated with the formation of amino acid degradation products.

In contrast and as documented in Example 2A, careful selection of right pH and temperature ranges to allow exposure and selective oxidation of the free thiol in BLG makes it feasible to produce modified whey protein compositions, and beverage products containing them, having a reduced content of free thiol groups with much lower levels of oxidative damage.

### Example 3: Impact of the pH in Enabling Thiol Oxidation

In this experiment, the inventors investigated the impact of pH in enabling the oxidation of the free thiols of whey protein.

### Materials and Methods:

Aqueous samples of dissolved WPI-B (containing sufficient WPI-B powder to provide a protein content of 8.4% w/w) was prepared by mixing powder with demineralized water as described in Example 1. The pH of the samples was adjusted to pH 6.5, 7.0, 7.5, 8.0 and 8.5, respectively, using 10% HCl or 3M NaOH, respectively. The pH adjusted WPI-B samples were incubated for 20 hr at 40 to 55 degrees C. after addition of H2O2 to 8:1 H2O2:BLG molar ratio unless otherwise stated (see table 8). After incubation, residual H2O2 was measured using Analysis H.

Catalase (3.65 mL Catazyme 25 L per 150 L liquid product) was added and allowed to remove residual H2O2.

The samples were analyzed by Gel Permeation Chromatography (GPC) according to Analysis G to estimate the average molecular weight and the intrinsic viscosity of the resulting product. Residual free thiols were measured according to Analysis E.

Sub-samples were subjected to the UHT-like heat treatment described in Example 1 (using an aluminium block with a temperature of 160 degrees C. for 160 seconds) and the content of H2S was determined according to Analysis D.

The perceived unpleasant odour was evaluated as described in example 1.

### Results:

Table 8 demonstrates the need for specific temperature/pH combinations to enable the oxidation of free thiols.

Non-treated WPI-B31 and WPI-B32 which were incubated at 40 degrees C. at pH 8.0 in the absence of added H2O2 showed high levels of free SH at 21.6 and 21.5 μmol SH/g protein to high levels of unpleasant odour after UHT treatment as shown for WPI-B31.

However, the inventors found that increasing the temperature gradually increased the consumption of H2O2 and consequently free thiols were reduced and reached 2.2 μmol SH/g protein at pH 8.0. The H2S levels generated during UHT treatments decreased accordingly.

While the reaction requires a pH of about 8.0 at 40° C., the inventors furthermore discovered that the reaction can proceed at pH values lower than 8.0 if the temperature is increased at the same time to facilitate the partial unfolding of the proteins, meaning that specific pH levels require specific temperatures.

Indeed, efficient elimination unpleasant odour at pH 7.0 was found to require an incubation temperature of at least about 50° C. as shown by sample WPI-B38 and a temperature of at least about 55° C. was required at pH 6.5.

As evidenced by sample WPI-B35 to WPI-B39, the inventors further note that a consequence of efficient oxidation and elimination of unpleasant odour is an increase in the weight-average molecular weight of the modified WPI product from 51 (WPI-B35) to 1142 kDa (WPI-B39) compared to 22.4 kDa for the non-treated WPI-B raw material.

The inventors further noted that although measured levels of unpleasant odour resulting from UHT treatment of samples characterized by free thiol contents at or below 7.4 micromol SH/g protein were found to be above the determined sensory threshold of 1-2 microM H2S, the unpleasant odour of WPI-B35 had already the day after (24 hours at ambient temperature) decreased to levels at which it was found comparable the non-heated, non-oxidized 6% WPI-B sample. No unpleasant odour was detected in samples WPI-B36 to WPI-B39.

TABLE 8
Impact of pH on the accessibility of free thiols, consumption of
H2O2 and resulting off-flavour development after UHT treatment.

| | | | Intrinsic | SH | Residual | | Perceived |
|---|---|---|---|---|---|---|---|
| Sample | Oxidation | Mw, | viscosity | μmol/g | H2O2 | H2S after UHT | unpleasant odour |
| ID | conditions | kDa | mL/g | protein | [%]/[mM] | mV/μM | after 24 hr RT |
| WPI- | No | 22.4 | 5.6 | 21.6 | | 213.6 ± 18.1/ | 9 |
| B31 | H2O2 | | | | | 10.4 ± 0.9 | |
| WPI- | 40° C. | n.d. | n.d. | 21.5 | n.d. | n.d. | n.d |
| B32 | pH 8.0 | | | | | | |
| | No | | | | | | |
| | H2O2 | | | | | | |
| WPI- | 40° C. | 33 | 6.4 | 16.5 | 31%/ | n.d. | n.d |
| B34 | pH 7.0 | | | | 6.8 mM | | |
| WPI- | 40° C. | 51 | 6.6 | 7.4 | 30%/ | 54.2 ± 15.4/ | <5 |
| B35 | pH 7.5 | | | | 5.6 mM | 2.5 ± 0.8 | |
| WPI- | 40° C. | 72 | 6.8 | 2.2 | 25%/ | 27.4 ± 4.4/ | <5 |
| B36 | pH 8.0 | | | | 3.6 mM | 1.2 ± 0.14 | |
| WPI- | 40° C. | 297 | 7.7 | 1.5 | 18%/ | 34/ | <5 |
| B37 | pH 8.5 | | | | 3.4 mM | 1.5 ± 0.30 | |
| WPI- | 50° C. | 160 | 7.6 | 2.6 | 13%/ | 22.8/ | <5 |
| B38 | pH 7.0 | | | | 4.1 mM | 0.9 μM | |
| WPI- | 55° C. | 1142 | 9.4 | 1.5 | 40% | 17.4/ | <5 |
| B39 | pH 6.5 | | | | 7.51 mM | 0.7 μM | |

### Conclusion:

The inventors observed that an increased pH gave rise to an increased reduction of the free thiols of the whey protein. From Table 8, it is furthermore evident that the reduction in the “SH-groups per g protein” per amount of consumed H2O2 increases dramatically going from pH 6.5 to pH 7.0, and again from pH 7.0 to pH 7.5. Without being bound by theory, the inventors speculate that the increased pH loosen up the molecular structure of BLG and thereby eases the access of the oxidant to the free thiol of BLG and therefore increases the specificity of the oxidation reaction.

The method of the invention may also be implemented at pH 6.5 but will require longer incubation time, preferably a higher temperature (e.g. 50 degrees C.) to speed up the process by the partial unfolding of the protein that allows easier access of the oxidant to the free thiol. The inventors have furthermore observed a tendency to increased average molecular weight when the temperature during heat-treatment increases. For the production of powders of oxidized whey protein, the inventors have found that it is advantageous to keep the aggregate size as low as possible as it makes it possible to process liquid streams of higher protein concentration without problems with increased viscosity.

### Example 4: Production of a pH-Neutral, UHT-Treated Whey Protein Beverage for Sports Nutrition

In this example the inventors demonstrated the feasibility of scaling up the process to pilot scale for making ready-to-drink beverage products comprising oxidized whey protein isolate with surprisingly low levels of unpleasant odour after UHT treatment at neutral pH.

### Materials and Methods:

Ready-to-drink beverages with low level of unpleasant odour after UHT treatment at neutral pH were produced at pilot plant using WPI-B or WPI-C types of powder as raw material. Powder composition of WPI-B is shown in Example 1 and WPI-C in table 9.

TABLE 9
Composition of exemplary whey protein isolates
(BLG = beta-lactoglobulin; SH = thiol; ALA= alpha-
lactalbumin; CMP= caseinomacropeptide; TS = total solids)

| Component | WPI-C |
|---|---|
| Protein/TS | 94 |
| Native BLG relative to total protein | 59 |
| Native ALA relative to total protein % | 10 |
| CMP relative to total protein % | 15 |
| Free SH in micromol/gram protein | 31 |
| Na, % of TS | 0.5 |
| K, % of TS | 1.2 |
| Mg, % of TS | 0.008 |
| Ca, % of TS | 0.051 |
| pH of 6% solution | 6.8 |
| Lactose | ≤0.1 |
| Fat % | ≤0.1 |

For the pilot processing, a 12 kg solution with 6% w/w protein (WPI-B or WPI-C) was prepared, followed by 30 min rehydration. The pH was adjusted to 8.0 at 20° C., using 10% NaOH. This is followed by transferring the solution to a Scanima mixer (SPM-100V, Scanima A/S, Denmark), where the temperature of the solution was increased to 40° C. with gentle mixing. Thereafter, 35% H2O2 was added to the solution to obtain a 8:1 molar ratio between H2O2 and BLG of WPI-B or WPI-C. The solution was kept at 40° C. for 18 h and catalase was added at the end of the 18 hour incubation to remove access H2O2 as described in example 1. The solutions were left at room temperature for 60 min, and pH adjusted to 7.0 using 1M HCl before UHT. UHT thermal treatment was done using an plate heat exchanger (PHE), (HT320-20, OMVE, Netherlands) operated with service water flow of 80 L/h, product flow of 20 L/h, preheating to 70° C. followed by heating at 143° C. for 4 seconds. The heat-treated beverage was cooled to 10° C. at the outlet and tapped into 100 ml sterile plastic bottles and immediately sealed for further analysis. Moreover, samples for H2S level analysis were filled at the outlet of the UHT, where 1 ml of sample was filled into 2 ml glass vial and immediately crimp-sealed with lids (triplicates for each sample) as described in example 1.

Several analyses were carried out to evaluate the beverage. Residual free thiols were measured according to analysis E for sample after oxidation for 18 h. The H2S level of beverage was analysed (Analysis D), within 2 h after production. All samples were stored at room temperature before H2S measurement. Turbidity was analyzed by analysis Q.

A sensory evaluation was carried out at the same day of beverage production and the 100 ml plastic bottles were stored at room temperature before opening. The bottles were opened and directly evaluated by 3 to 5 persons, two bottles for each person. A scale of 0 to 15 was used.

### Results:

The results clearly show that oxidation of WPI-B or WPI-C at 8:1 molar ratio of H2O2 and BLG significantly reduced the amount of free thiols compared to non-treated samples as illustrated in Table 10. Moreover, both WPI-B37 and WPI-C1, with no H2O2 addition, the UHT treatment leads to a high level of H2S in the beverage. However, with the addition of H2O2 (sample WPI-B38 and WPI-C2), the unpleasant odour reached the level below the identified sensory threshold after 24 h storage at room temperature.

The low turbidity observed for the 6% WPI-B beverage and low levels of unpleasant odour clearly suggest the use of the pre-treated WPI products for palatable, clear whey protein beverages.

TABLE 10
Preparation of transparent UHT-treated whey protein
isolate beverages from whey protein isolates treated with
hydrogen peroxide reveal significant reduction in free
thiols and development of H2S upon UHT treatment.

| | | Free | H2S | Perceived | |
|---|---|---|---|---|---|
| Protein | | thiol in | electrode | unpleasant | Turbidity, |
| source | H2O2:BLG | μmol/g | μM) | odour | NTU |
| WPI-B37 | 0:1 | 26.9 | 10.6 | 9 | 18 |
| WPI-B38 | 8:1 | 3.9 | 0.8 | <5 | 13 |
| WPI-C1 | 0:1 | 30.9 | 11.7 | 9 | 21 |
| WPI-C2 | 8:1 | 4.4 | 0.3 | <5 | 14 |

### Conclusions

The inventors have demonstrated successful use of the oxidation process in pilot scale to produce transparent pH-neutral, UHT-treated whey protein beverages without the perceived unpleasant odour similar to the odour of rotten eggs. Such beverages are considered particularly appealing for sports nutrition.

### Example 5: Production of a pH-Neutral UHT-Treated Whey Protein Powder for Sports Nutrition

In this example the inventors demonstrated the feasibility of using the conditions described in example 4 for making a powder product process comprising concentration and spray drying to produce a modified whey protein isolate that generates surprisingly low levels of unpleasant odour after rehydration and UHT treatment at neutral pH.

It is particularly advantageous to remove water:
When such product is to be transported over long distances (avoid transport of water)
To reduce risk of microbial growth during storage

### Materials and Methods:

A 150 kg solution of WPI-C(with characteristics described in example 4, table 9) at 10.3% or 7.9% protein was prepared by hydration of WPI-C in water for 30 minutes. The pH of the solution was adjusted to 8 (20° C.) before the solution was heated to 40° C. In the heated solution the pH was adjusted to pH 7.7 (measured at 40° C.) before the addition of H2O2 using a molar H2O2:BLG stoichiometry of 7.5:1 or 13:1.

After 20 hours incubation at 40° C., 96U catalase (SigmaC9322) was added per g protein to inactivate residual H2O2. The oxidized WPI was then concentrated to 12% protein on a pilot scale MMS NF/RO unit equipped with 2 pcs Koch HFK328 (3838/31) membranes and operated in UF mode at 10° C. with average 0.9 Bar differential pressure. The UF retentate was then dried on a SPX Anhydro pilot scale spray dryer (185° C. inlet/85° C. outlet temperature).

The produced oxidized WPI powders were mixed with demineralized water to provide a whey protein beverage comprising 5.9% protein (WPI-C4 and WPI-C5). The pH of the solution was adjusted to pH 7.0 (20° C.) using 3% HCl. The WPI-C4 solution was subjected to UHT on an OMVE HT320-20 equipped with PHE at 143° C. for 4 seconds as described in Example 4. A reference beverage was prepared the same way from the WPI-C powder (without any oxidative pre-treatment, WPI-C3).

The WPI-C5 solution was thermally treated by use of tubular heat exchanger (THE) using a UHT APV/SPX 5010026 system operated at 100 L/h and configured for two preheating steps at 80° C. and then at 100° C. followed by heating at 143° C. for 10 seconds (High temperature, short time (HTST)). The beverage composition was then cooled in three steps to 78° C., to 40° C. and then to 10° C. and tapped into 100 mL sterile bottles, then immediately sealed.

The UHT-treated beverages were analyzed for the content of free thiol groups by analysis E, H2S by Analysis D, turbidity by analysis Q, viscosity by analysis C and sensory by analysis K.

### Results:

The level of free thiols per gram protein in the WPI-C4 and WPI-C5 beverages was reduced to 2.0 and 0.3 micromol/g protein, respectively. As seen in Table 11 the oxidation of thiols in WPI-C4 and WPI-C5 gave rise to UHT-treated beverages with comparable viscosity, slightly lower turbidity and importantly a significantly reduced H2S level when compared to WPI-C3 (the non-oxidized reference). By the sensory panel, oxidized WPI-C5 beverage gave a reduced sulfu-ric/rotten smell as compared to the reference beverage (WPI-C3), shown in Table 12. The attributes were rated from a score of 0 (low intensity) to 15 (high intensity) (Analysis K). The sensory score of WPI-C5 beverage approach those of a non-heated whey protein solution, having a score of 1.7.

TABLE 11
Characteristics of the WPI-C4 and WPI-C5 beverages
compared to the non-oxidized reference WPI-C3 beverage.

| | H2O2:BLG | SH in | H2S, | Turbidity, NTU | Viscosity, |
|---|---|---|---|---|---|
| Beverage | mol:mol | μmol/g | microM | after UHT | CP |
| WPI-C3 | 0:1 | 31 | 207 | 16.4 | 2.2 |
| WPI-C4 | 7.5:1 | 2.0 | 4 | 10.0 | 2.5 |
| WPI-C5 | 13:1 | 0.3 | 4.8 | 10.4 | n.d. |

TABLE 12
Sensory analysis (Analysis K) of beverages WPI-C3
and WPI-C5. Different letters (groups) of the attributes
indicates that the samples were significantly different.

| | Unpleasant odour similar to |
|---|---|
| Beverage | the odour of rotten eggs |
| WPI-C3 | 9.3 ª |
| WPI-C5 | 4.1 ^{b} |

### Conclusion:

It was demonstrated that it was possible to produce powdered, oxidized WPI-C4/C5 products by specific oxidation of free thiol groups, inactivation of excess oxidant, subsequent concentration by ultrafiltration, and spray drying. The provision of the oxidized WPI-C4/C5 in powder form improves the logistics and shelf life for the product. The produced oxidized WPI-C4/C5 powders were furthermore shown to have no intense perceived sulfuric/rotten smell in a UHT-treated beverage containing 6% WPI-C4/C5 protein that even approach the sensory scores of non-heated whey protein solutions.

The beverages have low viscosity and lower turbidity than a comparably UHT-treated reference beverage based on the non-oxidized WPI.

### Example 6: Benefit of Maintaining pH Constant During Oxidation

In previous investigations, the inventors noticed that the pH decreases during the oxidation process by as much as 0.5 pH units or more.

In this example the inventors demonstrate that it can be particularly advantageous to maintain the pH constant by use of pH-stat to allow shortening the required process time during the oxidation step.

### Part 1. The Potential of Improving Reaction Kinetics by Readjustment of pH During Oxidation.

### Materials and Methods:

A 150 kg solution of WPI-C(with characteristics described in Example 4, table 9) at 9% protein was hydrated, pH adjusted and heated as described in example 5, but with oxidation conducted at a 10:1 molar ratio of H2O2 to BLG. 20 minutes after addition of H2O2 two 100 ml samples were poured into beakers with lids and placed in a water bath at 40° C. with stirring. One of the two samples was left with pH unadjusted during oxidation (WPI-C8), the other had pH readjusted to pH 7.7 (measured at 40° C.) after 3 hours (WPI-C7). The remaining 150 kg solution was maintained at 40° C. with static pH at pH 7.7 by readjustment every 20 minutes for 5 hours after which pH was allowed to decrease as oxidation was continued for totally 22 hours (WPI-C6). At timepoints 3 hours (3 h), 5 hours (5 h), and 7 hours (7 h) after H2O2 addition samples were taken from each beaker as well as from the large volume kept at static pH. Residual H2O2 was measured in the samples according to analysis H before 5U catalase per ml was added to dismutate residual H2O2. All samples were then analyzed for free thiols according to Analysis E.

### Results:

It was observed that static pH at pH 7.7 during oxidation significantly improved the reaction kinetics and made it possible to reach a content of free thiols of 2.0 micromol/g protein after only 7 hours, whereas neither WPI-C7 nor WPI-C8 reached that level in 24 hours. The single readjustment of pH after 3 hours oxidation in WPI-C7 also improved the kinetics. These results underscore the impact of pH in facilitating the thiol oxidation.

| | | | WPI-C7 | |
|---|---|---|---|---|
| | | WPI-C6 | pH | WPI-C8 |
| | | Static | readjusted at | pH |
| | | pH | 3 hours | unadjusted |
| Free thiol, | Before H2O2 | 29.0 | 29.0 | 29.0 |
| μmol/g | 3 hours | 7.6 | 14.0 | 14.2 |
| protein | 5 hours | 3.4 | 8.7 | 10.7 |
| | 7 hours | 2.0 | 6.0 | 8.3 |
| | 24 hours | 0.5 | 2.6 | 3.3 |
| residual | Added, 0 h | 28.8 | 28.8 | 28.8 |
| H2O2, | 3 hours | 14.6 | 17.3 | 18.3 |
| mM | 5 hours | 8.3 | 11.4 | 12.5 |
| | 7 hours | 5.8 | 9.4 | 10.0 |
| | 24 hours | 0.8 | 2.7 | 3.3 |

### Part 2. The Influence of H2O2 to BLG Ratio During Oxidation at Static pH.

### Materials and Methods:

A 10% protein solution of WPI-C was made and the pH was adjusted to pH 8.0 (20 degrees C.) and 400 g of the solution was distributed into each of four reactors of the BioXplorer 400 (HEL) equipment fitted with temperature control, mechanical stirrers, pH sensors and liquid dosing system for base addition (7% NaOH) and controle via the WinBio software control system. The system was programmed to heat the solutions to 40° C. before adjusting pH to pH 7.7 and keeping pH constant at pH 7.7 and at 40° C. for 14 hours by addition of a 7% NaOH solution. H2O2 was manually added into reactors according to below scheme when pH and temperature were stable. During the oxidation 6 ml samples were taken with 1-1.5 hours intervals. Residual H2O2 was measured in the samples according to analysis H and the remaining was added 10U catalase per ml sample. The samples were adjusted to pH 7 (20° C.) and diluted to 6% protein. All samples were analysed for free thiols according to analysis E. 1 ml of each sample was subjected to the UHT-like heat-treatment described in Example 1 (using the aluminum block having a temperature of 160 degrees C. for 160 sec) and analyzed for H2S according to Analysis D. Viscosity was measured according to analysis C.

### Results:

TABLE 13
Summary of the results of Part 2. of Example 6. The content of free
thiol groups prior to the H2O2-treatment was 28.7 μmol/g protein.

| | | WPI-C9 | WPI-C10 |
|---|---|---|---|
| H2O2:BLG molar ratio | | 9:1 | 18:1 |
| Free thiols, micromol/g | 3 hours | 9.1 | 2.4 |
| protein | 5 hours | 3.5 | 0.5 |
| | 8 hours | 1.5 | 0.3 |
| | 12.5 hours | 0.4 | 0.3 |
| H2S · mV | 3 hours | 27.8 | 5.8 |
| | 5 hours | 8.6 | 1.1 |
| | 8 hours | 1.8 | 1.3 |
| | 12.5 hours | 0.5 | 1.1 |
| Viscosity (cP) | 14 hours | 2.5 | 2.4 |
| Residual H2O2. mM | Added. 0 h | 29.4 | 58.9 |
| | 5 hours | 5.2 | 13.3 |

It was observed that increasing the dose of added H2O2 decreases the time required for thiol oxidation and at 18:1 molar ratio dose the unpleasant odour can be eliminated within the first 5 hours if static pH is applied compared to approximately 8 hours required if a 9:1 molar ratio of H2O2:BLG is used.

### Conclusions:

The experiment demonstrated that maintaining pH at a favourable set-point allows for faster reaction kinetics (when compared to WPI-C7 and WPI-C8). This is likely a consequence of maintaining the state of partial unfolding dictated by temperature/pH combination.

The experiment furthermore demonstrated that use of higher dosages allows for shorter reaction time and that the process time can be pronouncedly reduced by the combined use of pH-stat and higher H2O2:BLG dosages. For example, the development of unpleasant odour from UHT treatment could be eliminated by an oxidative pretreatment at pH 8.0 (20 degree C.) for 3 hr with a H2O2:BLG-ratio of 18:1 or for 5 hr with a H2O2:BLG-ratio of 9:1.

### Example 7: Impact of the Fat Content of the Whey Protein Source

The experiment described in this example explored the impact of fat content on the development of undesired smells (in addition to the unpleasant odours mentioned above) from volatile organic compounds.

### Materials and Methods:

TABLE 14
Composition of WPC powder.

| | WPC |
|---|---|
| Protein/TS % | 81 |
| BLG/protein % | 34.8 |
| ALA/protein % | 5.3 |
| CMP/protein % | 12.4 |
| Na, % of TS | 0.14 |
| K, % of TS | 0.44 |
| Mg, % of TS | 0.06 |
| Ca, % of TS | 0.37 |
| pH of 6% solution | 6.5 |
| Lactose % | 7.5 |
| Fat % | 6.5 |

8% protein solutions were prepared from WPI-B and WPC, respectively, by hydration of the powder under gentle stirring at room temperature for 1 hour. The pH was adjusted to 8.0 (20° C.). Both samples were incubated at pH8.0 at 40° C. for 20 hr after the addition of 30% hydrogen peroxide to reach 8:1 molar stoichiometry.

The samples were subjected to UHT treatment as described in Example 1 and the content of H2S was determined according to Analysis D. Samples from several thermally treated vials were collected to allow transfer of 5 mL sample to 100 mL blue-cap flasks. 1.5 uL of a 100 ppm 2-hexanone-5-methyl internal standard solution was added to reach a final concentration of 30 ppb. The analysis of the samples for volatile organic compounds was performed according to Analysis J.

### Results:

The WPC and the WPI beverages that had been treated with 8:1 H2O2 at pH 8.0 and 40° C. for 20 hours were analysed for the content of volatile organic compounds using a Dynamic Headspace Gas Chromatographic method using Mass Spectrometry for identification. The analysis revealed a much larger presence of all detected organic compounds in the headspace of the WPC beverage. Aldehydes such as Hexanal, Heptanal, 2-4 Nonadienal (E,E), Nonanal and Benzaldehyde, in particular, were present in a much larger amount compared to the WPI. The aldehydes originate from the oxidation of lipids and since the WPC contains much more lipids than the WPI, the aldehydes are also generated at a larger rate from the WPC. To avoid the formation of aldehyde volatiles, it is preferable to use protein sources with as low amounts of fat as possible. In addition, the WPC also contained a greater amount of the ketone 2-butanone and the organic acids Acetic acid, Formic Acid and benzoic acid.

The combined effect of the increased presence of all volatile organic compounds in the headspace of the WPC beverage is a much stronger undesirable odour compared to the WPI, which was confirmed by a brief organoleptic evaluation that revealed a much more intense and complex odour for the WPC sample compared to the WPI, probably due to the formation of the detected volatile organic compounds.

| | WPC | WPI-B |
|---|---|---|
| | pH 8.0/40 C./ | pH 8.0/40 C./ |
| | 20 hr 8:1 | 20 hr 8:1 |
| | H2O2:BLG | H2O2:BLG |
| | (amounts in ppb) | (amounts in ppb) |
| 2-butanone | 135 ± 21 | 76 ± 9 |
| Hexanal | 13 ± 3 | Not Detected |
| Heptanal | 11 ± 1 | Not Detected |
| 2,4 Nonadienal (E,E) | 10 ± 2 | Not Detected |
| Nonanal | 1 ± 0 | Not Detected |
| Benzaldehyde | 21 ± 9 | 13 ± 0 |
| Acetic Acid | 58 ± 30 | 11 ± 2 |
| Formic Acid | 28 ± 16 | 9 ± 2 |
| Phenol | 11 ± 2 | 4 ± 1 |
| Benzoic Acid | 14 ± 4 | 7 ± 2 |

### Conclusions:

The inventors have found that whey protein sources containing as low amounts of fat as possible are preferred for preparing oxidized whey protein products and palatable products thereof.

### Example 8: Use of Thermal Gradients

The inventors have found that the elimination of free thiols can be particularly efficient when different temperature profiles are applied to reach a partial unfolding of the proteins to allow for the oxidation of the free thiols to sulfenic acid followed by a second temperature step, allowing the formation of disulfide bonds between proteins through the reaction of sulfenic acids and exposed thiols.

### Method

1%; 2%; 3%; 4%; 5% and 6% w/w protein solutions were prepared from WPI-A (see Example 1) by hydration of the powder in a 10 mM phosphate buffer pH 7.0 under gentle stirring at room temperature for 1 hour.

30% hydrogen peroxide was diluted to 0.3% in miliQ water and added to the protein solutions to reach 2:1 molar stoichiometry. Afterwards, the samples were thermally treated in a PCR machine (Esco Healthcare SwiftMax Pro) by using a temperature/time step-gradient (From 25° C. to 99° C. in 5° C. intervals and a holding time of 10.5 min. (total time 176 min.)). The samples were cooled down to 25° C. before analysis.

All samples were analysed for free thiols (Analysis E) and particles size by GPC-HPLC (Analysis G).

### Results:

Surprisingly, it was found possible to reduce the content of free thiols by 95% by using only a 2:1 molar stoichiometry at a protein concentration from 1% to 6%. The measured free thiols are shown in Table 15.

TABLE 15
Free thiols and Mw after oxidation by 2:1
at 1% to 6% WPI-A protein solutions.

| | WPI-A (protein %) | | | | | |
|---|---|---|---|---|---|---|
| | 1% | 2% | 3% | 4% | 5% | 6% |
| SH μmol/g | 2.42 | 2.33 | 2.30 | 2.16 | 2.13 | 2.6 |
| protein | | | | | | |
| Mw (kDa) | 105 | 852 | 1588 | 2552 | 4131 | 10846 |

The aggregation increased at higher protein concentration, shown in Table 15, but surprisingly, it can be done with limited protein aggregation at high protein concentrations.

### Conclusion:

The elimination of free thiols can be achieved at very low H2O2:BLG ratios by careful design of thermal profile that allows (1) exposure of free thiol and oxidation to sulfenic acid state at a low range of temperatures selected by a person skilled in the art to result in minimum aggregation and (2) subsequently allow the reaction between sulfenic acid and non-oxidized free thiol residues at higher temperatures.

The inventors have seen indications that the implementation of the invention of the present example increases the selectivity of cysteine oxidation and thereby reduces e.g. methionine oxidation.

### Example 9: Use of a Low Dosage of Oxidant in Combination with Heat-Treatment after the Oxidation

The inventors demonstrated that the combination of thermal treatment and by using a low dosage of oxidant can lead to a reduction of free thiol level, even to a desired range, where the H2S concentration can reach a level which is below sensory threshold.

A mild oxidation, by using low level of oxidant and short incubation time, e.g. 1 h, can allow partially unfolded protein molecular to oxidise and form sulfenic acid. The sulfenic acid is a transient intermediate during the reaction of cysteine residues with peroxides, and can be further oxidized to form sulfinic or sulfonic acids with the presence of desired level of peroxide, and/or long reaction time, e.g. 8:1 and 18 h in example 1 and 2. On the other hand, the sulfenic acid can also be consumed to form disulphide bonds with the presence of free thiols. In the current example, the inventors used low level of oxidant, e.g. 2:1, short reaction time, e.g. 1 h, which facilitates the oxidation of one part of the free thiols to form sulfenic acid, and further form disulfide bonds with the rest free thiols during secondary heating or UHT treatment.

### Materials and Methods:

A 6% (w/w, in protein) WPI-C solution (details for WPI-C powder is shown in Example 4) was pH adjusted to 8.0 at 20° C. (Analysis B) and placed in a 40° C. water bath. When the temperature of the protein solution reached 40° C., 2:1 (molar ratio between H2O2 and BLG) of 30% H2O2 was slowly added with stirring. This is followed by incubation at 40° C. for 1 h. Thereafter, the oxidised protein solution was taken out from the water bath, added with catalase to remove access H2O2, and left at room temperature for 15 min. A heat treatment with temperatures ranging from 60° C. to 81° C. and with different duration from 2.5 min up to 30 min was applied to samples of 6 ml solution which were filled in a thin 10 ml glass tube to ensure the efficient heating. The heated samples were immediately cooled in 10° C. water bath for 5 min. Analysis was carried out for free thiol (Analysis E) and analysis for GPC (Analysis G) was carried out for samples before UHT simulation. The H2S level (Analysis D) was measured after the samples had been subjected to UHT simulation as described in Example 1.

### Results

The results from Table 16 clearly show that when using a low dosage of H2O2 (2:1), a short incubation time, e.g. 1 h, at 40° C. is preferred. The level of free thiol reduced from 31.7 μmol/g protein (WPI-C11) to 5.4 μmol/g protein (WPI-C12) after incubation. Without a second heat treatment, the WPI-C12 was directly subjected to UHT treatment, where the thiol level was further decreased to 1.9 μmol/g protein. This further thiol reduction during the UHT treatment might be due to the formation of disulphide bonds. Hence, leads to formation of protein aggregates (increased molecular weight), and a very low level of H2S.

On the other hand, when the samples (WPI-C13 to WPI-C17) undergo a heat treatment after incubation, the lowest thiol and H2S level is obtained when heating at 81° C. for 5 min (WPI-C17).

It is interesting to notice that with a heat-treatment of lower temperature but longer heating time, e.g. 60° C. with a 30 min (WPI-C13), it is also possible to reduce the amount of free thiols and hence obtain a lower level of H2S compare to non-oxidized sample (WPI-C11). However, this temperature and time combination was much less efficient compared to that of at 81° C., for 5 min.

The inventors also demonstrated that, at 2:1 dosage of H2O2, a prolonged heating time, e.g. 7 h at 40° C. is not preferred (WPI-C18). Moreover, when increasing the dosage of H2O2 to 8:1, a 1 h incubation time is not enough (WPI-C19). In this case, a longer incubation time is required, e.g. 18 h, as demonstrated in example 1.

The molecular weight and intrinsic viscosity before UHT for sample WPI-C13 to WPI-C19, all show an increase compared to WPI-C11. This indicates the formation of aggregates, which is due to the formation of disulphide bonds between protein molecules. The protein solution is still clear with low turbidity of 14 NTU (only measured for sample WPI-C17).

TABLE 16

| | | | | Free | | Unpleasant | | |
|---|---|---|---|---|---|---|---|---|
| | H2O2:BLG | | | thiols, | | odour | | |
| | (molar | | Heat | μmol/g | H2S, | (Scale | Mw, | IV, |
| | ratio) | Incubation | treatment | protein | μM | 0-15) | kDa | mL/g |
| WPI- | 0:1 | None | None | 31.7 | 11.8 | 9 | 19.7 | 3.2 |
| C11 | | | | | | | | |
| WPI- | 2:1 | 40° C., | None | 5.4/1.9*⁾ | 0.2 | — | n.d. | n.d. |
| C12 | | 1 h | | | | | | |
| WPI- | 2:1 | 40° C., | 60° C., | 16.6 | 3.5 | — | 136.3 | 6.8 |
| C13 | | 1 h | 30 min | | | | | |
| WPI- | 2:1 | 40° C., | 65° C., | 11.7 | 2.4 | <5 | 471.5 | 8.2 |
| C14 | | 1 h | 25 min | | | | | |
| WPI- | 2:1 | 40° C., | 70° C., | 12.0 | 2.2 | <5 | 672.8 | 8.5 |
| C15 | | 1 h | 15 min | | | | | |
| WPI- | 2:1 | 40° C., | 75° C., | 6.5 | 1.1 | — | 788.5 | 8.9 |
| C16 | | 1 h | 8.5 min | | | | | |
| WPI- | 2:1 | 40° C., | 81° C., | 4.1 | 0.5 | — | 695.5 | 8.9 |
| C17 | | 1 h | 5 min | | | | | |
| WPI- | 2:1 | 40° C., | 81° C., | 8.2 | 6.5 | <5 | 225.1 | 7.5 |
| C18 | | 7 h | 2.5 min | | | | | |
| WPI- | 8:1 | 40° C., | 81° C., | 8.1 | 5.4 | <5 | 473.8 | 8.1 |
| C19 | | 1 h | 5 min | | | | | |

*⁾the level of free thiol of 5.4 is before UHT, and 1.9 is after UHT treatment.

### Conclusion:

It was possible to reduce the free thiol and H2S level of 6% whey solution when using a low dosage of oxidant, and a short incubation time at 40° C. was preferable. The heating step was not necessary when the protein solution was subjected directly to UHT after the incubation, and the UHT-treated liquid could be consumed as a beverage with no unpleasant odour. However, when the incubated protein solution is to be converted to a powder, the heat-treatment step is required to inactivate catalase, and a heat-treatment at 81 degrees C. for 5 minutes provided an oxidized whey protein composition that did not generate unpleasant odour at the subsequent UHT treatment.

The inventors have seen indications that the implementation of the invention of the present example increases the selectivity of cysteine oxidation and thereby reduces e.g. methionine oxidation.

### Example 10: Use of In-Situ Generation of Oxidant

The inventors demonstrated that the elimination of the free thiols, hence, the reduction of unpleasant odour, can be achieved by a stepwise addition of oxidant at low dosage over 8 h incubation at pH 8.0 and 40° C., followed by one or two heating steps.

The oxidant is provided by the use of an enzyme that generates 1 molar oxidant (H2O2) by conversion 1 molar lactose to lactobionic acid. The activity of the enzyme can be inhibited by the present of a relatively high level of H2O2 in the solution. Therefore the in-situ generation of H2O2 was designed to stepwise addition of substrate and the enzyme over time to avoid a high concentration of H2O2 at beginning of the reaction.

### Materials and Methods:

A 6% (w/w, in protein) WPI-C solution (details for WPI-C powder is shown in Example 4) was pH adjusted to 8.0 at 20° C. (Analysis B) and incubated for 470 minutes at 40° C. The lactose (alpha-lactose monohydrate, Sigma-Aldrich, USA) and the lactose oxidase (LactoYIELD®, Chr. Hansen A/S, Denmark) were added stepwise to the WPI-C solution, as described below:
At time 0 min, 0.75:1 (molar ration between BLG and lactose) of lactose and 1 ml/L Lactose oxidase was added.
At time 180 min 0.25:1 (molar ration between BLG and lactose) of lactose was added.
At time 280 min and 400 min 0.25:1 (molar ration between BLG and lactose) of lactose and 0.5 ml/L Lactose oxidase were added.

Therefore, a total amount of lactose corresponding to 1.5:1 (molar ration between BLG and lactose) and lactose oxidase of 2 ml/L was thus added during the whole duration of the reaction.

The sample was heated to 81° C. for 2.5 min for inactive lactose oxidase in a water bath at time 470 min and immediately cooled in ice for 2 min.

Catalase was added and allowed to react for 30 min at room temp.

The sample was heated to 81° C. for 2.5 min again for inactivation of catalase, and cooled immediately in ice for 2 min.

Thereafter, the sample was used for different analysis while including a non-oxidized, non-heated WPI-C20 sample as reference. The free thiols, molecular weight and the intrinsic viscosity of the samples before UHT were carried out according to analysis E, G and G, respectively. For H2S detection the Analysis D was used.

### Results:

The level of free thiols after 470 min incubation at 40° C. was successfully reduced from 25.6 μmol/g protein to 5.5 μmol/g protein. Hence, the very low level of H2S, 0.5 μM, which is below the sensory threshold. The molecular weight and intrinsic viscosity all increased in the WPI-C21 sample compare to WPI-C20 sample. This indicates the formation of aggregates, similar to in example 9.

TABLE 17

| | | Free | | | | |
|---|---|---|---|---|---|---|
| | H2O2:BLG | thiols, | | Unpleasant | | |
| | (molar | μmol/g | H2S, | odour | Mw, | IV, |
| | ratio) | protein | μM | (Scale 0-15) | kDa | mL/g |
| WPI-C20 | 0:1 | 25.6 | 10.6 | 10 | 19.6 | 3.4 |
| WPI-C21 | 1.5:1 | 5.5 | 0.5 | <5 | 846 | 9.3 |

### Conclusion:

In-situ generation of oxidant constitutes can be an alternative way to direct addition of H2O2. The low dosage and step-wise generation of In-situ oxidant during first step incubation allow the oxidation of free thiols to form sulfenic acid, followed by the formation of disulphide bridges during further heating step, similar to Example 9.

The inventors have seen indications that the implementation of the invention of the present example increases the selectivity of cysteine oxidation and thereby reduces e.g. methionine oxidation.

### Example 11: Exploitation of In-Situ Generation of Oxidant by One Step Addition of Lactose and Lactose Oxidase

Based on Example 10, the inventors also explored the possibility of a one-step addition of lactose and lactose oxidase for generation of oxidant (H2O2) to eliminate of the free thiols in the protein solution.

### Materials and Methods:

A whey protein solution was prepared by mixing WPI-C(details for WPI-C powder is shown in Example 4) with demineralised water to obtained 6% w/w protein and its pH adjusted to 8.0 at 20° C. (Analysis B). The pH adjustments of the present Examples always used the minumum required amounts of acid/bases and only gave rise to insignificant changes in protein concentration. The whey protein solution was incubated for 15 minutes to reach the temperature of 40° C. Thereafter, the full dosage of lactose (alpha-lactose monohydrate, Sigma-Aldrich, USA) and the lactose oxidase (LactoYIELDR, Chr. Hansen A/S, Denmark; LactoYield material number 191306 and cellobiose oxidase activity (LOXU/g) of 17.2) was added together to the WPI-C solution. The amount of the lactose added corresponded to a molar ratio between lactose and BLG of 1.5:1 and hence a theorical molar ratio between generated H2O2 and BLG of 1.5:1. The lactose oxidase was used in an amount of 2 mL/L. The solution was then kept at 40° C. for 360 minutes to allow the formation of H2O2 and oxidation of free thiols.

At the end of the incubation, a 6 ml sample was taken into a thin glass tube, and heated at 83° C. for 2.5 min and cooled immediately in ice for 2 min (sample WPI-C23).

The reference sample, WPI-C22, was a non-oxidized solution of WPI-C(protein in an amount of 6% w/w and adjusted to pH 8.0. WPI-C22 was not heated to 83° C. for 2.5 min.

Subsequently, WPI-C22 and WPI-C23 were subjected to different analyses. The free thiols, molecular weight and the of the samples before UHT, were carried out according to analysis E and G, respectively. The detection of H2S was performed within one hour after UHT-simulation (according to Example 1), using the Analysis D. The sensory test was carried out as described in Example 1.

### Results:

The level of free thiols after 420 minutes incubation at 40° C. was successfully reduced from 29.8 μmol/g protein (WPI-C22) to 7.3 μmol/g protein in the oxidized sample (WPI-C23). Simulated UHT treatment of WPI-C23 revealed a low level of H2S of 1 μM and the smell of H2S could not be perceived after 24 h storage at room temperature. In contrast, simulated UHT treatment of WPI-C22 produced a strong eggy unpleasant odour that was easily perceived by sensory testing.

The molecular weight increased in the WPI-C23 sample compared to WPI-C22 reference sample. This indicates the formation of aggregates as a consequence of thermal treatment, similar to in example 9 and 10.

TABLE 17
In situ generation of oxidant to reduce free thiol levels and
resulting unpleasant odour generation by UHT treatment

| | | Free thiols, | | Unpleasant | |
|---|---|---|---|---|---|
| | H2O2:BLG | μmol/g | H2S, | odour | Mw, |
| | (molar ratio) | protein | μM | (Scale 0-15) | kDa |
| WPI-C22 | 0:1 | 29.8 | 10.4 | 10 | 22 |
| WPI-C23 | 1.5:1 | 7.3 | 1.0 | <5 | 644 |

The reference sample WPI-C22 had not been subjected to the heat-treatment of 83° C. for 2.5 minutes and therefore no aggregation (and hence increase in molar weight, Mw) was observed in relation to WPI-C22.

### Conclusion:

The present example demonstrated that in-situ generation of oxidant by one step addition of lactose and lactose oxidase at a low molar ratio between lactose (and therefore H2O2) and BLG is a feasible approach to reduce free thiols and result in only a low level of unpleasant odour generation upon UHT treatments.

### Example 12: Production of an Oxidized Whey Protein Powder Using Low Dosage of Oxidant

In the experiment reported in this example the inventors demonstrated the feasibility of preparing a powder of oxidized whey protein using the oxidation conditions described in Example 9 and furthermore concentrating and spray drying the resulting oxidized whey protein stream. The resulting modified whey protein powder generated a surprisingly low level of unpleasant odour after rehydration and UHT treatment at neutral pH.

It is particularly advantageous to remove water by e.g. spray drying to save energy when such a product is to be transported over long distances (avoid transport of water) and to reduce risk of microbial growth during storage.

| | | WPI-C26 |
|---|---|---|
| Total solids | [%] | 96.0 |
| Protein (N × 6.38) | [%] | 87.8 |
| Protein/Total solids | [%] | 91.5 |
| Fat | [%] | <0.1 |
| Lactose | [%] | <0.1 |
| Ash | [%] | 5.08 |
| Calcium | [%] | 0.056 |
| Sodium | [%] | 0.699 |
| Potassium | [%] | 1.62 |
| Magnesium | [%] | 0.008 |
| Phosphorus | [%] | 0.197 |
| Chloride | [%] | 0.38 |
| pH | [—] | 7.25 |

### Materials and Methods:

A 250 kg solution of WPI-C(with characteristics described in Example 4, table 9) containing 7.6% w/w protein was prepared by hydration of WPI-C in water for 30 minutes at room temperature with gentle stirring (WPI-C24). Thereafter the solution was heated to 40° C., and the pH of the solution was adjusted to 7.8 (40° C.) by addition of a lye mixture of KOH (4.5%) and NaOH (2.3%). H2O2 was added in an amount sufficient to obtain a molar ratio of 1.9:1 between H2O2 and BLG (corresponding to approx. 150 mg H2O2/L) and the solution was incubated with gentle mixing for 60 min at 40° C. At the end of the incubation, the protein solution was heated via a plate heat exchanger to 85° C., with a holding time of 2 minutes. and subsequently cooled to <10° C.

The oxidized WPI was then pH adjusted to 7.1 (20° C.) using 0.3 M HCl, with stirring for 30 min. 200 ml of sample (WPI-C25) were taken at this time point for free thiol groups by analysis E, UHT simulation according to example 1, H2S by analysis D turbidity by analysis Q, viscosity by analysis C and sensory as described in example 1 . . . . Amino acids and oxidized amino acids were quantified by analysis F1 and F2, respectively.

The remaining oxidized WPI solution was concentrated to Brix 14, corresponding to a protein content of 10.5% w/w, on a pilot scale MMS NF/RO unit equipped with 2 pcs Alfa Laval RO98pHt 3838/65 membranes, and operated in a RO mode at 10° C. and 30 bars with maximum differential pressure of 1.1 bar per element. The RO retentate was then dried on an SPX Anhydro pilot scale spray dryer (185° C. inlet/85° C. outlet temperature) to produce a powder (WPI-C26).

WPI-C26 (with a composition as shown in the table above) was rehydrated at room temperature under gentle stirring to produce a WPI-C26 solution containing protein in an amount of 6% w/w that was characterized for free thiol groups by analysis E, subjected to UHT simulation according to example 1, H2S determination by analysis D and sensory as described in example 1. Residual H2O2 was measured according to analysis H.

A separate sample of the WPI-C26 powder was rehydrated to provide a solution containing protein in an amount of 7.6% w/w and amino acids and oxidized amino acids were quantified by analysis F1 and F2, respectively.

The amino acid profile of sample WPI-D24, WPI-D25 and WPI-D26 was determined by Eurofins Vitamin Testing Denmark DJ041-1 based on the EU 152/2009 method reference.

The combined cysteine+cystine levels were derived from the eurofins analysis and the amount of cysteine residues in disulfide bridges (cystine) was calculated by combining data with those of analysis E (converting to weight-concentration by multiplying with the molecular weight of L-cysteine) and recalculating to units g/100 g:

$$Cys in disulfide s = ( 1 - ( Free SH in g / 100 g protein ) / ( Cys + Cystine in g / 100 g protein ) ) * 100 \%$$

### Results:

As shown in Table 18, the oxidation by low dosage of H2O2 with a 60 min incubation time at 40° C. resulted in a reduction of free thiols from 29.6 in the starting material (WPI-C24) to 1.7 μmol SH/g protein (WPI-C25) that produced a a very low amount of H2S after lab UHT treatment, which could not be detected by sensory evaluation. The 1.8 μmol SH/g protein characterizing sample WPI-C26 resulted in 0.4 μM H2S and could not be perceived in the sensory evaluation.

The inventors have found that the low turbidity and viscosity is in excellent agreement with the observed Mw of 494 kDa for sample WPI-C25.

During the heating step of the process of Example 12, the formation of disulfide bonds by free thiols and sulfenic acid, lead to increased molecular weight from 19 to 494 kDa. The inventors find that the molecular weight increases slightly by the concentration and drying step to 717 kDa for WPI-C26.

TABLE 18
Production of an oxidized whey protein powder

| | | | | Turbidity, | | | Unpleasant |
|---|---|---|---|---|---|---|---|
| | H2O2:BLG | SH in | H2S, | NTU after | Viscosity, | Mw, | odourScale |
| Beverage | mol:mol | μmol/g | μM | UHT | cP | kDa | 0-15 |
| WPI-C24 | 0:1 | 29.6 | 10.6 | 6.6 | 2.8 | 19.2 | 10 |
| WPI-C25 | 1.9:1 | 1.7 | 0.3 | 18.1 | 3.4 | 494 | <5 |
| WPI-C26 | 1.9:1 | 1.8 | 0.4 | — | 3.2 | 717 | <5 |
| (Final | | | | | | | |
| powder) | | | | | | | |

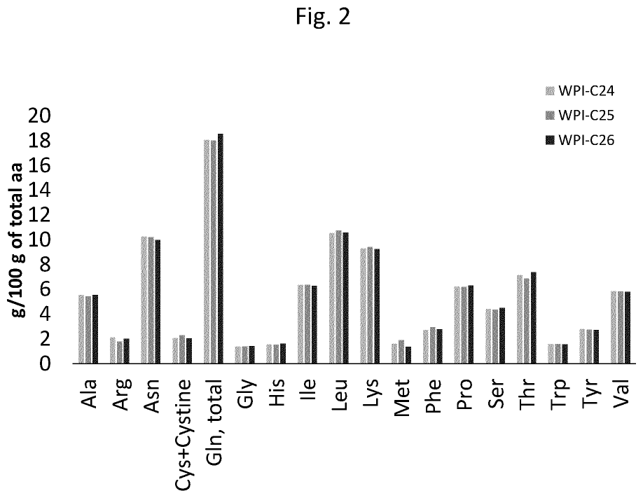

The results of the amino acid analysis are shown in FIG. 2 and demonstrate the selective oxidation of free thiols that the present invention enables. The oxidized whey protein samples WPI-C25 and WPI-C26 have substantially the same amino acid profile as the non-oxidized reference sample WPI-C24.

As shown in Table 19, the analysis of tryptophan and methionine in sample WPI-C24 to WPI-C26 showed no significant changes in the level of these amino acids after oxidation (WPI-C25) and drying (WPI-C26) thus clearly demonstrating a gentle and selective oxidation process. Table 19 further demonstrates that no kynurenine was formed after oxidation and drying. The inventors further found no trace of o-Tyr, DiTyr or DiOia in samples WPI-C24 to WPI-C26.

By combining amino acid analysis of total cysteines (Cys+cystine), the inventors found that the reduction in free thiols of the present example predominantly was due to formation of disulfide bonds as demonstrated from the increase in disulfide-bonded cysteines from 82.9% (WPI-D24) to 99.1% in the oxidized (WPI-D25) and 97.4% in the dried sample (WPI-D26); see Table 19. The inventors expect the minor differences between WPI-D25 and WPI-D26 to be within analytical error. Further, the inventors found that aggregates in WPI-D26 were fully reducible to the state of the WPI-D24 confirming that aggregates were stabilized by disulfide-bonds (confirmed by SDS-PAGE analysis of the samples under reducing and non-reducing conditions).

Finally, the analysis of residual peroxides revealed that WPI-D25 and WPI-D26 did not have any presence of the previously added peroxide.

TABLE 19
Sample characteristics (BDL = below the detection limit)

| | | Cys in | | | | |
|---|---|---|---|---|---|---|
| | Cys + | disulphide | Protein | | | |
| | cystine | bonds of total | bound | | | |
| | in g/ | cys (Cys + | sulfuric | | | |
| | 100 g | cystine), | aa, | Tryptophan, | Methionine, | |
| Sample | protein | % | % | % | % | Kyrurenine |
| WPI- | 2.1 | 82.9 | 3.7 | 1.5 ± 0.1 | 1.6 ± 0.3 | BDL |
| C24 | | | | | | |
| WPI- | 2.3 | 99.1 | 4.2 | 1.5 ± 0.0 | 1.9 ± 0.4 | BDL |
| C25 | | | | | | |
| WPI- | 2.1 | 97.4 | 3.4 | 1.5 ± 0.0 | 1.4 ± 0.3 | BDL |
| C26 | | | | | | |

### Conclusion:

It was possible to produce an oxidized WPI powder that does not generate undesirable odours during UHT treatment by using a low dosage of oxidant and a short reaction time. This combination resulted in both liquid product and powder characterized by high amount of cys in reducible disulphide bonds, low cysteine levels as free thiols and consequently produced low levels of H2S when subjected to UHT treatment.

The low dosages of oxidant used in the manufacturing of WPI-D25 and WPI-D26 resulted in an amino acid profile comparable to that of the raw material (WPI-D24) and particularly noticeable with no significant loss of total cysteine or methionine residues and oxidation products could be detected.

Presence of residuals of the added peroxide could not be detected in WPI-D25 and WPI-D26 which indicates that peroxides can be used as oxidants in the present method and be fully consumed without the need for addition of catalase.

### Example 13: Use of Low Dosages and High Temperatures

The inventors have demonstrated that the use of low dosages of oxidant can efficiently be used in combination with direct steam injection UHT treatment to successfully reduce free thiols in whey protein compositions and consequently lead to whey protein beverages with low level of unpleasant odour upon subsequent thermal treatment.

### Materials and Methods:

225 kg of WPI-C solution (protein in an amount of 6% w/w) was prepared by dissolving WPI-C powder in demineralised water.

The WPI-C solution was heated to 40° C. with stirring in a holding tank using a heating mantle. pH was adjusted to pH 7.8 measured at 40° C. to produce WPI-C27.

20 kg of WPI-C27 was subjected directly to UHT treatment by direct steam injection (DSI) at 143° C. for 4 sec (WPI-C28) and subsequently cooled by flash cooling to 70 degrees C. and then cooled to 10 degrees C. The flash water from the flash cooling of WPI-C28 was collected as sample Flash1.

The remaining WPI-C27 was oxidized with 1.9:1 H2O2:bLG at 40° C. for 60 min and then UHT treatment by direct steam injection with a holding time at 143° C. of 4 sec and subsequently cooled by flash cooling to 70 degrees C. and then cooled to 10 degrees C. to produce the an oxidized WPI-C29 sample. The flash water from the flash cooling of WPI-C29 was collected as sample Flash2 to investigate the feasibility of a production process combining low dosages of H2O2 with high-temperature treatment (here DSI) in producing a product that produces low H2S levels in subsequent applications.

Immediately after collection, 1.0 mL samples of of Flash1 and Flash2 were transferred to 2 mL GC vials (Mikrolab no ML 33003VU) and crimp-sealed using aluminium lids (Mikrolab ML 33032) and an electronic crimper (Thermo Scientific CRMA60180-ECRH11KI). The H2S content in samples Flash1 and Flash2 was analyzed according to analysis D.

WPI-C27 and WPI-C29 was further subjected to simulate UHT treatment to demonstrate that the oxidized WPI-C29 samples produces low levels of unpleasant odour even when subjected to harsh heat treatments. The free thiol content and molecular weight of sample WPI-C27, WPI-C28 and WPI-C29 was analyzed according to analysis E and G, respectively.

### Results:

In the present investigation, the inventors employed low H2O2 dosages (1.9:1 H2O2:bLG) in combination with direct steam injection at 143° C. of 4 sec as the heating step to demonstrate an efficient lowering in free thiol content as shown in Table 20.

Table 20 demonstrates that the free thiol content of WPI-C27 raw material is marginally reduced by direct steam injection to produce WPI-C28 in the absence of H2O2. However, the oxidation with 1.9:1 H2O2:bLG mole ratio in combination with direct steam injection to produce WPI-C29 significantly reduces the free thiol content to 5.9 μmol SH/g protein.

It was further demonstrated that the molecular weight of protein aggregates created in the thermal processing of WPI-C28 and WPI-C29 were essentially indistinguishable suggesting that the presence of low H2O2 dosages in the processing of WPI-C29 does not affect the overall propensity for aggregation of WPI-C.

During the processing of WPI-C28 the inventors surprisingly perceived an eggy aroma from the flash water (Flash1) generated during the evaporation/condensing step of the thermal treatment after direct steam injection to heat the sample and holding time at 143° C. of 4 sec. Indeed, a concentration of 4.3 μH2S was demonstrated in the collected flash water (Flash 1) and could easily be perceived by the operators.

In contrast, the eggy aroma was not observed by the inventors during the processing of the WPI-C29 sample and H2S measurements confirmed a very low level of 0.1 μM H2S in the collected flash water (Flash2). The inventors thus surprisingly found that the use of low H2O2 dosages may therefore in itself be beneficial to reduce the exposure of operators to H2S levels generated by thermal treatments in the manufacturing process.

The H2S contents of WPI-C27 and WPI-C29 samples subjected to simulated UHT treatment showed 5.7 μM H2S and 0.3 μM H2S in samples, respectively. The level of and clearly demonstrate that oxidation with low dosages of H2O2 in combination with the use of high temperatures during the processing allow for manufacturing of beverage compositions with no/low H2S levels in the final preparation of beverages.

TABLE 20
Samples prepared in Example 13.

| | | Free thiol | |
|---|---|---|---|
| | | μmol SH/g | |
| Sample | H2O2:bLG | protein | Mw, kDa |
| WPI-C27 | — | 31.7 | 23 |
| WPI-C28 | — | 30.8 | 175.1 |
| WPI-C29 | 1.9:1 | 5.9 | 165.2 |

### Conclusion:

The inventors have demonstrated that oxidation of whey protein using molar ratios of e.g. 1.9:1 H2O2:bLG can be used in combination with UHT-type of heat treatment to reduce the content of free thiols of whey protein compositions.

The use of low H2O2 dosages in the processing of whey can significantly reduce the exposure of H2S to operators of the UHT equipment.

Due to the low content of free thiol groups of WPI-C29 it will not generate undesirable odours if subjected to a second UHT-treatment.

### Example 14: Use of Low-Dosages of H2O2 to Produce Oxidized Whey Protein Beverages Suitable for Chronical Kidney Disease Patients

Chronical kidney disease patients are inefficient in removing organic phosphorous often found in many protein-rich foods (meat, poulty, dairy products) very well due to kidney malfunction and it may therefore be particularly beneficial to provide whey protein compositions low in phosphorous. The present example demonstrates that BLG isolates can be subjected to selective, low-dosage H2O2 oxidation to produce nutritional PH neutral beverages with a low level of unpleasant odour (or even no unpleasant odour at all). Such beverages can be produced both with or without added lipids.

### Materials and Methods:

WPI-D with characteristics as described in Table 21 was used to prepare the beverage compositions of this example.

TABLE 21
WPI-D characteristics

| | WPI-D |
|---|---|
| Protein/TS, % | 97 |
| BLG relative to total protein, % | 99.6 |
| ALA relative to total protein, % | <1 |
| cGMP relative to total protein, % | <1 |
| Na, % of TS | 0.34 |
| K, % of TS | 0.83 |
| Mg, % of TS | <0.003 |
| Ca, % of TS | <0.025 |
| Phosphorous, % of TS | 0.03 |
| Cl, % of TS | 0.07 |
| pH of 6% solution | 7.0 |
| Lactose % | ≤0.1 |
| Fat % | ≤0.1 |

A 3 liter WPI-D protein solution (6% protein w/w) was prepared by dissolving powder in demineralized water with gentle stirring for 30 minutes. The pH was adjusted to pH 8.0 at 20° C. using 3M NaOH and the solution was split in smaller aliqouts and equilibrated to 40° C. 3% hydrogen peroxide was added to a final content molar ratio of 2:1 between H2O2 and bLG and the oxidizing protein solution was incubated for 1 hr at 40° C. The oxidizing solution was heat treated to 83° C. with a holding time of 2.5 minutes using a OMVE HT122 bench-top UHT system and subsequently cooled to 20° C.

The oxidized protein solution was concentrated to 7.8% by use of 200 mL Amicon stirred cells equipped with 5 kDa ultrafiltration membranes at 3 bar TMP using N2 gas to provide sample WPI-D5. The protein content were estimated by use of an PAL-α hand-held refractometer (ATAGO) and confirmed by analysis A.

A reference solution (WPI-D6) containing 7.8% protein w/w was prepared by dissolving WPI-D in demineralized water with gentle stirring for 30 minutes without further treatment.

The free thiol content of WPI-D5 and WPI-D6 solutions was determined according to analysis E.

Exemplary beverage compositions (BEV-D1, BEV-D2, BEV-D3, and BEV-D4) with and without lipid were prepared by mixing ingredients described in Table 22. The protein and lipid constituents were individually preequilibrated to 40° C. in a water bath and the emulsifier was added to the lipid phase.

The pre-equilbrated protein solutions were then mixed with the lipid phase or demineralized water and briefly mixed using an ultra-turrax and finally homogenized at 200 bar using a GEA Panda homogenizer to produce the beverage compositions of Table 22 having a protein content of 6% w/w. The beverage compositions were subjected to simulated UHT treatment according to example 1 and H2S was measured using Analysis D the day after UHT simulation.

TABLE 22
Recipe of exemplary beverage compositions.
Sample ID

| Sample ID | BEV-D1 | BEV-D2 | BEV-D3 | BEV-D4 |
|---|---|---|---|---|
| Protein source: | 45 g 7.8% | 45 g 7.8% | 450 g 7.8% | 450 g 7.8% |
| | WPI-D6 | WPI-D5 | WPI-D6 | WPI-D5 |
| Coconut oil, | — | — | 50 g | 50 g |
| Kristal | | | | |
| Emulsifyer, | — | — | 1 | 1 |
| Citrem | | | | |
| LR 10 | | | | |
| Water | 5 g | 5 g | — | — |

### Results:

The present example demonstrated the feasibility of producing oxidized WPI-D5 by use of low H2O2 dosages in combination with a heat-treatment at 83° C. from WPI-D characterized by a low content of phosphorus making it particularly suited as nutritional beverages for chronical kidney disease patients requiring protein sources with minimum phosphorous content.

It was found that the oxidation process reduced the amount of free thiols from 54.2 μmol SH/g protein from WPI-D6 to 9.2 μmol SH/g protein after oxidation in WPI-D5 as demonstrated in Table 23.

When nutritional beverage compositions with or without lipids were subjected to simulated UHT treatment it was found that BEV-D1 and BEV-D3 samples containing non-oxidized WPI-D6 protein produced H2S levels of more than about 10 μM H2S which is significantly beyond the sensory threshold. In contrast, the BEV-D2 and BEV-D4 beverage compositions containing WPI-D5 protein gave rise to <0.7 μM H2S and below levels perceived by sensory testing.

TABLE 23
Beverage characteristics after simulated UHT treatment

| | | | | Free thiols | |
|---|---|---|---|---|---|
| Beverage | Protein | Protein, | Lipid, | μmol SH/g | H2S, |
| sample | source | w/w | w/w | protein | μM |
| BEV-D1 | WPI-D6 | 6% | 0% | 54.2 | 13.9 ± 3.7 |
| BEV-D2 | WPI-D5 | 6% | 0% | 9.2 | 0.51 ± 0.06 |
| BEV-D3 | WPI-D6 | 6% | 10% | 54.2 | 12.8 ± 3.1 |
| BEV-D4 | WPI-D5 | 6% | 10% | 9.2 | 0.23 ± 0.04 |

### Conclusion:

The use of WPI-D to produce 6% whey protein beverages comprising 10% w:w lipid was demonstrated through oxidation with 2:1 H2O2:bLG. The low phosphorous level of the WPI-D makes such beverages particularly useful for patients suffering from chronical kidney disease.

### Example 15: Use of High Pressure for Exposure of Free Thiols

In this example the inventors aimed to oxidize free thiols in WPI-D by subjecting the protein composition to oxidizing conditions under moderate pressures that in themselves are insufficient to induce significant denaturation/aggregation of the major thiol-containing whey protein (bLG) as determined after pressure relief.

The inventors suggest that partial oxidation of free thiols in bLG allows for disulfide bond formation between free thiols oxidized to sulfenic acid and remaining non-oxidized free thiols provided that the conformational freedom to achieve the formation of new disulfide bonds exists. In the present example this conformational freedom is achieved by heating solutions at 85° C. for 5 minutes after exposure of free thiols to H2O2 under pressurization.

### Methods and Materials

WPI-D was rehydrated to 6% under gentle stirring at room temperature followed by pH adjustment to 8.0 (WPI-D7 to WPI-D13) using 2M NaOH at 20° C.

H2O2 was added to sample WPI-D8 to WPI-D10 and WPI-D12 and WPI-D13 to reach 2:1 H2O2:bLG molar ratio. No H2O2 was added to WPI-D7, and WPI-D11.

With the exception of WPI-D13, 32 mL of each sample was transferred into Nalgene HDPE plastic bottles and sealed with a cap. The bottle was submerged in a pressure vessel containing hydrostatic fluid medium and pressurized as described in Table 24 to 50 or 100 bar for 30 or 60 minutes at 20-25° C. using a QFK-6 high pressure unit (Avure Technoliges AB, Vesterås, Sweden).

Samples WPI-D8 to WPI-D13 (WPI-D9 excluded) were taken directly from high pressure treatment and 15 mL samples was transferred to 20 mL Duran GL 18 reagent glasses with screw-cap lids and immersed into a 86° C. water bath for 5 minutes. After heating the samples were cooled in an ice-water bath.

The free thiols content of all samples was measured according to analysis E. Select samples were subjected to simulated UHT treatment and sensory evaluation according to example 1 and H2S was measured according to example D

### Results:

The use of moderate pressures to enable access to free thiols in bLG was evaluated. High pressure treatment at pH 8.0 with heating at 85° C./5 min in the absence of H2O2 (WPI-D7) result in high levels of unpleasant odour after simulated UHT and is also perceived as ‘eggy’ by inventors.

High pressure treatment at pH 8.0 in the presence of H2O2 (WPI-D12) lead to a reduction in free thiol levels to ˜23 μmol SH/g protein or just below half of the starting material (theoretically 54 μmol SH/g protein). When combined with thermal treatment at 85° C./5 min the resulting free thiol levels were reduced to 6.8 μmol SH/g protein in WPI-D13, 5.9 μmol SH/g protein in WPI-D8 and 3.9 μmol SH/g protein in WPI-D10. Measurements of unpleasant odour after simulated UHT treatment of sample WPI-D8 and WPI-D13 confirmed previous observations that thiol reduction result in low levels of unpleasant odour with 0.5 and 0.4 μM H2S and a perception below 5. Thermal treatment of sample WPI-D9 at 85° C. for 5 min in the presence of 2:1 H2O2:bLG without pressure treatment also reduced free thiol levels but was slightly less efficient with an identified free thiol level of 9 μmol SH/g protein.

TABLE 24
High pressure oxidation of free thiols in WPI-D

| | | | | Pressure | | Free thiol | | |
|---|---|---|---|---|---|---|---|---|
| | | | Temperature, | (bar)/ | | μmol | | |
| | | | degrees | time | Heat | SH/g | H2S | |
| Sample | H2O2:bLG | pH | celcius | (min) | treatment | protein | μM | Perception |
| WPI- | — | 8.0 | 25 | 50/30 | 85° C./ | 48.3 ± 0.1 | 5.5 | 9 |
| D7 | | | | | 5 min | | | |
| WPI- | 2:1 | 8.0 | 25 | 50/30 | 85° C./ | 5.9 ± 0.0 | 0.5 | <5 |
| D8 | | | | | 5 min | | | |
| WPI- | 2:1 | 8.0 | 25 | — | 85° C./ | 9.0 ± 0.1 | — | — |
| D9 | | | | | 5 min | | | |
| WPI- | 2:1 | 8.0 | 25 | 100/30 | 85° C./ | 3.9 ± 0.1 | — | — |
| D10 | | | | | 5 min | | | |
| WPI- | — | 8.0 | 25 | 100/60 | — | 50.6 ± 0.1 | 6.4 | 9 |
| D11 | | | | | | | | |
| WPI- | 2:1 | 8.0 | 25 | 100/60 | — | 23.0 ± 0.2 | — | — |
| D12 | | | | | | | | |
| WPI- | 2:1 | 8.0 | 25 | 100/60 | 85° C./ | 6.8 ± 0.2 | 0.4 | <5 |
| D13 | | | | | 5 min | | | |

### Conclusion:

The present example demonstrates that alternative means to unfolding proteins can be employed to expose free thiols and allow the of oxidation. Here the combination of moderately high pressures, a low 2:1 H2O2:bLG dosage of oxidant and following thermal treatment were sufficient to reduce free thiol levels to an extent that leads to very low perceived and measured levels of unpleasant odour when subjected to UHT treatments.

### Example 16: Use of Low Dosage and Short Incubation Time

In this example the inventors showed that it surprisingly was possible to produce oxidated WPI by hot oxidation with very short incubation time.

### Materials and Methods:

A 6% protein (w/w) WPI solution (WPI-C) was adjusted to pH 7.8 at 40° C., and cooled down to approx. 10° C. Afterward H2O2 was added to the WPI solution to reach 1.9:1 H2O2:bLG molar ratio and mixed for 1 min. Immediately after the WPI solution was heated via a plate heat exchanger to 85° C., with a holding time of 2 minutes, to perform a hot oxidation, and subsequently cooled to <10° C. (WPI-C30).

Beverages were produced from WPI-C30 (the liquid oxidized WPI solution). Before the UHT the pH of the 6% oxidized WPI solution was adjust to pH 7.0 (22° C.) with 1% HCl. The UHT thermal treatment was done using a plate heat exchanger (PHE), (HT320-20, OMVE, Netherlands) operated with service water flow of 80 L/h, product flow of 20 L/h, preheating to 70° C. followed by heating at 143° C. for 20 seconds. The heat-treated beverage was cooled to 10° C. at the outlet and tapped into 100 ml sterile plastic bottles and immediately sealed for further analysis. Moreover, samples for H2S level analysis (Analysis D) were taken at the outlet of the UHT, where 1 ml of sample was filled into 2 ml glass vial and immediately crimp-sealed with lids as described in example 1.

### Results:

The present experiment demonstrated that it was possible to reduce the content of free thiols by 93% by adding H2O2 (1.9:1) at 10° C., and carry out a hot oxidation at short incubation time at 85° C./2 min. Hereby very low level of H2S (0.2 μM) was found in clear (9.2 NTU) UHT beverages.

| | | Free | | | | |
|---|---|---|---|---|---|---|
| | H2O2:BLG | thiols, | | Unpleasant | | Tur- |
| | (molar | μmol/g | H2S, | odour | Mw, | bidity |
| | ratio) | protein | μM | (Scale 0-15) | kDa | (NTU) |
| WPI-C30 | 1.9:1 | 1.6 | 0.2 | <5 | 195 | 9.2 |

### Conclusions:

The inventors found that is was possible to reduced the processing time and energy use by incubating the proteins with a low level of H2O2 for short time at temperatures exceeding 65 degrees C. The obtained oxidized whey protein composition can be used directly as a beverage and may e.g. be bottled immediately after the hot oxidation or alternatively it may be dried as such or concentrated and subsequently dried, preferably by spray-drying.

1. A method of producing an oxidized whey protein composition, the method comprising
a) processing a whey protein source to provide an oxidizing whey protein solution comprising:
oxidizing agent capable of oxidizing the thiol group of cysteine, and
having:
a pH in the range of 6.5-9.5,
a total protein content of at least 1% w/w relative to the weight of the oxidizing whey protein solution,
a beta-lactoglobulin (BLG) content of at least 10% w/w relative to total protein
preferably, a protein content of at least 30% w/w relative to total solids,
preferably, a total fat content of at most 3% w/w relative to total solids,
and wherein the oxidizing whey protein solution furthermore:
i) has a temperature in the range of 0-160 degrees C., and/or
ii) is pressurized to a pressure in the range of 20-4000 bar,
b) incubating the oxidizing whey protein solution under one or more conditions that allow for oxidation of the free thiol of at least some of the BLG molecules of the oxidizing whey protein solution, preferably to reduce the amount of free thiol groups of the oxidizing whey protein solution to at most 15 micromol/g protein, which one or more conditions involve:
I) the oxidizing whey protein solution having temperature in the range of 0-160 degrees C., and/or
II) the oxidizing whey protein solution is pressurized to a pressure in the range of 20-4000 bar,
c) optionally, yet preferably, subjecting the oxidized whey protein solution obtained from step b) or a protein concentrate thereof to a heat-treatment step which involves heating to a temperature of at least 60 degrees C.,
d) optionally, yet preferably, drying a liquid feed comprising at least the protein derived from the oxidized whey protein solution obtained from step b).

2. The method according to claim 1 wherein the oxidizing agent capable of oxidizing the thiol group of cysteine comprises or even consists of a peroxide, ozone, dioxygen, or a combination thereof.

3. The method according to any of the preceding claims wherein the oxidizing agent capable of oxidizing the thiol group of cysteine is a peroxide selected from the group consisting of hydrogen peroxide, benzoyl peroxide, and a mixture thereof.

4. The method according to any of the preceding claims wherein the molar ratio between:
the oxidizing agent capable of oxidizing the thiol group of cysteine, and
the total amount of free thiol groups
of the oxidizing whey protein solution of step a) is at least 1:2, more preferably at least 1:1, even more preferably at least 2:1, and most preferably at least 3:1.

5. The method according to any of the preceding claims wherein the molar ratio between:
the oxidizing agent capable of oxidizing the thiol group of cysteine, and
the total amount of free thiol groups
of the oxidizing whey protein solution of step a) is 1:2-15:1, more preferably 1:1.5-10:1, even more preferably 1:1-8:1, and most preferably 1:1-3:1.

6. The method according to any of the preceding claims wherein the oxidizing whey protein solution of step a) has a pH in the range of 7.0-9.5, more preferably 7.1-8.5, even more preferably 7.2-8.5, and most preferably 7.4-8.2.

7. The method according to any of the preceding claims wherein the oxidizing whey protein solution of step a) has a total fat content of at most 1% w/w relative to total solids, more preferably at most 0.5% w/w, even more preferably at most 0.2% w/w, and most preferably at most 0.1% w/w relative to total solids.

8. The method according to any of the preceding claims wherein condition i) involves the oxidizing whey protein solution of step a) having a temperature in the range of 5-65 degrees C., more preferably 10-65 degrees C., even more preferably 30-60 degrees C., and most preferably 40-55 degrees C.

9. The method according to any of the preceding claims wherein condition i) involves the oxidizing whey protein solution of step a) having a temperature in the range of 66-160 degrees C., more preferably 70-145 degrees C., even more preferably 75-120 degrees C., and most preferably 80-100 degrees C.

10. The method according to any of the preceding claims wherein condition ii) involves that the oxidizing whey protein solution of step a) is subjected to a pressure in the range of 20-4000 bar, more preferably 200-3500 bar, even more preferably 300-3000 bar, and most preferably 500-2500 bar

11. The method according to any of the preceding claims wherein condition ii) involves that the oxidizing whey protein solution of step a) is subjected to a pressure in the range of 25-1000 bar, more preferably 30-500 bar, even more preferably 35-300 bar, and most preferably 40-200 bar.

12. The method according to any of the preceding claims wherein step b) reduces, or is performed to reduce, the initial amount of free thiol groups of the oxidizing whey protein solution of step a) to 20-80% of the initial amount, more preferably to 30-80%, even more preferably to 50-75%, and most preferably to 60-75% of the initial amount.

13. The method according to any of the preceding claims wherein step b) reduces, or is performed to reduce, the amount of free thiol of the oxidizing whey protein solution at most 10 micromol/g protein, more preferably at most 8 micromol/g protein, more preferably at most 5 micromol/g protein, even more preferably at most 3 micromol/g protein, and most preferably at most 2 micromol/g protein.

14. The method according to any of the preceding claims wherein the molar ratio between:
the amount of oxidizing agent consumed during step b) but excluding any removal of the excess oxidizing agent at the end of step b), and
the initial amount of free thiol groups in step a)
is 1:2-30:1, more preferably 1:2-25:1, even more preferably 1:1-20:1, and most preferably 1:1-15:1.

15. The method according to any of the preceding claims wherein the molar ratio between:
the amount of oxidizing agent capable of oxidizing the thiol group of cysteine consumed during step b) but excluding any removal of excess oxidizing agent at the end of step b), and
the initial amount of free thiol groups in step a)
is 1:4-15:1, more preferably 1:3-10:1, even more preferably 1:2-5:1, and most preferably 1:2-2:1.

16. The method according to any of the preceding claims wherein the duration of step b) is at most 12 hours, more preferably at most 6 hours, even more preferably at most 3 hours, and most preferably at most 1 hour.

17. The method according to any of the preceding claims wherein step b) involves stopping the oxidation by contacting the oxidizing whey protein solution with a component, preferably catalase that eliminates the residual oxidizing agent capable of oxidizing the thiol group of cysteine.

18. The method according to any of the preceding claims furthermore comprising c) which involves subjecting the oxidized whey protein solution obtained from step b) to a heat-treatment step.

19. An oxidized whey protein composition having:
a protein content of at least 30% w/w relative to total solids,
at most 15 micromol free thiol groups/g protein,
a tryptophan content of at least 0.7% w/w relative to total protein,
a methionine content of at least 0.3% w/w relative to total protein,
a kynurenine content of at most 0.2 micrograms/mg protein,
preferably, a fat content of at most 3% w/w relative to total solids,
preferably, a content of protein-bound sulfur in the range of 100-600 micromol/g protein,
preferably, a content of protein-bound cysteine residues that form disulfide bonds in the range of 150-400 micromol/g protein.

20. The oxidized whey protein composition according to claim 19 having a weight average molecular weight of the protein in the range of 18 kDa and 10000 kDa, more preferably between 50-8000 kDa, and most preferably 80-5000 kDa.

21. The oxidized whey protein composition according to claim 19 or 20 wherein at least 60% w/w of the protein has a molecular weight between 18 kDa and 10000 kDa, more preferably at least 80% w/w, even more preferably at least 90% w/w, and most preferably at least 99% w/w.

22. The oxidized whey protein composition according to any of claims 19-21 having a protein content of at least 86% w/w relative to total solids, and most preferably at least 90% relative to total solids.

23. The oxidized whey protein composition according to any of claims 19-22 having a fat content of at most 1% w/w relative to total solids, and most preferably at most 0.2%.

24. The oxidized whey protein composition according to any of claims 19-23 comprising at most 10 micromol free thiol groups/g protein, and most preferably at most 5 micromol free thiol groups/g protein.

25. The oxidized whey protein composition according to any of claims 19-24 having a tryptophan content of 0.7-3% w/w relative to total protein, and most preferably 1.0-3% w/w relative to total protein.

26. The oxidized whey protein composition according to any of claims 19-26 having a methionine content of 0.3-3.3% w/w relative to total protein, and most preferably 1.3-3.2% w/w relative to total protein.

27. The oxidized whey protein composition according to any of claims 19-26 having a kynurenine content of at most 0.2 micrograms/mg protein, and most preferably at most 0.01 micrograms/mg protein.

28. The oxidized whey protein composition according to any of claims 19-27 in the form of a powder.

29. The oxidized whey protein composition according to any of claims 19-27 in the form of a liquid.

30. The oxidized whey protein composition according to any of claims 19-29 obtainable by a method according to one or more of claims 1-18.

31. A heat-treated, preferably heat-sterilized, beverage having a pH of 5.5-8.5, and more preferably 6.5-7.5, the beverage comprising the oxidized whey protein composition according to one or more of claims 19-29 in an amount sufficient to contribute with at least 0.5% w/w protein, and preferably having a content of H2S 7 days after production of at most 5 micromol/L, more preferably 3 micromol/L, even more preferably 1.0 micromol/L, and most preferably at most 0.7 micromol/L.

32. A food ingredient comprising:
the solids of the oxidized whey protein composition according to one or more of claims 19-30, and
one or more further ingredient(s), preferably selected from:
a dairy ingredient, preferably a non-oxized dairy ingredient,
a plant-based ingredient,
a non-dairy carbohydrate source,
a flavouring agent, and/or
a sweetener (sweet carb/polyol/HIS).

33. The food ingredient according to claim 32 wherein the solids of the oxidized whey protein composition according to one or more of claims 19-30 contribute with 0.5-95% w/w of the weight of the food ingredient, more preferably 1-90% w/w, even more preferably 5-85% w/w, and most preferably 10-80% w/w of the weight of the food ingredient.

34. The food ingredient according to claim 32 or 33 wherein the solids of the oxidized whey protein composition according to one or more of claims 19-30 contribute with 0.5-95% w/w of the protein of the food ingredient, more preferably 1-90% w/w, even more preferably 5-85% w/w, and most preferably 10-80% w/w of the protein of the food ingredient.

35. The food ingredient according to any one of claims 32-34 comprising free thiol groups in an amount of at most 15 micromol/g protein, more preferably at most 14 micromol/g protein, even more preferably at most 13 micromol/g protein, and most preferably at most 12 micromol/g protein.

36. The food ingredient according to any one of claims 32-35 comprising free thiol groups in an amount of at most 10 micromol/g protein, more preferably at most 8 micromol/g protein, more preferably at most 5 micromol/g protein, even more preferably at most 3 micromol/g protein, and most preferably at most 2 micromol/g protein.

37. The food ingredient according to any one of claims 32-36 in the form of a powder, preferably comprising water in an amount of at most 6% w/w.
